(19) United States
(12) Patent Application Publication
(10) Pub. No.: US 2021/0061248 A1
(43) Pub. Date: Mar. 4, 2021

(54) Enhanced-Thrust Lift and Propulsion Systems

(71) Applicants: Mark T. Holtzapple, College Station, TX (US); Jeffrey J. Breedlove, Grantham, NH (US); Scott Brauer, Dripping Springs, TX (US); Michael Van Steenburg, Garden Ridge, TX (US)

(72) Inventors: Mark T. Holtzapple, College Station, TX (US); Jeffrey J. Breedlove, Grantham, NH (US); Scott Brauer, Dripping Springs, TX (US); Michael Van Steenburg, Garden Ridge, TX (US)

(21) Appl. No.: 16/995,725

(22) Filed: Aug. 17, 2020

Related U.S. Application Data
(60) Provisional application No. 62/962,144, filed on Jan. 16, 2020.
(60) Provisional application No. 62/962,154, filed on Jan. 16, 2020.
(60) Provisional application No. 62/888,971, filed on Aug. 19, 2019.
(60) Provisional application No. 62/899,715, filed on Sep. 12, 2019.
(60) Provisional application No. 62/957,122, filed on Jan. 4, 2020.

(51) Int. Cl. B60V 1/15; F04C 23/00

(52) U.S. Cl. CPC B60V 1/15; F04C 23/001

(57) ABSTRACT

A propulsion system includes a duct and a fluid flow generator. The duct has an elongated cavity with an inlet portion and an outlet portion. The fluid flow generator is disposed in the duct. The fluid flow generator configured to receive a fluid to generate an inlet stream through the inlet portion and generate an outlet stream through the outlet portion. The outlet stream is configured to generate thrust for a vehicle on which the fluid flow generator and the duct are mounted, and at least one of the inlet portion or the outlet portion is bent in a circular shape to alter a direction of a corresponding either one of the input stream or the output stream.

### CROSS REFERENCE TO RELATED APPLICATIONS

This application is related to and claims priority under 35 U.S.C. § 119 to U.S. Patent Application Nos. 62/962,154 filed on Jan. 16, 2020 entitled “Enhanced-Thrust Lift and Propulsion System”; 62/888,971 filed on Aug. 19, 2019 entitled “Jet Pack”; 62/899,715 filed on Sep. 12, 2019 entitled “Jet Pack”; 62/957,122 filed on Jan. 4, 2020 entitled “Propulsion System”; and 62/962,144 filed on Jan. 16, 2020 entitled “Propulsion System.” Each of these applications is hereby incorporated by reference in its entirety.

### TECHNICAL FIELD

Aspects of the present disclosure relate to vehicles and, in particular, to an enhanced-thrust lift and propulsion system.

### BACKGROUND

Propellers are often used to provide motive propulsion for vehicles moving through fluids, such as propellers used to propel boats over the water, or those used to propel airplanes through the air, or those used to lift helicopters into the air. The performance of propellers is often assessed using Actuator Disc Theory, which is also commonly known as Momentum Theory. In general, actuator disc theory is a mathematical model in which the propeller is modeled as an infinitely thin disc that overcomes a pressure difference across the two disc faces and induces a constant fluid velocity perpendicular to the disc faces. Based on the density, pressure, and velocity of the fluid (e.g., air, water) that flows through the actuator disc, a mathematical connection can be extracted between disc size, power, and lift (thrust).

### SUMMARY

According to one embodiment of the present disclosure, a propulsion system includes a duct and a fluid flow generator. The duct has an elongated cavity with an inlet portion and an outlet portion. The fluid flow generator is disposed in the duct. The fluid flow generator is configured to receive a fluid to generate an inlet stream through the inlet portion and generate an outlet stream through the outlet portion. The outlet stream is configured to generate thrust for a vehicle on which the fluid flow generator and the duct are mounted, and at least one of the inlet portion or the outlet portion is bent in a circular shape to alter a direction of a corresponding either one of the input stream or the output stream.

### BRIEF DESCRIPTION OF THE DRAWINGS

The various features and advantages of the technology of the present disclosure will be apparent from the following description of particular embodiments of those technologies, as illustrated in the accompanying drawings. It should be noted that the drawings are not drawn to scale; however, the emphasis instead is being placed on illustrating the principles of the technological concepts. Also, in the drawings the like reference characters refer to the same parts throughout the different views. The drawings depict only typical embodiments of the present disclosure and, therefore, are not to be considered limiting in scope.

FIG. 1 illustrates an example Actuator Disc Theory model involving a linearly oriented input flow and outlet flow according to one embodiment of the present disclosure.

FIG. 2 illustrates another example Actuator Disc Theory model involving multiple actuator discs that increase the pressure in a duct having a 90-degree radial bend according to one embodiment of the present disclosure.

FIG. 3 illustrates another example Actuator Disc Theory model involving multiple actuator discs that increase the pressure in a duct having a 180-degree radial bend according to one embodiment of the present disclosure.

FIG. 4 illustrates another example Actuator Disc Theory model involving an actuator disc that increases the pressure in a duct having a 180-degree radial bend, while having a varied fan position according to one embodiment of the present disclosure.

FIG. 5 illustrates another embodiment of an Actuator Disc Theory model involving an actuator disc located in a 180-degree duct according to one embodiment of the present disclosure.

FIGS. 6A, 6B, and 6C show the two-dimensional (x, y) flow fields determined by computational fluid dynamics (CFD) analysis for a simulated circular-profile 180-degree duct.

FIG. 7 shows the two-dimensional (x, y) flow fields determined by computational fluid dynamics (CFD) analysis for a low-profile 180-degree duct.

FIG. 8 report the upward thrust (N) per meter of depth in the z direction.

FIGS. 9a, 9b, 10a, and 10b show the flow fields and pressure fields, respectively, for circular and low-profile ducts in open space.

FIGS. 11a and 11b illustrate cross-sectional views of example propulsion systems incorporating linear circular ducting according to one embodiment of the present disclosure.

FIGS. 12a and 12b illustrate example fan arrangements that that may be used to blow air through the duct of FIGS. 11a and 11b according to embodiments of the present disclosure.

FIGS. 13a and 13b illustrate an example flying car according to one embodiment of the present disclosure.

FIGS. 14a and 14b illustrate cross-sectional views of example propulsion devices incorporating linear low-profile ducting according to one embodiment of the present disclosure.

FIGS. 15a and 15b illustrate example vertical-lift flying motorcycles with low-profile ducts with unequally sized inlet and outlet areas according to one embodiment of the present disclosure.

FIGS. 16a and 16b illustrate specific fuel consumption rates at various output powers of gas engines according to one embodiment of the present disclosure.

FIG. 17 illustrates one embodiment of a propulsion device having a duct with a short, straight outlet portion.

FIG. 18 illustrates another embodiment of a propulsion device having a duct with a long, straight outlet portion and an external turning vane at the inlet portion.

FIG. 19 illustrates another embodiment of a propulsion device having a duct with external turning vanes configured at the bottom end of the outlet duct portion of the duct.

FIG. 20 illustrates another embodiment of a propulsion device having a duct with an extra-long, straight outlet portion.

FIG. 21 illustrates another embodiment of a propulsion device having a duct with an extra-long, straight outlet portion and a restricted outlet.

FIG. 22 illustrates another embodiment of a propulsion device having a duct with an extra-long, straight outlet portion and a flared outlet.

FIG. 23 illustrates an example squirrel cage propeller assembly that may be implemented with the propulsion system according to one embodiment of the present disclosure.

FIGS. 24a and 24b illustrate an example squirrel cage propeller that may be implemented with the flying car according to one embodiment of the present disclosure

FIG. 25a illustrates an external view of flying car with no inlet ducts.

FIG. 25b illustrates an external view of a flying car with inlet ducts.

FIGS. 26a, 26b, and 26c illustrates example various propeller types that may be implemented with a circular duct according to embodiments of the present disclosure.

FIG. 27 illustrates an example turbo propeller as shown and described with reference to FIG. 26c.

FIG. 28 illustrates multiple clustered circular ducts that combine their thrust to increase lift capability.

FIG. 29 illustrates shows an example hybrid lifting system that employs the Coanda Effect to provide additional lift.

FIG. 30 illustrates a schematic diagram of a conventional axial jet engine.

FIG. 31 illustrates a schematic of a radial jet engine.

FIG. 32 illustrates a reverse-flow jet engine.

FIG. 33 shows the flow around a conventional torpedo.

FIGS. 34a through 34d show various options for torpedoes with axial propellers.

FIGS. 35a through 35e illustrate several embodiments of squirrel-cage propellers that may be used with a torpedo according to embodiments of the present disclosure.

FIG. 36a through 36ed illustrate other embodiments of the squirrel-cage propeller, which are similar to the embodiments of FIGS. 35a through 35e, except that turning vanes are employed.

FIG. 37a through 37e illustrate other embodiments of the squirrel-cage propeller, which are similar to the embodiments of FIGS. 36a through 36e except that a reduction nozzle is employed at the outlet.

FIGS. 38a and 38b are cut-away views showing the interior and exterior cone of a turbo propeller.

FIG. 39 illustrates a jet boat in which the propeller is located in the interior of the boat.

FIGS. 40a and 40b illustrate various bottom and frontal views of a traditional monohull boat hull, a catamaran boat hull, and a Small Waterplane Area Twin Hull (SWATH) hull.

FIGS. 41a to 41d show the submerged portion of SWATH boat.

FIGS. 42a and 42b illustrate bottom and side views, respectively, of a monohull boat in “travel mode” meaning it is traveling with a significant forward velocity.

FIGS. 43a and 43b illustrate bottom and side views, respectively, showing the monohull boat in “thrust mode” meaning it is traveling with a nearly zero velocity, but has tremendous thrust.

FIG. 44 is a schematic diagram illustrating an example jet pack according to one embodiment of the present disclosure.

FIG. 45 illustrates a schematic diagram of another example jet pack according to one embodiment of the present disclosure.

FIG. 46 illustrates a schematic diagram of another example jet pack according to one embodiment of the present disclosure.

FIG. 47 illustrates a top view of an example jet ejector according to one embodiment of the present disclosure.

FIG. 48 illustrates a top view of a linear jet ejector assembly according to one embodiment of the present disclosure.

FIG. 49 is a schematic diagram of an example jet pack according to one embodiment of the present disclosure.

FIGS. 50a and 50b illustrate an example jet pack according to one embodiment of the present disclosure.

FIGS. 51a and 51b illustrate other example jet packs according to one embodiment of the present disclosure.

FIGS. 52a and 52b illustrate other example jet packs according to one embodiment of the present disclosure.

FIG. 53 shows the jet pack of FIGS. 52a and 52b mounted to the back of a passenger.

FIGS. 54a and 54b illustrate a front view and a side view, respectively, of an example lift platform according to one embodiment of the present disclosure.

FIGS. 55a and 55b illustrates other example lift platforms according to one embodiment of the present disclosure.

FIGS. 56a and 56b illustrates other lift platforms according to one embodiment of the present disclosure.

FIG. 57 shows an example measured value of drag on a ship hull as a function of speed.

FIGS. 58 and 59 show the flow streams around an example ship hull.

FIGS. 60 and 61 illustrate how the dominant residual drag is caused by the generation of waves.

FIG. 62 shows an example hydrodynamic pressure acting on a boat hull.

FIG. 63 illustrates a conventional propeller model according to one embodiment of the present disclosure.

FIG. 64 shows how propulsive efficiency approaches 1.0 as V_{A}/V_{C} approaches 1.0.

FIG. 65 shows that the efficiency of a conventional propeller increases with size, although the efficiency is relatively low.

FIG. 66 shows propeller efficiency as a function of velocity and propeller pitch. Pitch is the distance a propeller would travel in a soft material using a single rotation.

FIG. 67 shows the efficiency of a variable-pitch two-blade propeller that extends the range of efficient velocities.

FIG. 68 shows the efficiency of a variable-pitch four-blade propeller ranges from 0.49 to 0.77.

FIGS. 69a to 69b illustrate example maritime propulsion systems that are mounted on a ship according to various embodiments of the present disclosure.

FIG. 70 illustrates another example propulsion system according to one embodiment of the present disclosure.

FIG. 71 illustrates a schematic representation of another maritime propulsion system according to one embodiment of the present disclosure.

FIG. 72 illustrates multiple example rudders that can be incorporated into the duct to allow for vectored thrust and enhanced maneuverability according to one embodiment of the present disclosure.

FIGS. 73 and 73a illustrate centrifugal and squirrel cage propellers that may be used as a fluid flow generator according to embodiments of the present disclosure.

FIG. 74 illustrates how, at particular speeds, the peak of the wave at the stern will be above the inlet to the duct of FIG. 71 according to one embodiment of the present disclosure.

FIGS. 75a to 75c show how a reversing duct may be used to reverse flow according to one embodiment of the present disclosure.

FIG. 76 illustrates another example propulsion system according to one embodiment of the present disclosure.

FIG. 77 illustrates another example propulsion system according to one embodiment of the present disclosure.

FIGS. 78 and 79 show the propulsive efficiency and factor in the square bracket, respectively for the propulsion system of FIG. 77 according to one embodiment of the present disclosure.

FIG. 80 illustrates another example propulsion system according to one embodiment of the present disclosure.

FIGS. 81 and 82 show the propulsive efficiency and factor in the square bracket, respectively for the propulsion system of FIG. 80 according to one embodiment of the present disclosure.

FIG. 83 shows example combinations of area ratio (A₁/A₂), velocity ratio (V_{A}/V_{B}), and withdrawal fraction (f) that result in 100% efficiency (η=1.0).

FIG. 84 illustrates an example hardware implementation of the propulsion system of FIG. 77.

FIG. 85 shows example maritime propulsion system using a centrifugal pump according to one embodiment of the present disclosure.

FIG. 86 illustrates an example centrifugal pump that may be used with embodiments of the present disclosure.

FIG. 87 illustrates an efficiency that may be obtained via use of the centrifugal pump of FIG. 86.

FIG. 88 shows the temperature, pressure, and velocity at various points in a turbojet engine.

FIG. 89 shows the propulsive efficiency for aircraft engines as a function of airspeed.

FIGS. 90 and 91 show embodiments where the propulsion system is placed behind the fuselage of an aircraft.

### DETAILED DESCRIPTION

The figures described below, and the various embodiments used to describe the principles of the present disclosure in this patent document are by way of illustration only and should not be construed in any way to limit the scope of the disclosure. Those skilled in the art will understand that the principles of the present disclosure invention may be implemented in any type of suitably arranged device or system. Additionally, the drawings are not necessarily drawn to scale.

Embodiments of the present disclosure relate to systems and methods for enhancing the thrust of vehicles (e.g., vertical-lift aircraft, fixed-wing aircraft, boats, ships, etc.) while minimizing power consumption. Thrust enhancement occurs by replacing conventional propeller designs typically having linearly oriented (e.g., 0-degree bend) input fluid flow and output fluid flows with fluid-moving devices that direct the fluid along a radial direction (e.g., 90-degree bend) or a reverse direction (e.g., 180-degree bend). Although particular types of vehicles will be described with reference and regard to particular embodiments, it should be understood that other types of vehicles may also avail from the teachings of this disclosure.

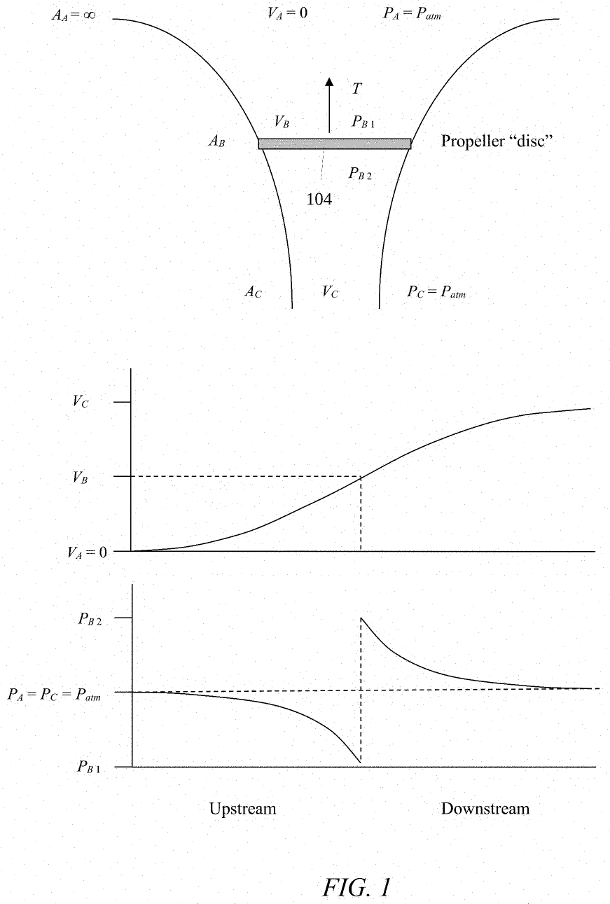

FIG. 1 illustrates an example Actuator Disc Theory model involving a linearly oriented input flow and outlet flow according to one embodiment of the present disclosure. The actuator disc theory involves a propeller disc 104 that moves through a medium to develop a thrust T. According the Actuator Disc Theory, the velocity V_{B} at the actuator disc is the arithmetic average of upstream velocity V_{A} and the downstream velocity V_{C}. In the case of vertical lift aircraft, the upstream velocity is often at or close to V_{A}=0 during normal operation.

$${V}_{B} = \frac{{V}_{A} + {V}_{C}}{2} = \frac{0 + {V}_{C}}{2} = \frac{{V}_{C}}{2} \\ {A}_{C} = \frac{{A}_{B}}{2}$$

For incompressible fluids undergoing negligible changes in height, the energy content (J/m³) contains a pressure component (N/m² or J/m³) and a kinetic energy component (J/m³), as determined by the Bernoulli equation. The Bernoulli equation is applied to the fluid upstream of the actuator disc:

$${P}_{B 1} + \frac{1}{2} ρ {V}_{B}^{2} = {P}_{A} + \frac{1}{2} ρ {V}_{A}^{2} = {P}_{A} + \frac{1}{2} ρ {( 0 )}^{2} = {P}_{A} = {P}_{at m}$$

$${P}_{B 1} = {P}_{at m} - \frac{1}{2} ρ {V}_{B}^{2} = {P}_{at m} - \frac{1}{2} {ρ ( \frac{{V}_{C}}{2} )}^{2} = {P}_{at m} - \frac{1}{8} ρ {V}_{C}^{2}$$

The Bernoulli equation can also be applied to the fluid downstream of the actuator disc:

$${P}_{B 2} + \frac{1}{2} ρ {V}_{B}^{2} = {P}_{C} + \frac{1}{2} ρ {V}_{C}^{2} = {P}_{at m} + \frac{1}{2} ρ {V}_{C}^{2}$$

$${P}_{B 2} = {P}_{at m} + \frac{1}{2} ρ {V}_{C}^{2} - \frac{1}{2} ρ {V}_{B}^{2} = {P}_{at m} + \frac{1}{2} ρ {V}_{C}^{2} - \frac{1}{2} {ρ ( \frac{{V}_{C}}{2} )}^{2} = {P}_{at m} + \frac{1}{2} ρ {V}_{C}^{2} - \frac{1}{8} ρ {V}_{C}^{2} = {P}_{at m} + \frac{3}{8} ρ {V}_{C}^{2}$$

The pressure difference across the actuator disc follows:

P_{B2}−P_{B1}=(Pₐₜₘ+3/8ρV_{C}²)−(Pₐₜₘ−1/8ρV_{C}²)=3/8ρV_{C}²+1/8ρV_{C}²=4/8ρV_{C}²=1/2ρV_{C}²

The thrust acting on the actuator disc is

T=A_{B}(P_{B2}−P_{B1})=A_{B}(1/2ρV_{C}²)=2A_{C}(1/2ρV_{C}²)=A_{C}ρV_{C}²=ρA_{C}V_{C}²

The rate that kinetic energy is imparted to the flowing fluid follows:

Ėₖ=1/2\dot{m}(V_{C}²−V_{A}²)=1/2\dot{m}(V_{C}²−0)=1/2\dot{m}V_{C}²=1/2(ρA_{C}V_{C})V_{C}²=1/2ρA_{C}V_{C}³

It is desirable to have the maximum amount of thrust per unit of kinetic power, which is determined by the following metric:

$$\frac{T}{{\dot{E}}_{k}} = \frac{ρ {A}_{C} {V}_{C}^{2}}{\frac{1}{2} ρ {A}_{C} {V}_{C}^{3}} = \frac{2}{{V}_{C}}$$

Thus, a conventional propeller having linearly oriented inlet flow and outlet flow would have a thrust per unit of kinetic power factor of 2.

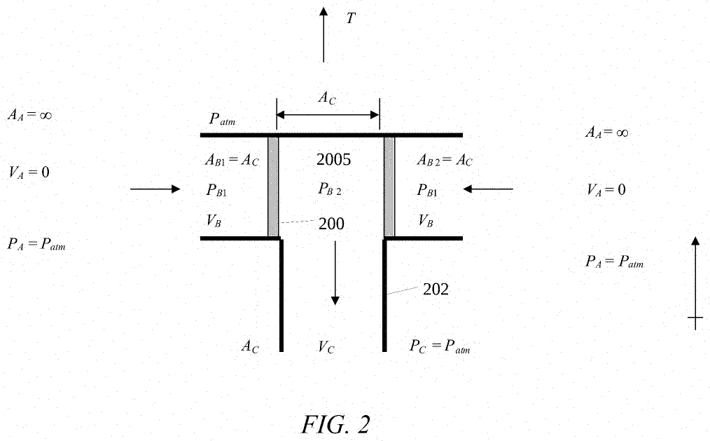

FIG. 2 illustrates another example Actuator Disc Theory model involving multiple actuator discs 200 that flows the fluid through a duct 202 having a 90-degree radial bend according to one embodiment of the present disclosure. The area at the inlet and outlet are variable and can be specified by the design engineer. In this case, the total area of the inlet and outlet are specified so that the relationship between V_{B} and V_{C} is the same as the propeller, which allows the impact of the directional change to be determined.

$${V}_{B} = \frac{{V}_{C}}{2}$$

This velocity ratio is obtained by specifying the area of the inlet and outlet as follows:

$${A}_{C} = \frac{{A}_{B}}{2} = \frac{{A}_{B 1} + {A}_{B 1}}{2} = \frac{{A}_{B 1}}{2} + \frac{{A}_{B 1}}{2} = \frac{{A}_{C}}{2} + \frac{{A}_{C}}{2}$$

The pressure at the inlet to the actuator discs can be obtained by applying the Bernoulli equation

$${P}_{B 1} + \frac{1}{2} ρ {V}_{B}^{2} = {P}_{A} + \frac{1}{2} ρ {V}_{A}^{2} = {P}_{A} + \frac{1}{2} {ρ ( 0 )}^{2} = {P}_{A} = {P}_{at m}$$

$${P}_{B 1} = {P}_{at m} - \frac{1}{2} ρ {V}_{B}^{2} = {P}_{at m} - \frac{1}{2} {ρ ( \frac{{V}_{C}}{2} )}^{2} = {P}_{at m} - \frac{1}{8} ρ {V}_{C}^{2}$$

The pressure at the outlet of the actuator discs is determined by applying the Bernoulli equation to the outlet stream.

$${P}_{B 2} + \frac{1}{2} ρ {V}_{B}^{2} = {P}_{C} + \frac{1}{2} ρ {V}_{C}^{2} = {P}_{at m} + \frac{1}{2} ρ {V}_{C}^{2}$$

$${P}_{B 2} - {P}_{at m} = \frac{1}{2} ρ {V}_{C}^{2} - \frac{1}{2} ρ {V}_{B}^{2} = \frac{1}{2} ρ {V}_{C}^{2} - \frac{1}{2} {ρ ( \frac{{V}_{C}}{2} )}^{2} = \frac{1}{2} ρ {V}_{C}^{2} - \frac{1}{8} ρ {V}_{C}^{2} = \frac{3}{8} ρ {V}_{C}^{2}$$

The net thrust on the duct results from the pressure difference on the duct area A_{C} plus the momentum of the mass leaving the duct.

T=A_{C}(P_{B2}−Pₐₜₘ)+\dot{m}V_{C}=A_{C}(P_{B2}−Pₐₜₘ)+(ρA_{C}V_{C})V_{C}=A_{C}3/8ρV_{C}²+ρA_{C}V_{C}²=11/8ρA_{C}V_{C}²

The rate that kinetic energy is imparted to the flowing fluid follows:

Ėₖ=1/2\dot{m}(V_{C}²−V_{A}²)=1/2\dot{m}(V_{C}²−0)=1/2\dot{m}V_{C}²=1/2(ρA_{C}V_{C})V_{C}²=1/2ρA_{C}V_{C}³

The thrust per unit of kinetic power follows:

$$\frac{T}{{\dot{E}}_{k}} = \frac{\frac{11}{8} ρ {A}_{C} {V}_{C}^{2}}{\frac{1}{2} ρ {A}_{C} {V}_{C}^{3}} = \frac{2.75}{{V}_{C}}$$

Thus, actuator discs 200 configured in a duct 202 having a 90-degree bend in its inlet flow would have a thrust per unit of kinetic power factor of 2.75. In this case, the numerator is higher (2.75 vs. 2.0), so 37.5% more thrust is developed for the same kinetic power when compared to an actuator disc 104 having linearly oriented input flow as described above with reference to FIG. 2.

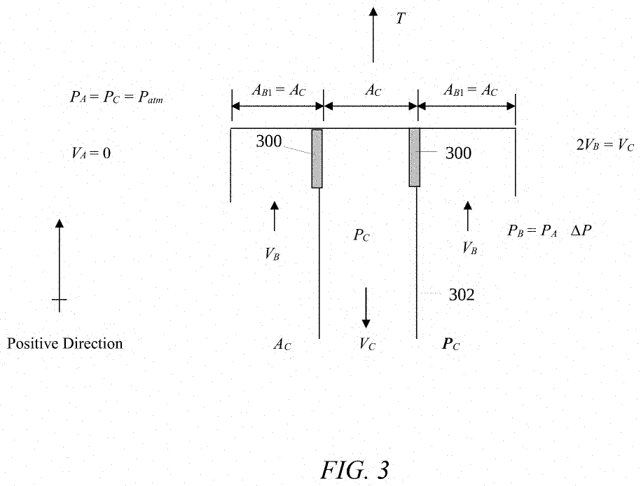

FIG. 3 illustrates another example Actuator Disc Theory model involving multiple actuator discs 300 that flow the fluid through a duct 302 having a 180-degree radial bend according to one embodiment of the present disclosure. In this case, the total area of the inlet and outlet are specified so that the relationship between V_{B} and V_{C} is the same as the actuator discs 300 (e.g., propellers), which allows the impact of the directional change to be determined.

$${V}_{B} = \frac{{V}_{C}}{2}$$

This velocity ratio is obtained by specifying the area of the inlet and outlet as follows:

2A_{C}=A_{B}=A_{B1}+A_{B1}=A_{C}+A_{C}

Applying the Bernoulli equation at the inlet allows the suction pressure ΔP to be calculated.

$$\frac{1}{2} ρ {V}_{A}^{2} + {P}_{A} = \frac{1}{2} ρ {V}_{B}^{2} + {P}_{B}$$

$$0 + {P}_{A} = \frac{1}{2} ρ {V}_{B}^{2} + {P}_{B}$$

$$Δ P = {P}_{A} - {P}_{B} = \frac{1}{2} ρ {V}_{B}^{2} = \frac{1}{2} {ρ ( \frac{{V}_{C}}{2} )}^{2} = \frac{1}{8} ρ {V}_{C}^{2}$$

The net thrust on the duct results from the pressure difference on the inlet duct plus the momentum of the mass entering and leaving the duct.

$$\begin{matrix}T = \dot{m} {V}_{B} - \dot{m} ( - {V}_{C} ) - 2 {A}_{C} Δ P \\ = \dot{m} ( \frac{{V}_{C}}{2} ) - \dot{m} ( - {V}_{c} ) - 2 {A}_{C} Δ P \\ = 15 \dot{m} {V}_{C} - 2 {A}_{C} Δ P \\ = 15 ( ρ {A}_{C} {V}_{C} ) {V}_{C} - 2 {A}_{c} \frac{1}{8} ρ {V}_{C}^{2} \\ = 1.5 ρ {A}_{C} {V}_{C}^{2} - \frac{1}{4} ρ {A}_{C} {V}_{C}^{2} \\ = 1.25 ρ {A}_{C} {V}_{C}^{2}\end{matrix}$$

The rate that kinetic energy is imparted to the flowing fluid follows:

Ėₖ=1/2\dot{m}(V_{C}²−V_{A}²)=1/2\dot{m}(V_{C}²−0)=1/2\dot{m}V_{C}²=1/2(ρA_{C}V_{C})V_{C}²=1/2ρA_{C}V_{C}³

The thrust per unit of kinetic power follows:

$$\frac{T}{{\dot{E}}_{k}} = \frac{1.25 ρ {A}_{C} {V}_{C}^{2}}{\frac{1}{2} ρ {A}_{C} {V}_{C}^{3}} = \frac{2.5}{{V}_{C}}$$

Thus, actuator discs 300 configured in a duct 302 having a 180-degree bend in its inlet flow would have a thrust per unit of kinetic power factor of 2.5. In this particular case, the actuator discs 300 configured in a duct 302 having a 180-bend is better than a conventional propeller design (e.g., 2.5>2.0) as described above with reference to FIG. 1, but not as good as actuator discs 200 configured in a duct 202 having a 90-degree bend as described above with reference to FIG. 2 (e.g., 2.5<2.75).

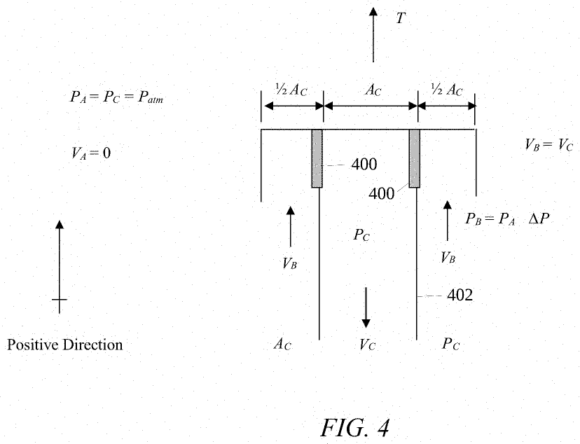

FIG. 4 illustrates another example Actuator Disc Theory model involving multiple actuator discs 400 that flows fluid through a duct 402 having a 180-degree radial bend, a condition is considered where the velocity V_{B} at the actuator disc is similar to the downstream velocity V_{C} (V_{B}=V_{C}) according to one embodiment of the present disclosure.

V_{B}=V_{C}.

This velocity ratio is obtained by specifying the area of the inlet and outlet as follows:

$${A}_{C} = {A}_{B} = {A}_{B 1} + {A}_{B 1} = \frac{{A}_{C}}{2} + \frac{{A}_{C}}{2}$$

Applying the Bernoulli equation at the inlet allows the suction pressure ΔP to be calculated

1/2ρV_{A}²+P_{A}=1/2ρV_{B}²+P_{B}

0+P_{A}=1/2ρV_{B}²+P_{B}

ΔP=P_{A}−P_{B}=1/2ρV_{B}²=1/2ρV_{C}²

The net thrust on the duct results from the pressure difference on the inlet duct plus the momentum of the mass entering and leaving the duct.

$$\begin{matrix}T = \dot{m} {V}_{B} - \dot{m} ( - {V}_{C} ) - {A}_{C} Δ P \\ = \dot{m} {V}_{C} - \dot{m} ( - {V}_{C} ) - {A}_{C} Δ P \\ = 2 \dot{m} {V}_{C} - {A}_{C} Δ P \\ = 2 ( ρ {A}_{C} {V}_{C} ) {V}_{C} - {A}_{C} \frac{1}{8} ρ {V}_{C}^{2} \\ = 2 ρ {A}_{C} {V}_{C}^{2} - \frac{1}{4} ρ {A}_{C} {V}_{C}^{2} \\ = \frac{3}{2} ρ {A}_{C} {V}_{C}^{2}\end{matrix}$$

The rate that kinetic energy is imparted to the flowing fluid follows:

Ėₖ=1/2\dot{m}(V_{C}²−V_{A}²)=1/2\dot{m}(V_{C}²−0)=1/2\dot{m}V_{C}²=1/2(ρA_{C}V_{C})V_{C}²=1/2ρA_{C}V_{C}³

The thrust per unit of kinetic power follows:

$$\frac{T}{{\dot{E}}_{k}} = \frac{\frac{3}{2} ρ {A}_{C} {V}_{C}^{2}}{\frac{1}{2} {ρA}_{C} {V}_{C}^{3}} = \frac{3}{{V}_{C}}$$

Thus, actuator discs 400 configured in a duct 402 having a 180-degree bend while being configured to have the velocity V_{B} at the actuator disc to be similar to the downstream velocity V_{C} (V_{B}=V_{C}) would yield a thrust per unit of kinetic power factor of 3.0. This particular case is an improvement over the conventional propeller design (2.0) as described above with reference to FIG. 1, and the case where the actuator discs 200 are configured in a duct 202 having a 90-degree bend as described above with reference to FIG. 2 (2.5). Additionally, this case is an improvement over the actuator discs 300 configured in a duct 302 having a 180-degree bend in its inlet flow would have a thrust per unit of kinetic power factor of 2.5 as described above with reference to FIG. 2. Thus, reducing the inlet area relative to the outlet area will improve this ratio even further.

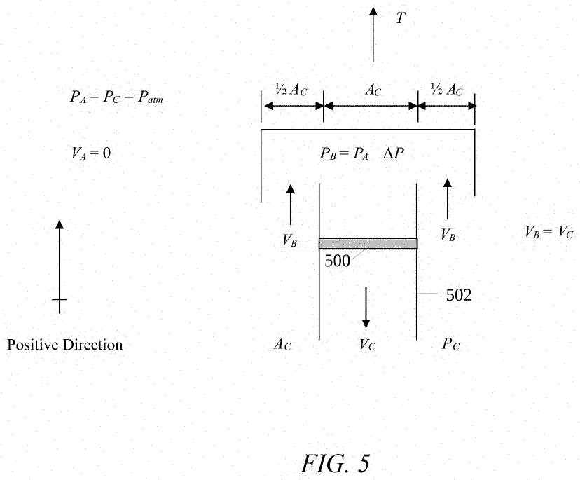

FIG. 5 illustrates another example Actuator Disc Theory model involving an actuator disc 500 that increases the pressure in a duct 502 having a 180-degree radial bend, while having a varied fan position according to one embodiment of the present disclosure. Similar to the example Actuator Disc Theory model described above, the velocity V_{B} at the actuator disc 500 is configured to be similar to the downstream velocity V_{C} (V_{B}=V_{C})

V_{B}=V_{C}

This velocity ratio is obtained by specifying the area of the inlet and outlet as follows:

$${A}_{C} = {A}_{B} = {A}_{B 1} + {A}_{B 1} = \frac{{A}_{C}}{2} + \frac{{A}_{C}}{2}$$

Applying the Bernoulli equation at the inlet allows the suction pressure ΔP to be calculated

1/2ρV_{A}²+P_{A}=1/2ρV_{B}²+P_{B}

0+P_{A}=1/2ρV_{B}²+P_{B}

ΔP=P_{A}−P_{B}=1/2ρV_{B}²=1/2ρV_{C}²

The net thrust on the duct results from the pressure difference on the duct and fan, plus the momentum of the mass entering and leaving the duct.

$$\begin{matrix}T = \dot{m} {V}_{B} - \dot{m} ( - {V}_{C} ) - 2 {A}_{C} Δ P + {A}_{C} Δ P \\ = \dot{m} {V}_{C} - \dot{m} ( - {V}_{C} ) - {A}_{C} Δ P \\ = 2 \dot{m} {V}_{C} - {A}_{C} Δ P \\ = 2 ( ρ {A}_{C} {V}_{C} ) {V}_{C} - {A}_{C} \frac{1}{2} ρ {V}_{C}^{2} \\ = 2 ρ {A}_{C} {V}_{C}^{2} - \frac{1}{2} ρ {A}_{C} {V}_{C}^{2} \\ = \frac{3}{2} ρ {A}_{C} {V}_{C}^{2}\end{matrix}$$

The thrust per unit of kinetic power follows:

$$\frac{T}{{\dot{E}}_{k}} = \frac{\frac{3}{2} ρ {A}_{C} {V}_{C}^{2}}{\frac{1}{2} ρ {A}_{C} {V}_{C}^{3}} = \frac{3}{{V}_{C}}$$

This is same as the previous case, so fan placement does not affect the net thrust. However, reducing the inlet area relative to the outlet area may improve this ratio even further in certain embodiments.

### Computational Fluid Dynamics

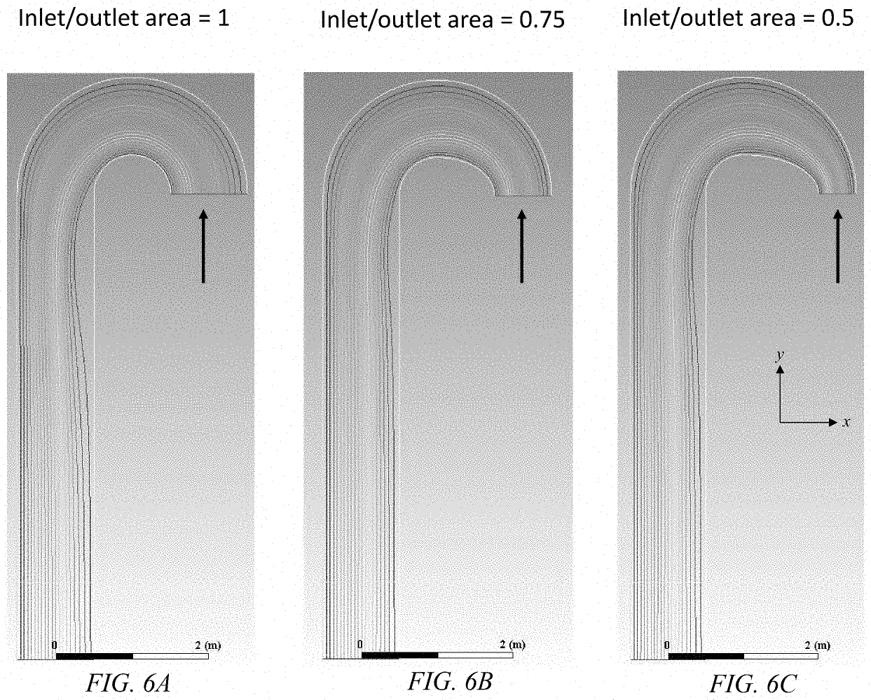

FIGS. 6A, 6B, and 6C illustrate two-dimensional (x, y) flow fields determined by computational fluid dynamics (CFD) analysis for a simulated circular 180-degree duct according to one embodiment of the present disclosure. For each of FIGS. 6A, 6B, and 6C, the width of the simulated duct outlet is 1 meter. However, the width of the simulated duct inlet in FIG. 6A is 1.0 meter, the width of the simulated duct inlet in FIG. 6B is 0.75 meters, and the width of the simulated duct inlet in FIG. 6C is 0.5 meters. In each case, the pressure difference that induces the flow is 1000 Pa. Only the flow in the simulated duct is modeled, not the surrounding open space. Table 1 reports the upward thrust (N) per meter of depth in the z direction.

TABLE 1

| | Inlet/outlet area | Upward thrust (N/m) |
|---|---|---|
| Test 1 | 1.0 | 4669.1 |
| Test 2 | 0.75 | 5327.2 |
| Test 3 | 0.5 | 6089.1 |

As shown, the CFD results confirm that decreasing the inlet area relative to the outlet area increases thrust.

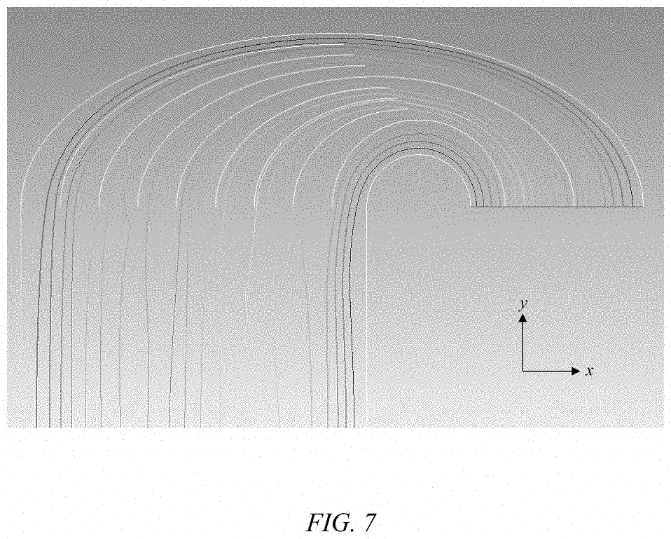

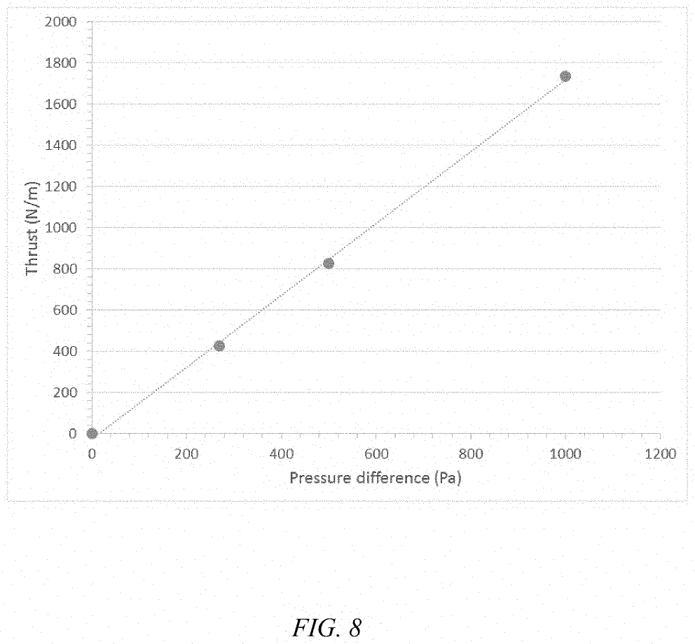

FIG. 7 shows the two-dimensional (x, y) flow fields determined by computational fluid dynamics (CFD) analysis for a simulated low-profile 180-degree duct. The width of the simulated duct outlet is 1 meter. The inlet/outlet area is 0.5. Turning vanes were incorporated to help reduce flow separation when making the sharp bend. Only the flow in the simulated duct is modeled, not the surrounding open space. As a function of pressure difference, Table 2 and FIG. 8 report the upward thrust (N) per meter of depth in the z direction. The upward thrust is linearly related to the pressure difference.

TABLE 2

| Fan ΔP (Pa) | Upward thrust (N/m) |
|---|---|
| 1000 | 1734 |
| 500 | 827 |
| 270 | 425 |

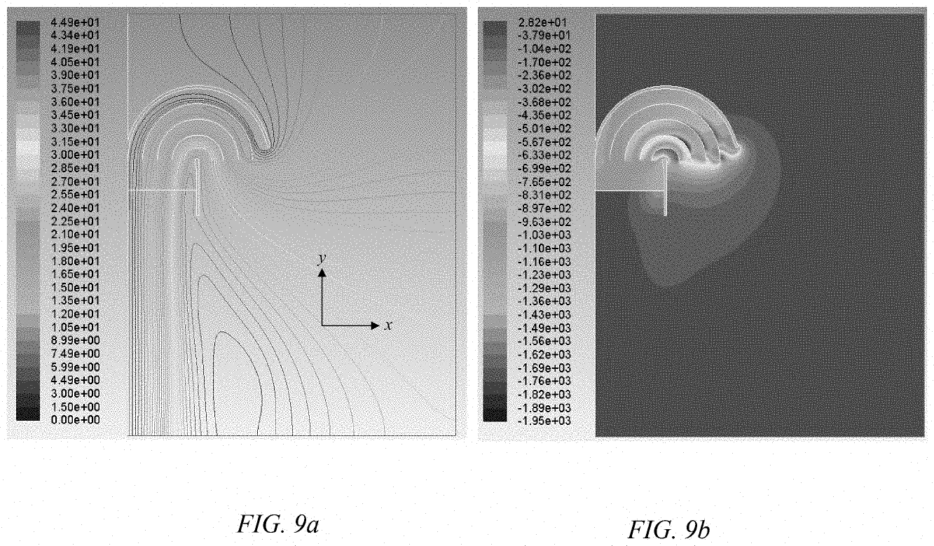

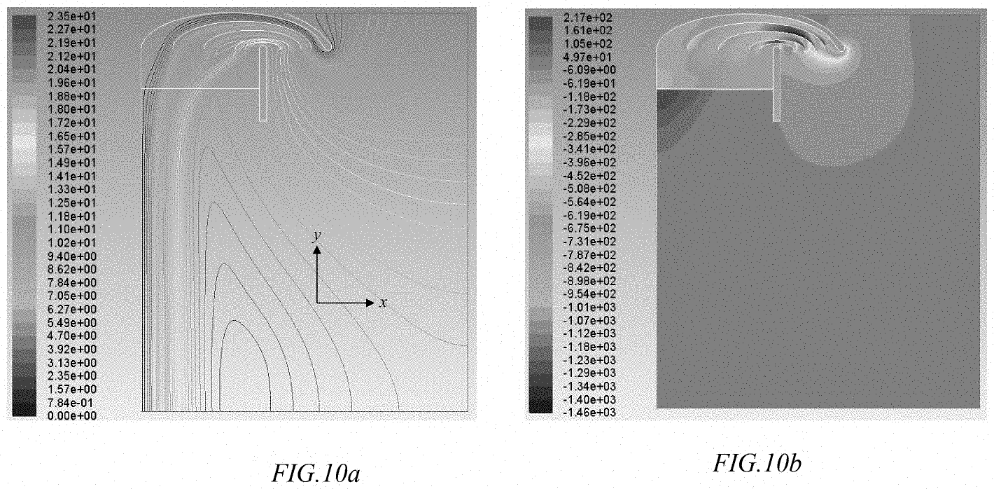

FIGS. 9a, 9b, 10a, and 10b show the flow fields and pressure fields, respectively, for circular and low-profile ducts in open space. More particularly, FIG. 9a shows the flow field and FIG. 9b show the pressure field for a circular 180-degree duct in an open space. More particularly, FIG. 10a shows the flow field and FIG. 10b shows the pressure field for a low-profile 180-degree duct in an open space. The z direction emanates perpendicularly from the xy-plane.

Table 3 summarizes the data gathered from the CFD analysis. In both cases, the thrust per kinetic power is very similar; however, it should be emphasized that meaningful comparison is only possible at the same duct size and pressure difference.

TABLE 3

| | Circular | Low Profile |
|---|---|---|
| Inlet/outlet area | 1.0 | 0.5 |
| Number of channels | 5 | 5 |
| Outlet width (m) | 1.3 | 1.7 |
| Inlet width (m) | 1.3 | 0.9 |
| Total width | 2.6 | 2.6 |
| Pressure difference (Pa) | 992 | 725 |
| Mass flow (kg/s) | 37.9 | 18.9 |
| Volume flow (m³/s) | 30.8 | 15.4 |
| Fluid power (kW) | 30.6 | 11.2 |
| Upward thrust (N) | 2239 | 805 |
| Thrust/power (N/kW) | 73.2 | 71.9 |

### Vertical-Lift Aircraft

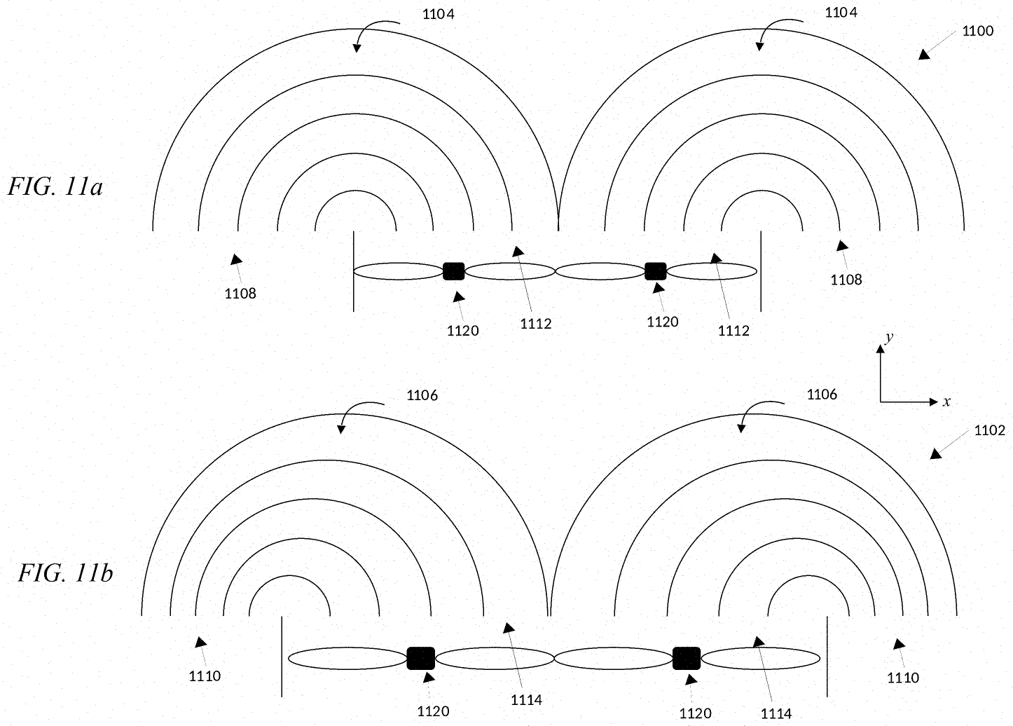

FIGS. 11a and 11b illustrate cross-sectional views of example propulsion systems 1100, 1102 incorporating linear circular ducting according to one embodiment of the present disclosure. Each propulsion system 1100, 1102 includes a duct 1104, 1106 having an inlet portion 1108, 1110 and outlet portion 1112, 1114 with a fluid flow generator, such as one or more propellers 1120 configured inside. While a propeller is shown in this configuration, other fluid flow generators may be show in other configurations including, but not limited to, squirrel-cage fans, turbo fans, impellers, jet engines, propellers, and the like. FIG. 11a shows the inlet portion 1108 and outlet portion 1112 having equally sized cross-sectional areas, whereas FIG. 11b shows the inlet portion 1110 and outlet portion 1114 with unequally sized cross-sectional areas.

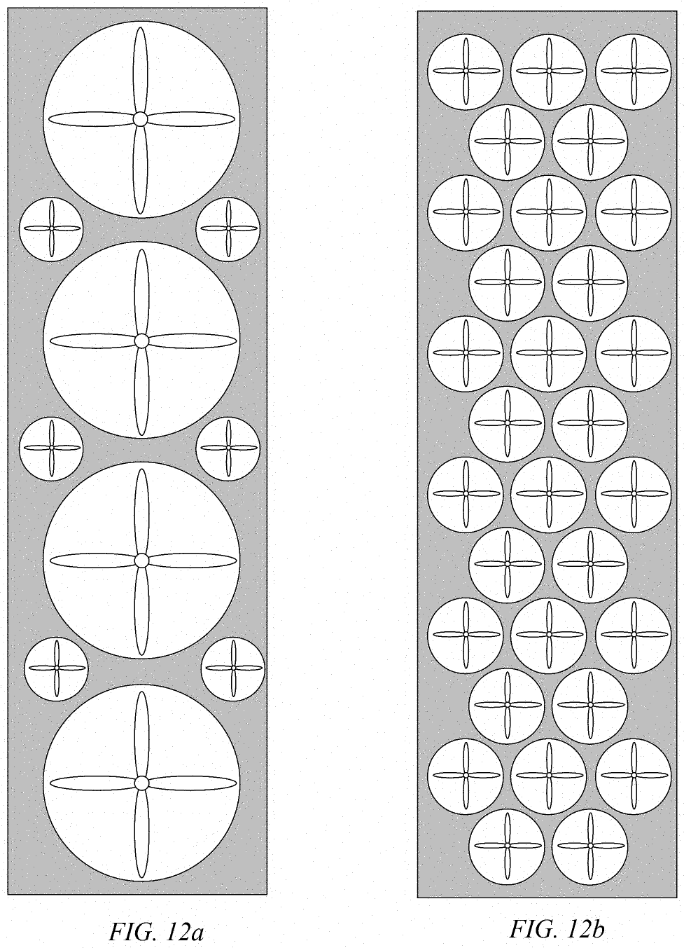

FIGS. 12a and 12b illustrate example fan arrangements (e.g., fluid flow generators) that that may be used to blow air through the duct 1104, 1106 of FIGS. 11a and 11b according to embodiments of the present disclosure. Again, although axial fans are shown here, it is possible to use any suitable type of fluid flow generator, such as squirrel-cage fans, turbo fans, impellers, jet engines, propellers, and the like. To prevent or reduce net torque on a vehicle, such as a flying vehicle, half or a portion of the fans operate in a clockwise direction while the other fans operate in a counter-clockwise direction. The embodiment of FIG. 12a shows multiple fans with unequally sized areas, whereas the embodiment of FIG. 12b shows fans with equally sized areas.

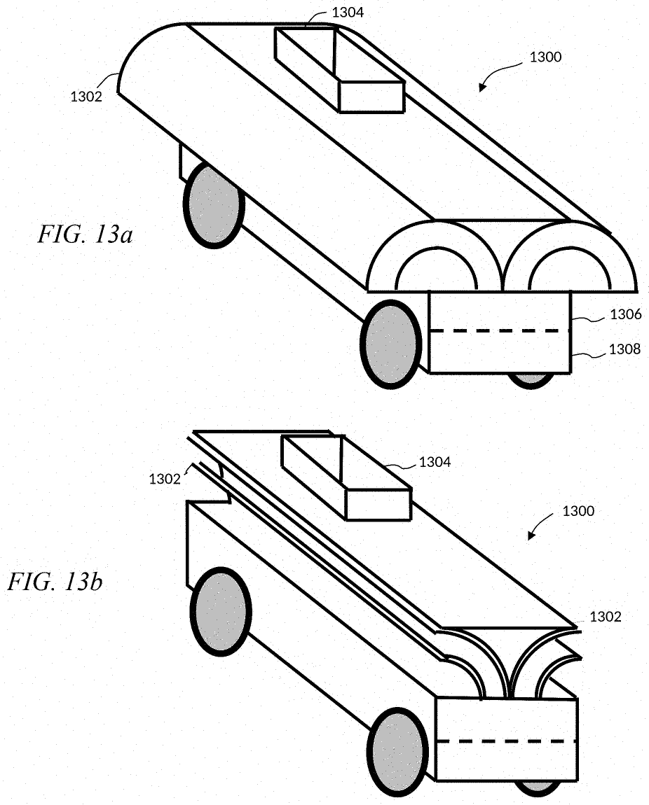

FIGS. 13a and 13b illustrate an example flying car 1300 according to one embodiment of the present disclosure. The flying car 1300 employs equal-area circular ducts similar to that shown and described above with reference to FIG. 11a. The ducts 1302 are selectively movable from a deployed position (flying mode) in which the ducts 1302 are fully extended as shown in FIG. 13a to a retracted position (driving mode) as shown in FIG. 13b. The flying car 1300 includes a passenger compartment 1304 that may be used to seat a user, such as a driver of the flying car 1300. Although the passenger compartment 1304 is shown as an open cockpit, other embodiments contemplate that the passenger compartment can be covered to allow the passenger to fly in a closed cockpit.

In one embodiment, the flying car 1300 includes an upper section 1306 and a lower section 1308. In flight, the upper section 1306 is maintained at a slight vacuum to draw air into the turning ducts, while the lower section 1308 is pressurized to blow air out of the bottom of the box and therefore lift the flying vehicle.

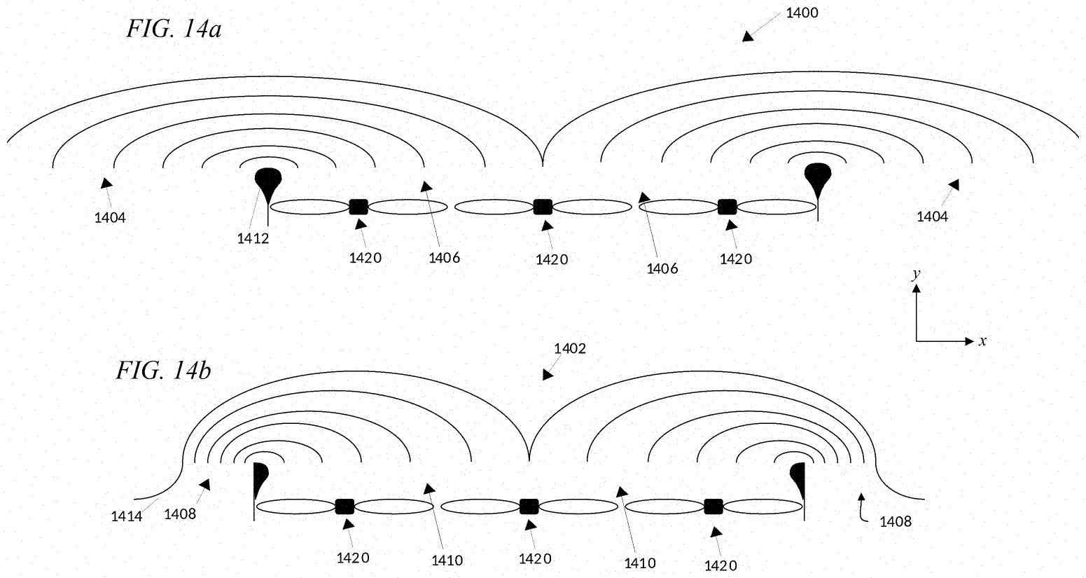

FIGS. 14a and 14b illustrate cross-sectional views of example propulsion devices 1400, 1402 incorporating linear low-profile ducting according to one embodiment of the present disclosure. FIG. 14a shows the inlets 1404 and outlet 1406 to the ducts with equally sized cross-sectional areas, whereas FIG. 14b shows the inlets 1408 and outlet 1410 to the ducts with unequally sized cross-sectional areas. In one embodiment, the duct may include one or more bulbs 1412 to assist the fluid turn the tight corner, and/or a scoop mechanism 1414 to help fluid enter with less loss. Just like configuration of FIGS. 11a and 11b, a variety of different fluid flow generators such as propellers (or other devices) may be utilized.

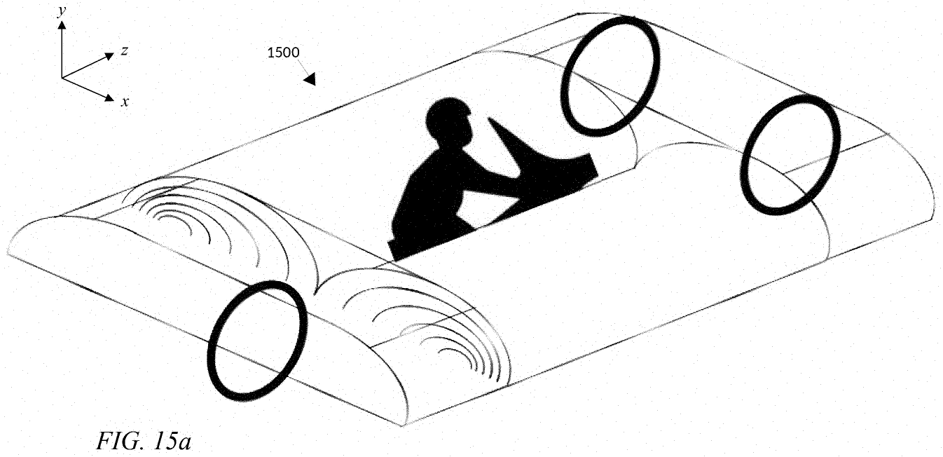

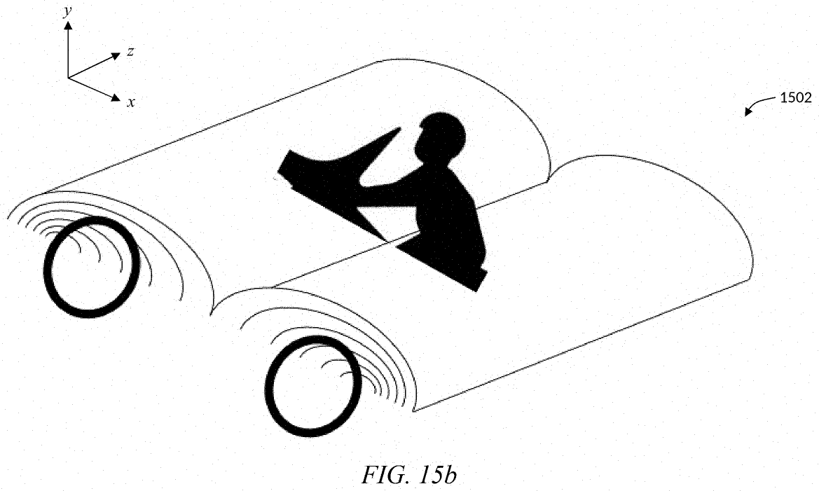

FIGS. 15a and 15b illustrate example vertical-lift flying motorcycles 1500, 1502 with low-profile ducts with unequally sized inlet and outlet areas according to one embodiment of the present disclosure. The flying motorcycle 1500 of FIG. 15a shows a ducting arrangement in which the passenger faces parallel to the ducts of the flying motorcycle, whereas the flying motorcycle 1502 of FIG. 15b shows a ducting arrangement in which the passenger faces perpendicular to the ducts of the flying motorcycle.

### Design Example

Perpendicular Orientation, Low-Profile Duct—

Table 3 shows the CFD data for the ducts in free space. The low-profile duct has a width of 2.6 m. When placed side-by-side, two adjacent ducts have a width of 5.2 m, which are oriented as shown in FIG. 15b. To put these values in perspective, the maximum width allowed for buses on that use the public highway system is z=2.6 m. Table 3 shows the volumetric flow for a single 1-m-depth duct is 15.4 m³/s at ΔP=725 Pa. With z=2.6 m, the analysis for one duct is

$$\dot{Q} = ( 2.6 m ) ( 15.4 \frac{{m}^{3}}{m \cdot s} ) = 40.0 \frac{{m}^{3}}{s}$$

$$T = ( 2.6 m ) ( 805 \frac{N}{m} ) = 2093 N$$

Two ducts are adjacent to each other, so the analysis for the pair is

$$\dot{Q} = ( 2 ) ( 40.0 \frac{{m}^{3}}{s} ) = 80.0 \frac{{m}^{3}}{s}$$

$$T = ( 2 ) ( 2093 N ) = 4186 N$$

$$m = \frac{T}{g} = \frac{4186 N}{9.81 \frac{m}{{s}^{2}}} = 426 kg = 0.427 tonne$$

$$\dot{E} = \dot{Q} Δ P = ( 80.0 \frac{{m}^{3}}{s} ) ( 725 Pa ) = 58 , 000 W = 58.0 kW$$

The upward thrust is linearly proportional to pressure difference (see FIG. 8).

$$T = {k}_{1} Δ P \\ Δ P = \frac{T}{{k}_{1}}$$

The volumetric flow is proportional to pressure difference, so the power is proportional to pressure difference squared

Ė=\dot{Q}ΔP=(k₂ΔP) ΔP=k₂ΔP²

The relationship between thrust and power follows:

$$\dot{E} = {k}_{2} Δ {P}^{2} = {{k}_{2} ( \frac{T}{{k}_{1}} )}^{2} = \frac{{k}_{2}}{{k}_{1}^{2}} {T}^{2} = k {T}^{2}$$

The amount of air power to lift 0.5 and 1.0 tonnes follows:

$$\dot{E} = 58.0 {kW ( \frac{0.5 tonne}{0.4 \; 27 tonne} )}^{2} = 79.5 kW$$

$$\dot{E} = 58.0 {kW ( \frac{1.0 tonne}{0.4 \; 27 tonne} )}^{2} = 318 kW$$

Perpendicular orientation, circular duct Table 3 shows the CFD data for the ducts in free space. The circular duct has a width of 2.6 m. When placed side-by-side, two adjacent ducts have a width of 5.2 m, which are oriented as shown in FIG. 15b. Table 3 shows the volumetric flow for a single 1 meter depth duct is 30.8 m³/s at ΔP=992 Pa. With z=2.6 m, the analysis for one duct is

$$\dot{Q} = ( 2.6 m ) ( 30.8 \frac{{m}^{3}}{m \cdot s} ) = 80.1 \frac{{m}^{3}}{s}$$

$$T = ( 2.6 m ) ( 2239 \frac{N}{m} ) = 5821 N$$

Two ducts are adjacent to each other, so the analysis for the pair is

$$\dot{Q} = ( 2 ) ( 80.1 \frac{{m}^{3}}{s} ) = 160.2 \frac{{m}^{3}}{s}$$

$$T = ( 2 ) ( 5821 N ) = 11 , 643 N$$

$$m = \frac{T}{g} = \frac{11 , 643 N}{9.81 \frac{m}{{s}^{2}}} = 1187 kg = 1.19 tonne$$

$$\dot{E} = \dot{Q} Δ P = ( 160.2 \frac{{m}^{3}}{s} ) ( 992 Pa ) = 159 , 000 W = 159.0 kW$$

The upward thrust is linearly proportional to pressure difference (see FIG. 8).

$$T = {k}_{1} Δ P \\ Δ P = \frac{T}{{k}_{1}}$$

The volumetric flow is proportional to pressure difference, so the power is proportional to pressure difference squared

Ė=\dot{Q}ΔP=(k₂ΔP) ΔP=k₂ΔP²

The relationship between thrust and power follows:

$$\dot{E} = {k}_{2} Δ {P}^{2} = {{k}_{2} ( \frac{T}{{k}_{1}} )}^{2} = \frac{{k}_{2}}{{k}_{1}^{2}} {T}^{2} = k {T}^{2}$$

The amount of air power to lift 0.5 and 1.0 tonnes follows:

$$\dot{E} = 159.0 {kW ( \frac{0.5 tonne}{1.19 tonne} )}^{2} = 28.1 kW$$

$$\dot{E} = 159.0 {kW ( \frac{1.0 tonne}{1.19 tonne} )}^{2} = 112 kW$$

Parallel Orientation, Circular Duct—

Table 3 shows the CFD data for the ducts in free space. The circular duct has a width of 2.6 m. When placed side-by-side, two adjacent ducts have a width of 5.2 m, which are oriented as shown in FIG. 15a, and could be retracted or deployed as shown in FIG. 13. Table 3 shows the volumetric flow for a single 1-m-depth duct is 30.8 m³/s at ΔP=992 Pa. With z=5.5 m (the length of a typical automobile), the analysis for one duct is

$$\dot{Q} = ( 5.5 m ) ( 30.8 \frac{{m}^{3}}{m \cdot s} ) = 169.4 \frac{{m}^{3}}{s}$$

$$T = ( 5.5 m ) ( 2239 \frac{N}{m} ) = 12 , 300 N$$

Two ducts are adjacent to each other, so the analysis for the pair is

$$\dot{Q} = ( 2 ) ( 169.4 \frac{{m}^{3}}{s} ) = 338.8 \frac{{m}^{3}}{s}$$

$$T = ( 2 ) ( 12 , 300 N ) = 24 , 600 N$$

$$m = \frac{T}{g} = \frac{24 , 600 N}{9.81 \frac{m}{{s}^{2}}} = 2510 kg = 2.51 tonne$$

$$\dot{E} = \dot{Q} Δ P = ( 338.8 \frac{{m}^{3}}{s} ) ( 992 Pa ) = 336 , 000 W = 336.0 kW$$

The upward thrust is linearly proportional to pressure difference (FIG. 8).

$$T = {k}_{1} Δ P \\ Δ P = \frac{T}{{k}_{1}}$$

The volumetric flow is proportional to pressure difference, so the power is proportional to pressure difference squared

Ė=\dot{Q}ΔP=(k₂ΔP) ΔP=k₂ΔP²

The relationship between thrust and power follows:

$$\dot{E} = {k}_{2} Δ {P}^{2} = {{k}_{2} ( \frac{T}{{k}_{1}} )}^{2} = \frac{{k}_{2}}{{k}_{1}^{2}} {T}^{2} = k {T}^{2}$$

The amount of air power to lift 0.5 and 1.0 tonnes follows:

$$\dot{E} = 336 {kW ( \frac{0.5 tonne}{251 tonne} )}^{2} = 13.3 kW$$

$$\dot{E} = 336 {kW ( \frac{1.0 tonne}{251 tonne} )}^{2} = 53.3 kW$$

Assume the following efficiencies:
Fan=85%
Electric motor=97%
Controller=98%

The electric power to lift 0.5 and 1.0 tonnes follows:

$$\dot{E} = \frac{13.3 kW}{( 0.85 ) ( 0.97 ) ( 0.98 )} = 16.5 kW$$

$$\dot{E} = \frac{53.3 kW}{( 0.85 ) ( 0.97 ) ( 0.98 )} = 66.0 kW$$

Rough Estimate of Mass for Battery-Powered System

| Item | Mass (kg) | Mass (kg) |
|---|---|---|
| Passenger/cargo | 85 | 400 |
| Motors/controllers | 40 | 40 |
| Body | 200 | 250 |
| Propellers | 40 | 40 |
| Batteries | 135 | 270 |
| Total | 500 | 1000 |

A typical lithium-ion cell, such as a Panasonic NCR18650B battery, has an energy density of approximately 243 Wh/kg.

$$Flight time = \frac{( 135 kg ) ( 243 \frac{W \cdot h}{kg} )}{( 16 , 500 W )} = 2.0 h ( at 500 kg )$$

$$Flight time = \frac{( 270 kg ) ( 243 \frac{W \cdot h}{kg} )}{( 66 , 000 W )} = 1.0 h ( at 1000 kg )$$

A 65-hp Rotax Type 582 engine can power the lighter aircraft

| Item | Mass (kg) |
|---|---|
| Passenger/cargo/fuel | 191 |
| Motors/controllers | 40 |
| Body | 200 |
| Propellers | 40 |
| 65-hp Rotax Type 582 engine | 29 |
| Total | 500 |

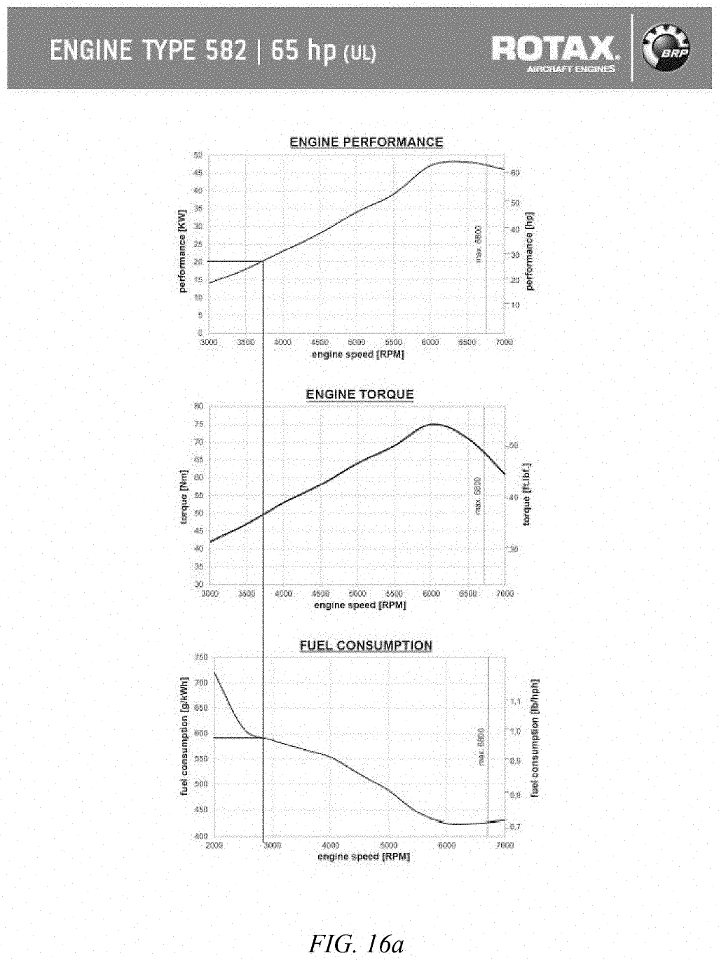

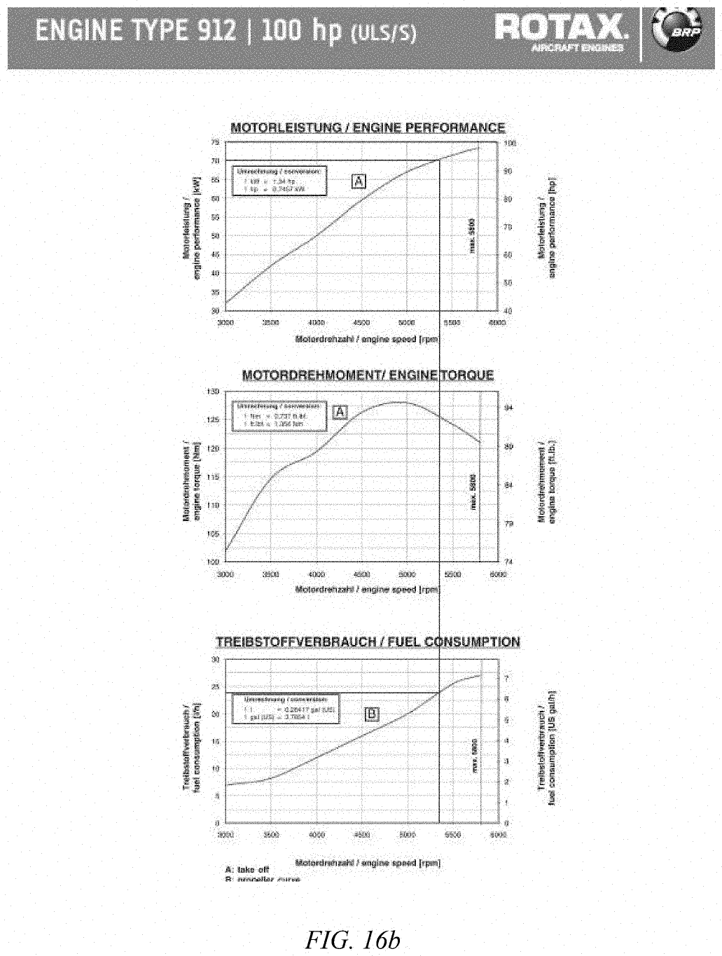

At an output power of 20 kW, the specific fuel consumption is 590 g/kWh (see FIG. 16a); therefore, the fuel consumption rate is

$$Fuel consumption rate = 20 kW \times \frac{590 g}{kWh} \times \frac{kg}{1000 g} = 11.8 \frac{kg}{h}$$

A 100-hp Rotax Type 912 engine can power the heavier aircraft

| Item | Mass (kg) |
|---|---|
| Passenger/cargo/fuel | 613 |
| Motors/controllers | 40 |
| Body | 250 |
| Propellers | 40 |
| 100-hp Rotax Type 912 engine | 57 |
| Total | 1000 |

At an output power of 70 kW, the fuel consumption rate is 24 L/h (see FIG. 16b). The density of fuel is about 0.77 kg/L, so the fuel consumption rate is 18.5 kg/h.

### Duct Options

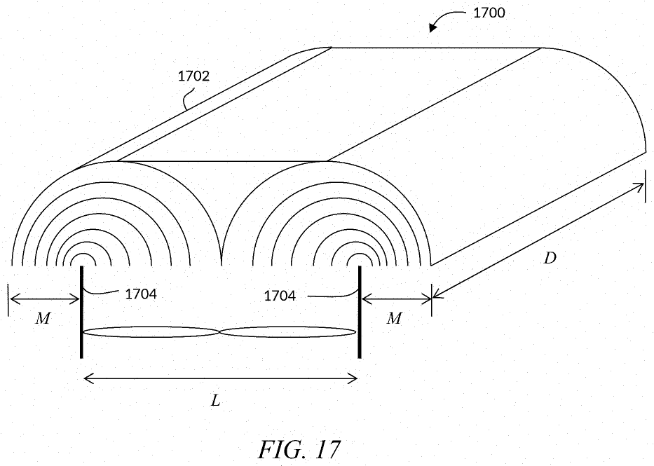

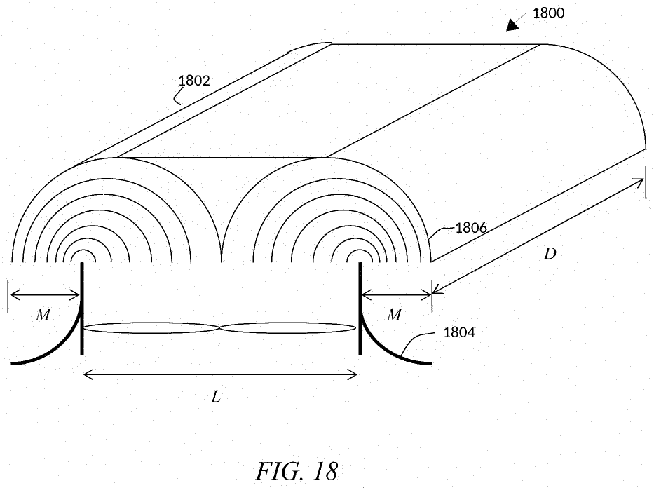

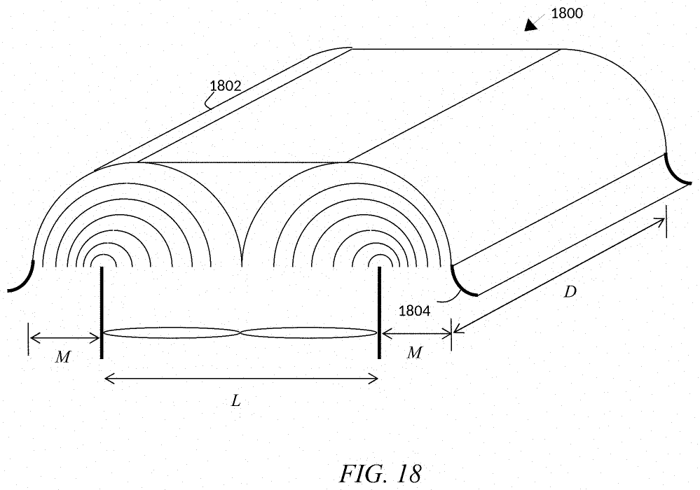

FIGS. 17 through 22 show various optional arrangements for the duct of the propulsion device, which address various means to improve efficiency or lift according to one or more embodiments of the present disclosure. In particular, FIG. 17 illustrates one embodiment of a propulsion device 1700 having a duct 1702 with a long, straight outlet portion 1704.

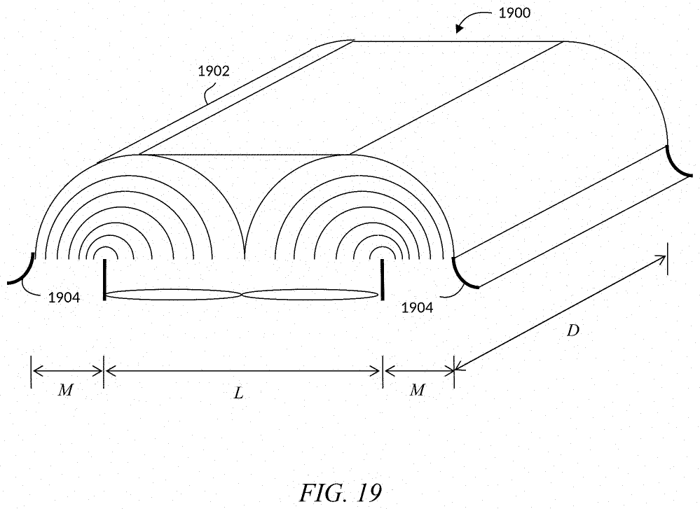

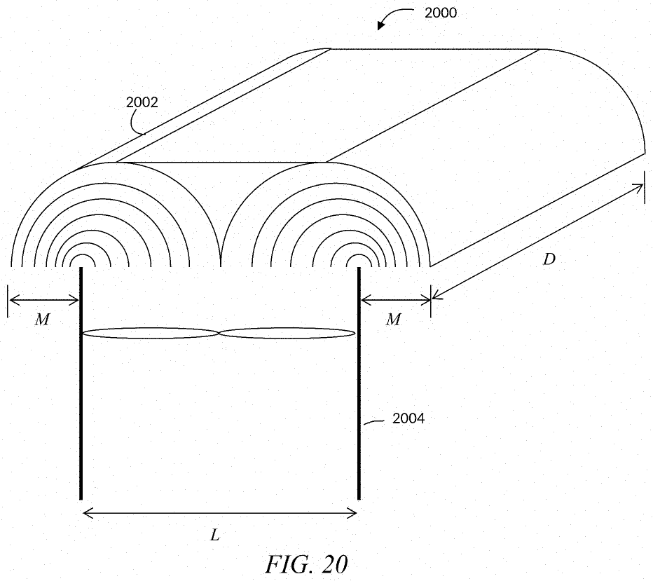

FIG. 18 illustrates another embodiment of a propulsion device 1800 having a duct 1802 with a long, straight profile. Additionally included are external turning vanes 1804 that help improve efficiency. FIG. 19 illustrates another embodiment of a propulsion device 1900 having duct 1902 a short, straight profile. Additionally included are external turning vanes 1904 that help improve efficiency. FIG. 20 illustrates another embodiment of a propulsion device 2000 having a duct 2002 with an extra-long, straight outlet portion 2004.

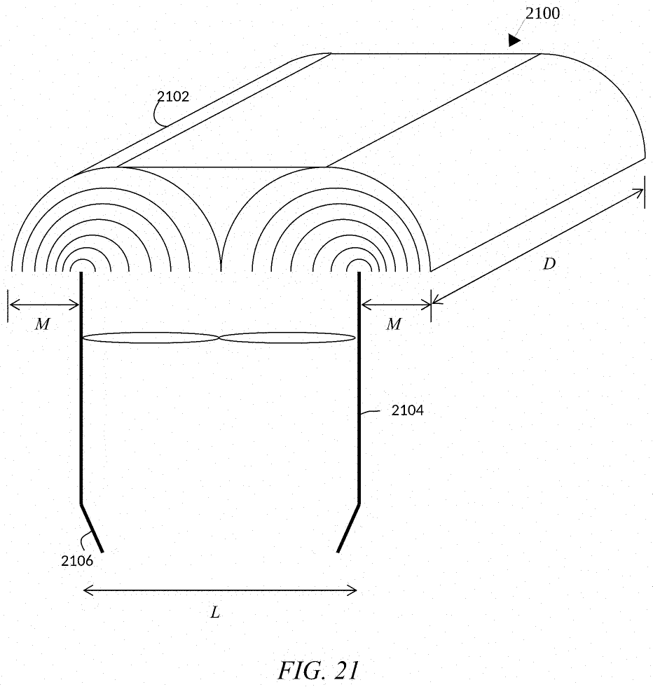

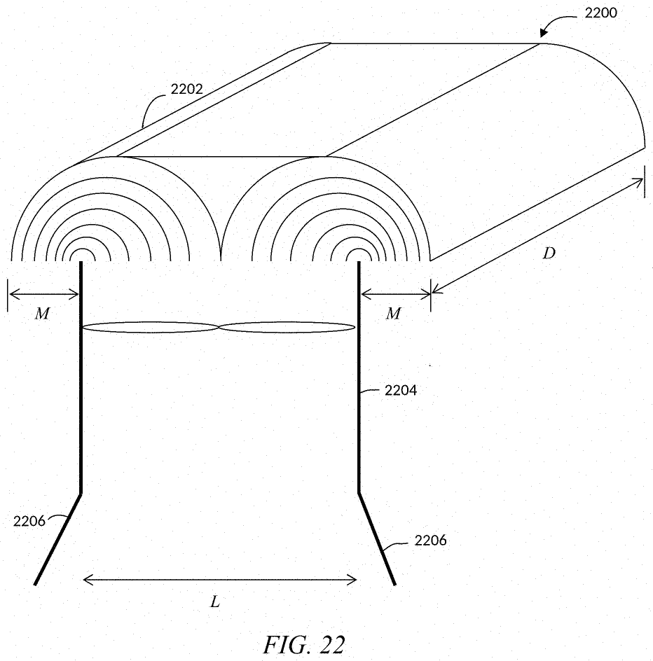

FIG. 21 illustrates another embodiment of a propulsion device 2100 having a duct 2102 with an extra-long, straight outlet portion 2104. Additionally included are converging vanes 2106 configured at the bottom end of the outlet portion to provide enhanced lift. FIG. 22 illustrates another embodiment of a propulsion device 2200 having a duct 2202 with an extra-long, straight outlet portion 2204. Additionally included are diverging vanes 2206 configured at the bottom end of the outlet portion to provide enhanced efficiency.

### Squirrel Cage Fans

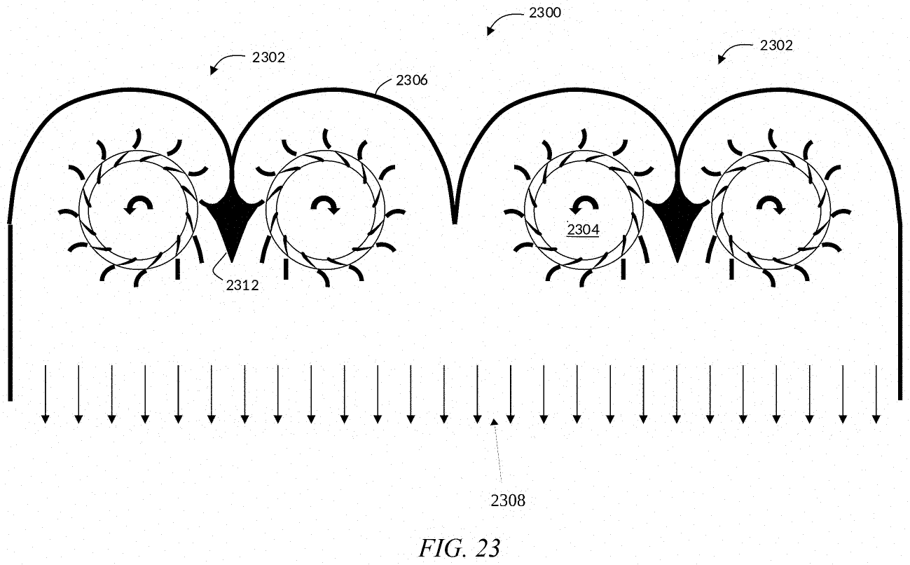

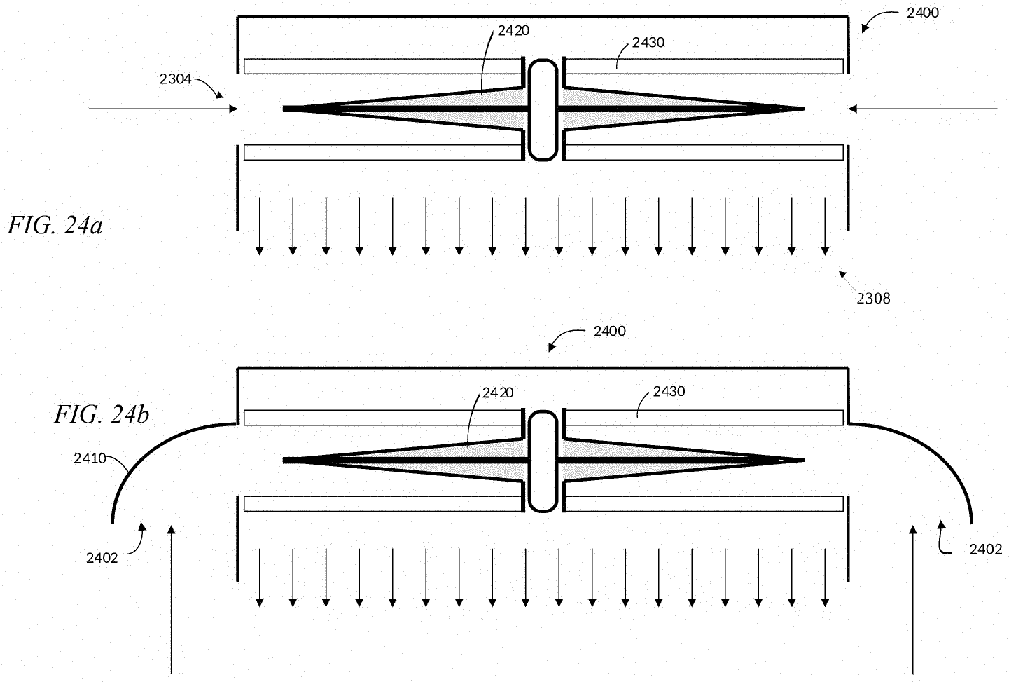

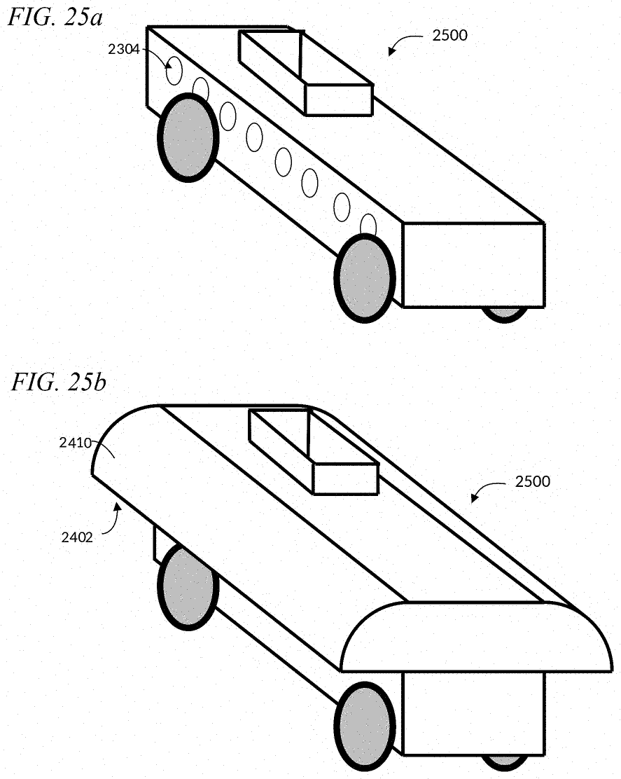

FIGS. 23 through 25 illustrate another example propulsion system utilizing squirrel cages assemblies 2300, 2400 that may be implemented on a flying car 2500 according to embodiments of the present disclosure. The propulsion system 2300 includes a duct 2306 having an inlet portion 2304 and outlet portion 2308 that are configured on a flying car 2500. FIGS. 24a and 24b show cones 2420 in the center of the squirrel cage propeller. These cones 2420 help ensure the inlet velocity to the squirrel cage blades 2430 is uniform. FIG. 25a shows the flying car 2500 with the inlet portion 2304 of the duct 2410 removed in order to reveal the inlet 2304 of the propeller, whereas FIG. 25b shows the inlet portion 2402 of the duct 2410 in operative engagement on the flying car 2500.

FIG. 23 illustrates an example squirrel cage propeller assembly 2300 that may be implemented with the propulsion system according to one embodiment of the present disclosure. The squirrel cage assembly 2300 includes two pair of squirrel cage propellers 2302, each having an inlet 2304 that receives fluid from the inlet portion of the duct 2306 to generate an outlet stream for providing lift for the flying car 2500 of FIGS. 25a and 25b. In one embodiment, each pair of squirrel cage propellers 2302 is configured to turn in opposite directions to balance angular momentum. In one embodiment, one or both pair of propellers are driven by a single motor located proximate the center of the flying car 2500. In another embodiment, a bulb 2312 helps direct the flow out of the squirrel cage.

FIGS. 24a and 24b illustrate an example squirrel cage propeller 2400 that may be implemented with the flying car 2500 according to one embodiment of the present disclosure. The squirrel cage assembly 2400 has an inlet 2402 that receives fluid from the inlet portion of the duct 2410 to generate an outlet stream for providing lift for the flying car 2500. FIG. 24a shows the assembly 2400 with the inlet portion 2410 of the duct 2306 removed, whereas FIG. 24b shows the inlet portion 2410 of the duct 2306 in operative engagement on the assembly 2400. An optional cone 2420 helps direct inlet flow in the radial direction.

In one embodiment, two vertical gyroscopes (not shown), each rotating in opposite directions may be provided. These gyroscopes stabilize the flying vehicle from gusts of wind. Also, if one gyroscope spins slightly faster than the other, the flying car can rotate and adjust yaw.

In another embodiment, horizontal thrust can be obtained by tilting the vehicle so that a portion of the lifting thrust becomes horizontal thrust. For example, forward thrust may be achieved by operating the rear fans slightly faster, which lifts the rear and tilts the vehicle. Another alternative is to operate a fan that blows air in the horizontal direction to provide horizontal thrust.

FIG. 25a illustrates an external view of the flying car with no inlet ducts 2410 whereas FIG. 25b illustrates an external view of a flying car with inlet ducts 2410.

### Circular Ducts

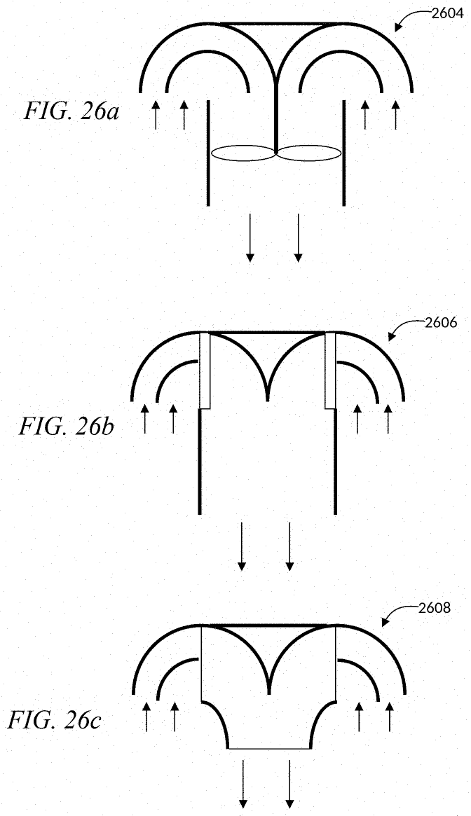

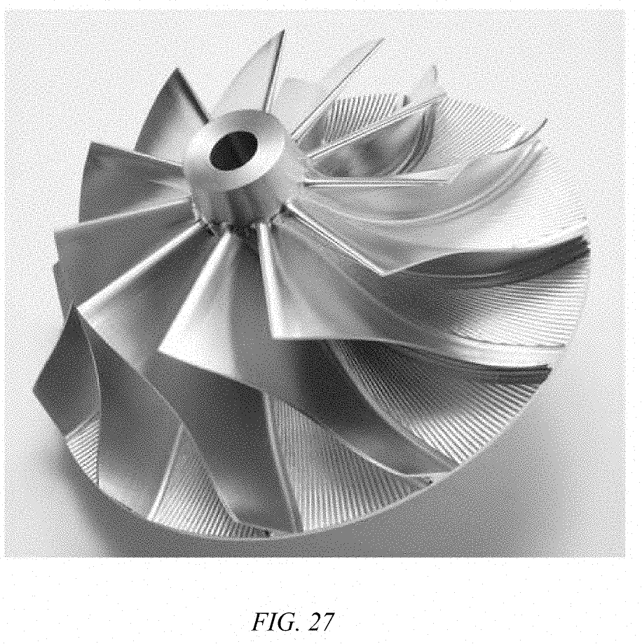

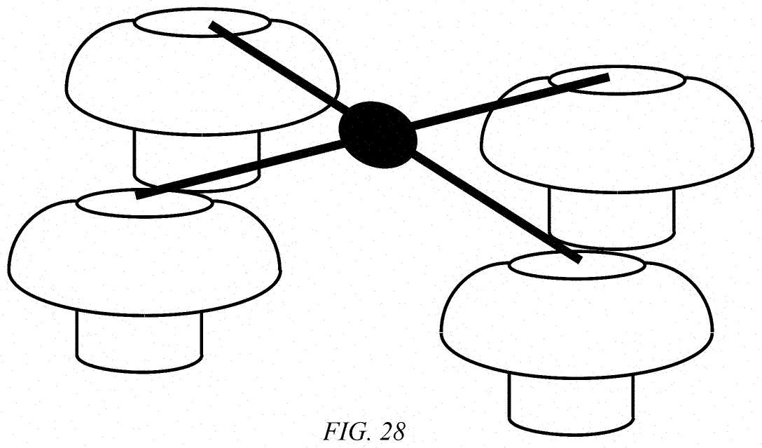

FIGS. 26a, 26b, and 26c illustrates example various propeller types that may be implemented with a circular duct according to embodiments of the present disclosure. In particular, FIG. 26a shows a ducted axial propeller 2604, FIG. 26b shows a squirrel-cage propeller 2606, whereas FIG. 26c shows a turbo propeller 2608. FIG. 27 shows an example turbo propeller as shown and described with reference to FIG. 26c. In most or all cases, the “turning duct” produces thrust as the flow reverses. In some cases, the propellers can be nested in some embodiments.

FIG. 28 illustrates multiple clustered circular ducts that combine their thrust to increase lift capability. By rotating half the fans clockwise and the other half counter-clockwise, net torque on the aircraft may be reduced or eliminated.

### Coanda Effect

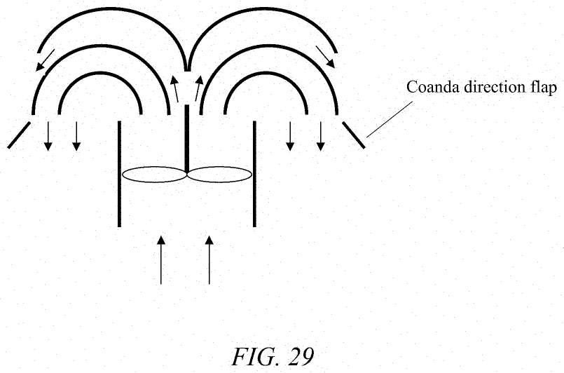

FIG. 29 illustrates an example hybrid lifting system that employs the Coanda Effect to provide additional lift. As shown, the duct includes multiple, nested vanes that direct outlet stream generated by the propeller through a directional turn. Bleed air from the center flows over the upper surface of the inner turning vanes and thereby reduces the pressure on the upper surface via the Coanda Effect. This embodiment can be practiced either in a linear duct or circular duct. Directional flaps on the exterior provide some control of the lifting surfaces.

### Jet Engines

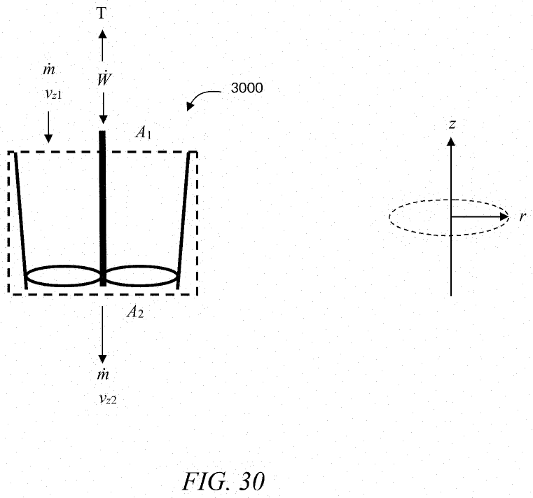

FIGS. 30 through 32 illustrate example jet engines 3000, 3100, and 3200 that may be implemented with the propulsion system according to embodiments of the present disclosure. In particular, FIG. 30 illustrates a schematic diagram of a conventional axial jet engine, so named because most or all the fluids flow generally in an axial direction. In the context of the present disclosure, the jet engine 3000 would be immersed in air (e.g., airplane) or water (e.g., ship). Fluid (water or air) enters the inlet with area A₁ at low velocity v_{z1}, the velocity of the vehicle. The fluid exits the outlet with area A₂ at higher velocity v_{z2} because A₂<A₁. Because of Newton's third law, a thrust T acts on the body, which propels the engine forward.

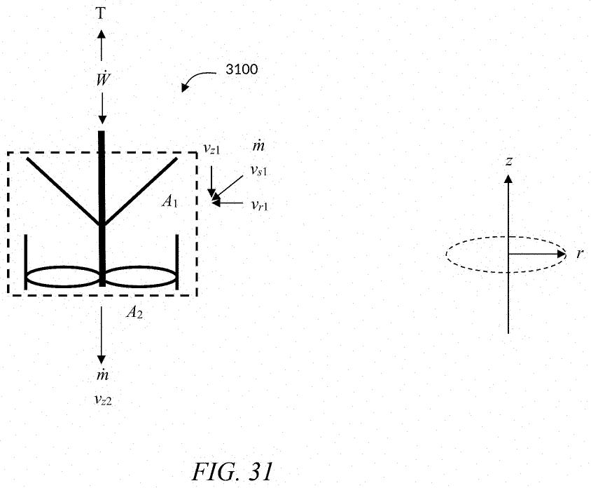

FIG. 31 illustrates a schematic of a radial jet engine 3100, so named because the inlet fluid has a radial component to its velocity. Fluid enters along the circumferential opening with area A₁ and exits from the axial opening with area A₂. A conical plate redirects the radial flow into the axial direction resulting in axial thrust acting on the conical plate. As shown previously, when fluid enters through a 90-degree duct, thrust is greater than a conventional propeller.

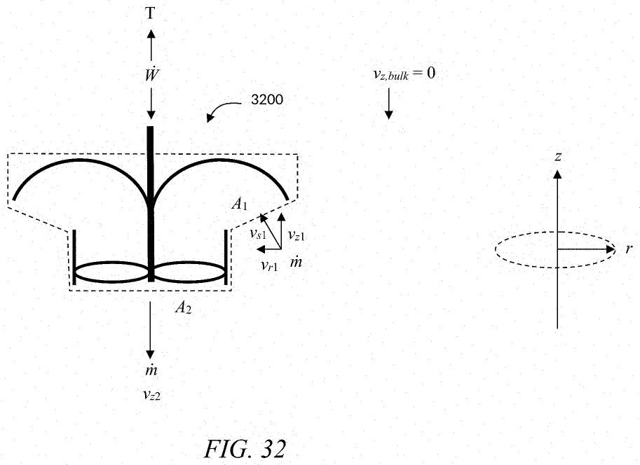

FIG. 32 illustrates a reverse-flow jet engine 3200. Flow enters from the bottom and encounters a thrust plate that reverses the flow through a 180-degree duct. As shown previously, when fluid enters through a 180-degree duct, thrust is greater than a conventional propeller.

### Water Vehicles

### Torpedo

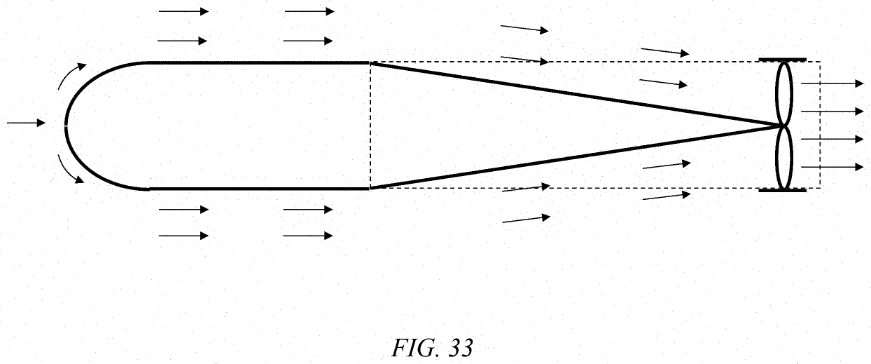

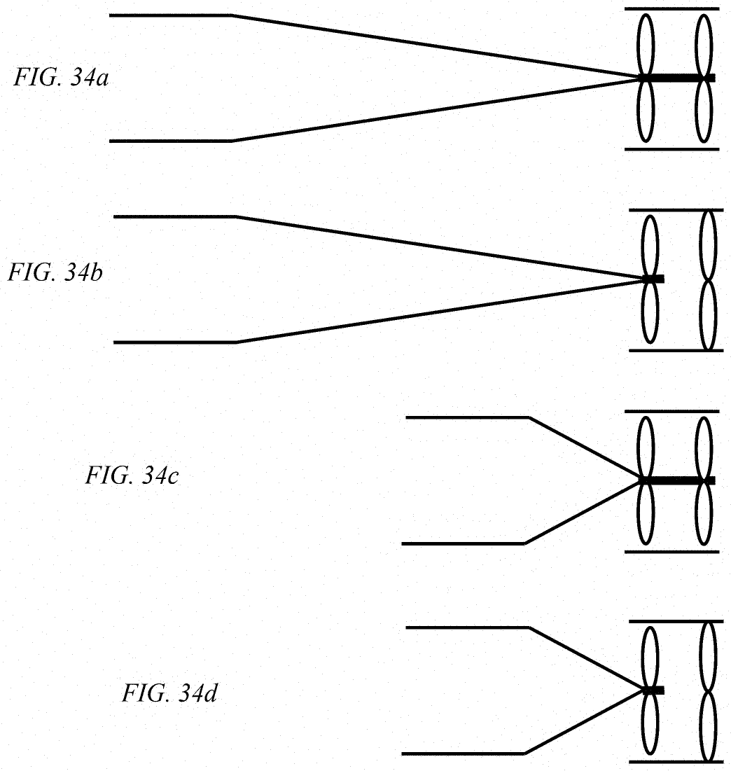

FIGS. 33 through 38 illustrate example torpedoes that may be implemented with the propulsion system according to embodiments of the present disclosure. In particular, FIG. 33 shows the flow around a conventional torpedo whereas FIGS. 34a through 34d show various options for torpedoes with axial propellers. FIG. 34a describes two counter-rotating propellers, which are often used in torpedoes. FIG. 34b describes a single rotating propeller with a stationary stator to remove the rotation from the exiting fluid. Both FIGS. 34a and 34b employ a shallow-angle inlet cone leading to the propeller. FIGS. 34c and 34d are comparable to FIGS. 34a and 34b, except that a steep-angle inlet cone leads to the propeller, which shortens the length of the torpedo. However, an undesirable feature of this approach is that there may be flow separation between the fluid and the inlet cone. In torpedoes, a shallow angle is employed to prevent flow separation, which would increase form drag.

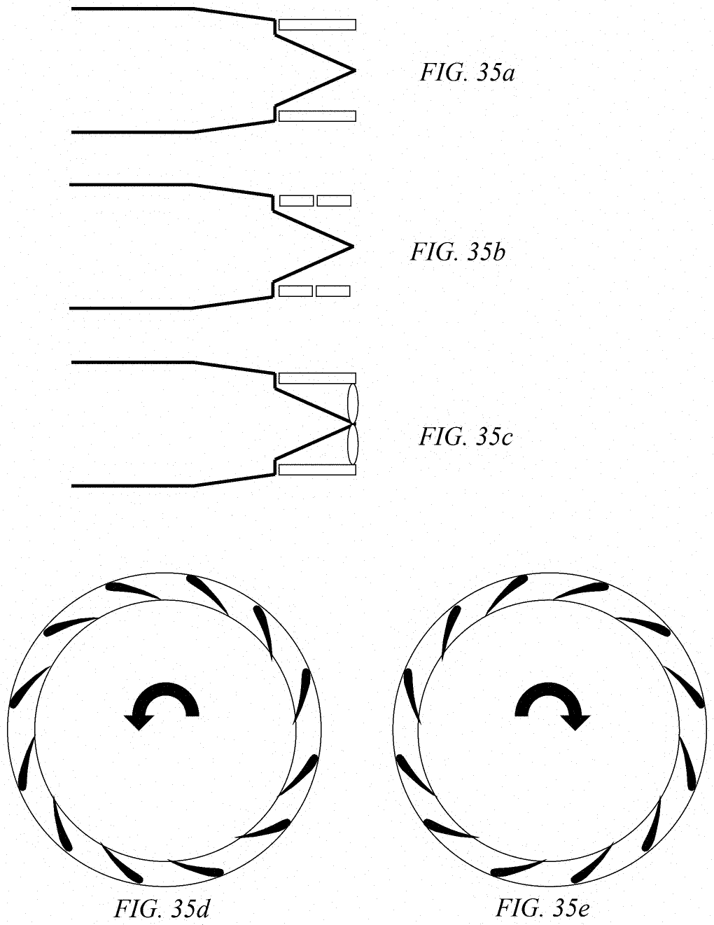

FIGS. 35a through 35e illustrate several embodiments of squirrel-cage propellers that may be used with a torpedo according to embodiments of the present disclosure. In particular, FIG. 35a shows a single squirrel-cage propeller, FIG. 35b shows a double squirrel-cage propeller with counter rotation, FIG. 35c shows a single squirrel-cage propeller with a stationary stator to remove rotation from the exiting fluid, FIG. 35d shows the blade design for a counter-clockwise rotation and FIG. 35e shows the blade design for a clockwise rotation.

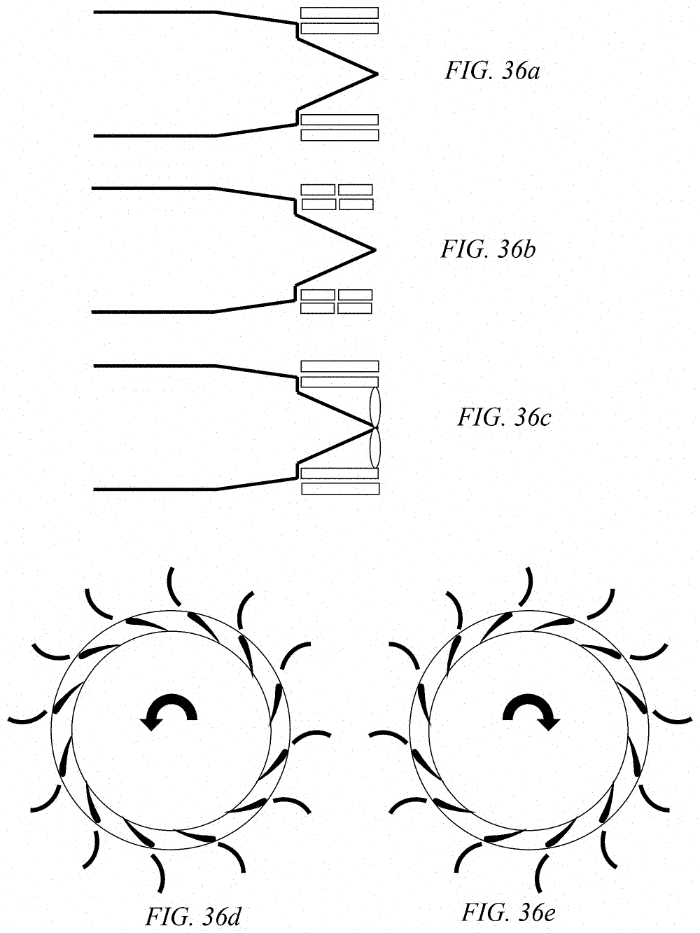

FIGS. 36a through 36ed illustrate other embodiments of the squirrel-cage propeller, which are similar to the embodiments of FIGS. 35a through 35e, except that turning vanes are employed.

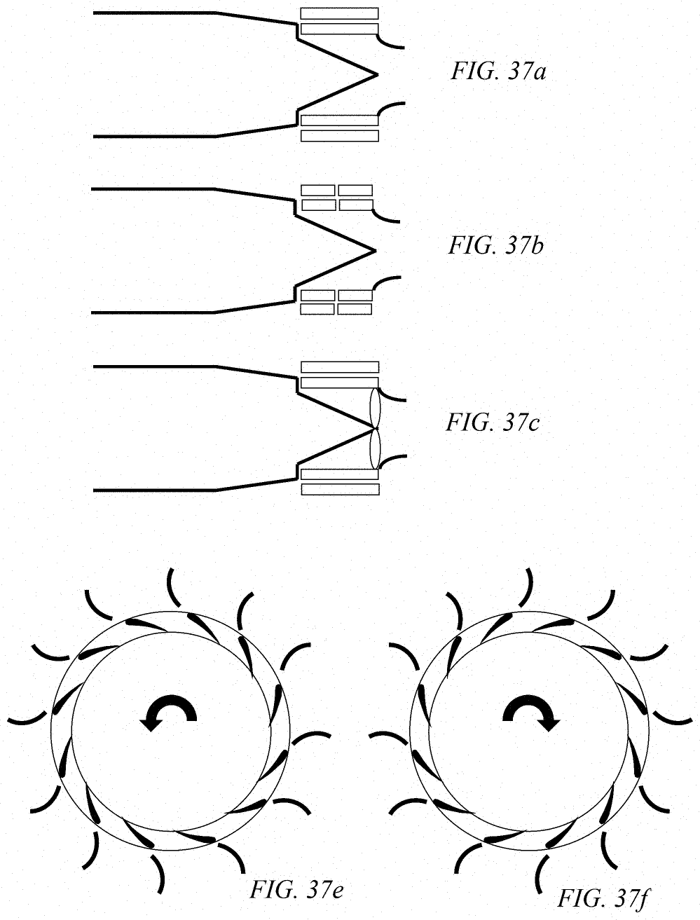

FIG. 37a through 37e illustrate other embodiments of the squirrel-cage propeller, which are similar to the embodiments of FIGS. 36a through 36e except that a reduction nozzle is employed at the outlet. This embodiment would be used if the propeller diameter were small, but high thrust is required. Because of the nozzle, the interior pressure of the squirrel-cage propeller is large, which applies a large force to the interior cone of the propeller and thereby produces a large thrust.

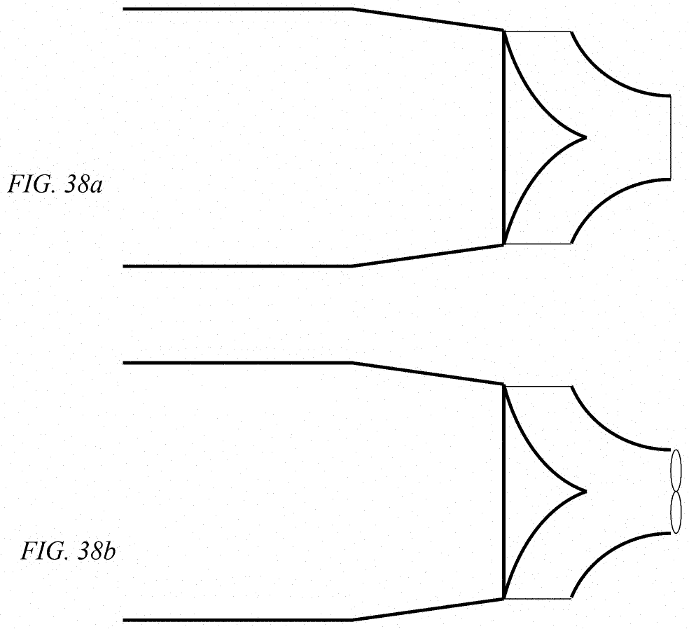

FIGS. 38a and 38b are cut-away views showing the interior and exterior cone of a turbo propeller. FIG. 38a does not include a stator. FIG. 38b includes a stator to remove rotation from the fluid exiting the propeller.

### Jetboat

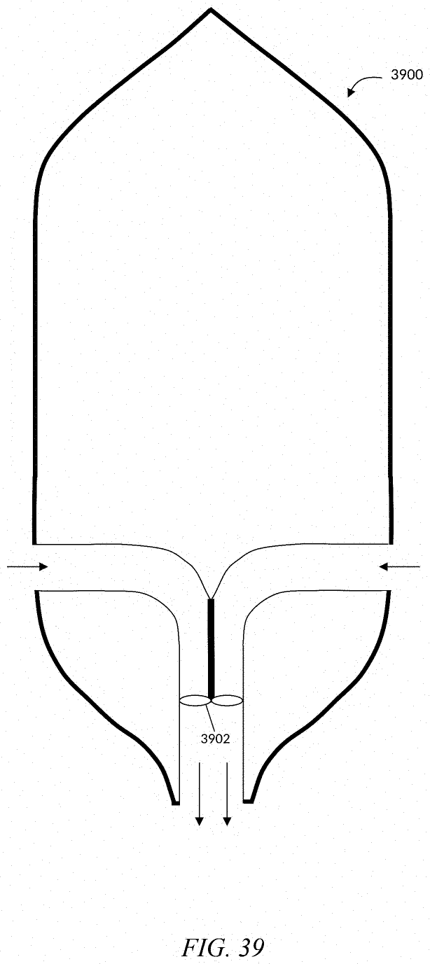

FIG. 39 illustrates a jet boat 3900 in which the propeller 3902 (e.g., a ducted axial propeller) is located in the interior of the boat. The inlet water feeding the interior propeller comes from opposite sides of the boat; therefore, the inlet momentum is canceled. When the fluid makes the turn toward the propeller, forward thrust is imparted. Additional forward thrust is imparted from the momentum of the fluid ejected from the rear of the boat.

### Small Waterplane Area Twin Hull (SWATH) Boat

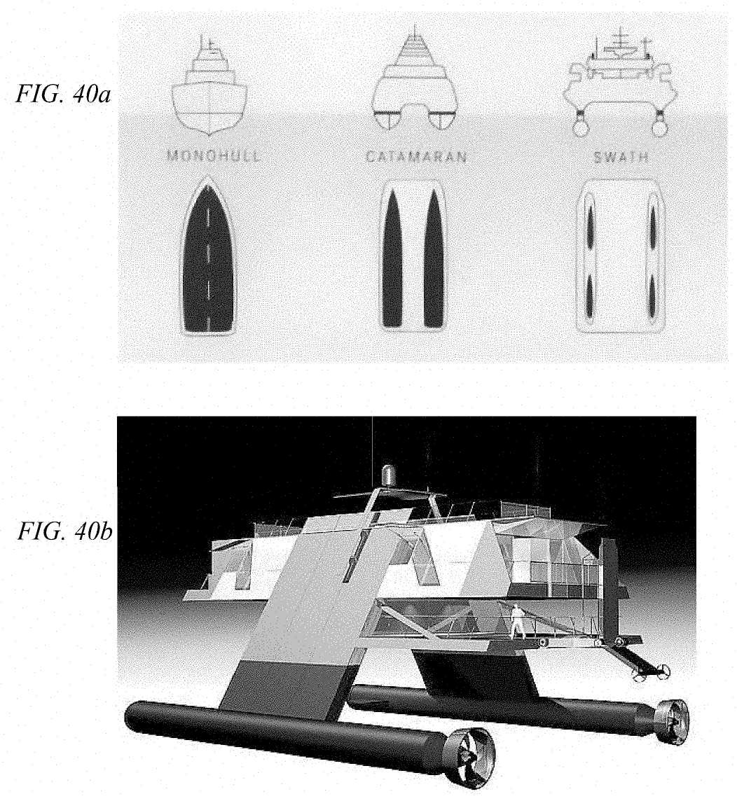

FIGS. 40a and 40b illustrate various bottom and frontal views of a traditional monohull boat hull, a catamaran boat hull, and a Small Waterplane Area Twin Hull (SWATH) hull. One advantage of a SWATH hull is that only a small portion of the hull is exposed to the water line, so there is minimal wave production, which reduces power consumption. FIG. 40b shows an artist's concept for a SWATH employing a steep-angle inlet cone ducted axial propeller. Alternatively, the squirrel-cage propeller or turbo propeller could be used.

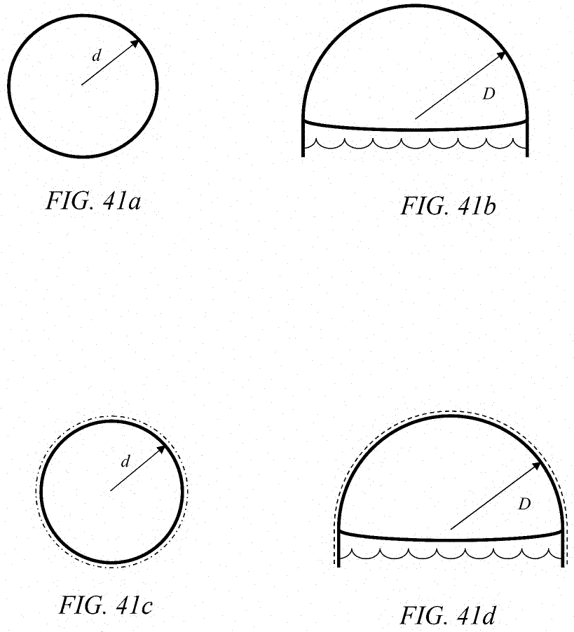

FIG. 41 shows the submerged portion of SWATH boat. FIG. 41a shows the circular cross section, as illustrated in FIG. 40b. FIG. 41b shows a semi-circular cross section, which is open on the bottom and filled with air.

FIGS. 41c and 41d show an option for reducing viscous drag. A porous membrane surrounds the hull. The membrane could be a variety of materials; however, Teflon is envisioned because of its low surface energy, which will reduce adhesion of fouling materials. The membrane could be made from expanded Teflon (i.e., Gore Tex), woven Teflon fibers, non-woven Teflon fibers, Teflon felt, or sintered Teflon particles. Alternatively, the membrane could be sintered metal. Alternatively, the sintered metal could be coated with Teflon or electroless nickel/Teflon. Compressed air is forced between the membrane and the solid surface so that small bubbles of air are trapped in the membrane pores. Primarily, the water interfaces with air rather than a solid surface, which reduces friction.

Monohull Boat with Radial Jet Engine

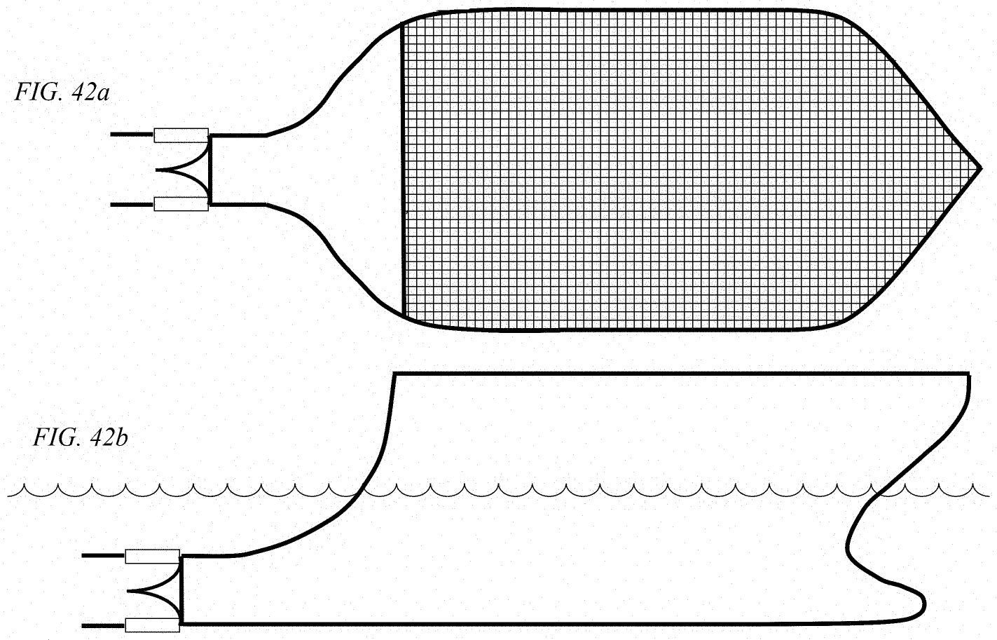

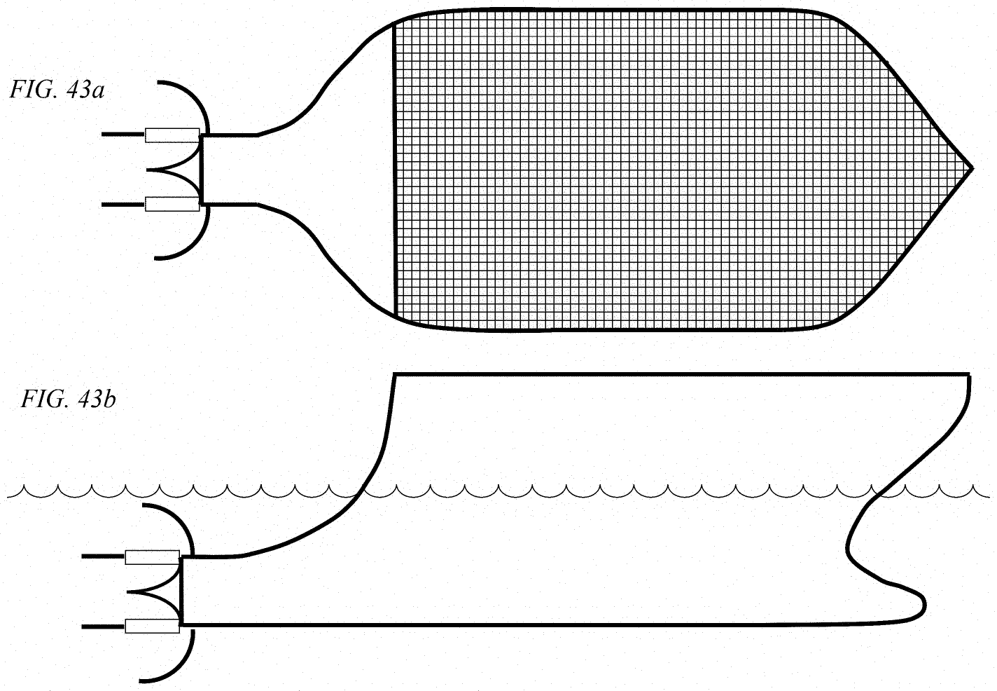

FIGS. 42a and 42b illustrate bottom and side views, respectively, of a monohull boat in “travel mode” meaning it is traveling with a significant forward velocity. FIGS. 43a and 43b illustrate bottom and side views, respectively, showing another monohull boat in “thrust mode” meaning it is traveling with a nearly zero velocity, but has tremendous thrust. For example, thrust mode would be useful for icebreakers. While in thrust mode, because of the 180-degree bend, the boat will produce significantly more thrust than a conventional propeller.

Thrust mode is achieved by placing the turning duct just forward of the radial jet engine. While in travel mode, the turning ducts could be removed and stored elsewhere on the boat. Ideally, they could be retracted into the hull using a hydraulic piston. Alternatively, they can be physically removed and placed on deck.

### Jet Pack

For flight vehicles, thrust is given by

Thrust=(mass flow rate)×(velocity)

and power is given by

Power=1/2(mass flow rate)×(velocity)²

Clearly, from these fundamental relationships, it is more energy efficient to achieve a given thrust by moving a large mass flow with a small velocity rather than a small mass flow with a large velocity. This invention aims to improve efficiency by employing a jet ejector to increase the mass flow in a vertical-lift jet pack. The jet ejector will “amplify” the thrust produced by the primary source of high-velocity gas: rocket, electric-powered fan, or micro jet engine. Further thrust enhancement occurs from directional changes in air flow.

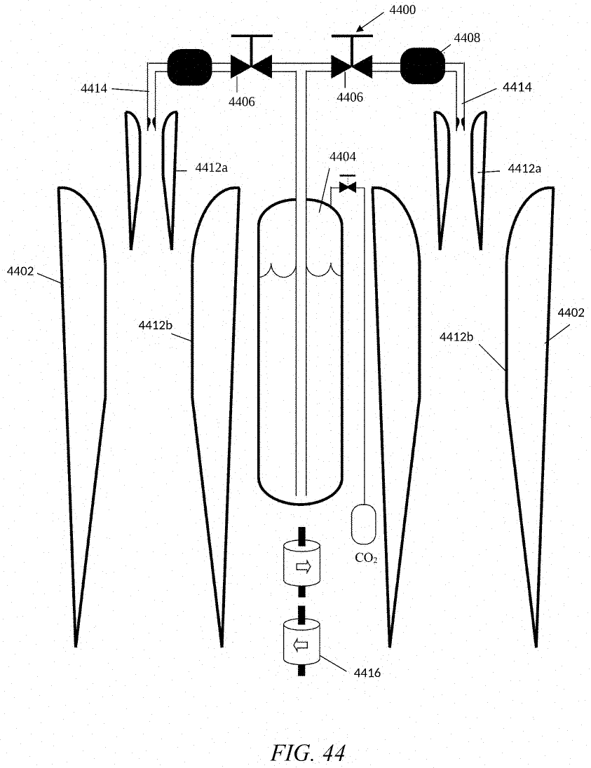

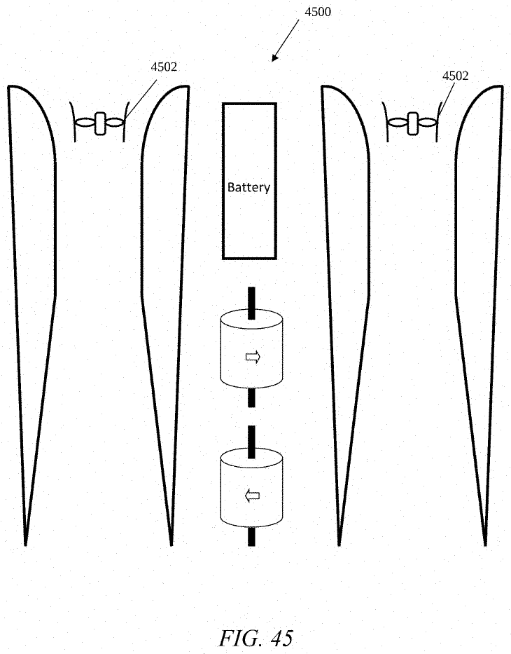

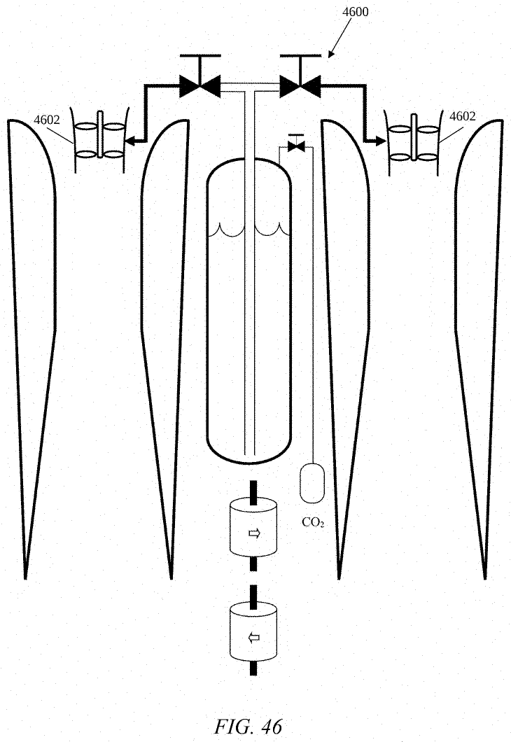

FIG. 44 is a schematic diagram illustrating an example jet pack 4400 according to one embodiment of the present disclosure. The jet pack 4400 generally includes two engines, each having two nested jet ejectors 4412a, 4412b that are powered by high-pressure propellant fuel stored a storage tank 4404. Two valves 4406 are provided that independently control the flow of fuel to nozzles 4414 configured on each engine. As shown, high-pressure propellant fuel delivered to each engine is provided by catalyst beds 4408 that decomposes the propellant fuel from the storage tank 4404 to produce high-velocity gases. The storage tank 4404 may store the propellant fuel at high pressure (as shown), or alternatively, the storage tank 4404 may store the propellant fuel at a relatively low pressure in which the propellant fuel is delivered to the catalyst bed 4408 via a pump (not shown).

Classically, the propellant fuel used by jet packs is high-concentration (˜90%) hydrogen peroxide dissolved in water. When passed over a catalyst bed (e.g., silver, manganese dioxide), the following reaction occurs:

2H₂O₂→2H₂O+O₂

The reaction is exothermic so the product water is steam.

The energy density of the propellant fuel mixture can be increased by adding a reducing component, such as alcohol, sugar, or a hydrocarbon. Although many compositions work, a typical propellant fuel mixture may typically consist of the following materials, namely hydrogen peroxide=40%, reducing component=20%, and water=40%

If the reducing component is not soluble in water (e.g., hydrocarbon), it may then be stored in a separate tank.

The above examples are not limiting; thus, other propellant fuels may be employed, such as hydrazine.

In one embodiment, counter-rotating flywheels 4416 can be located on the jet pack 4400 to enhance stability. Furthermore, if the rotation rate of one flywheel 4416 is greater than the other, it allows the jet pack to rotate about the vertical z-axis, thus providing an element of control. In another embodiment, two pairs of counter-rotating flywheels can be oriented with the rotation axes at right angles with respect to each other, thus allowing stable control in both the x-axis and z-axis.

To productively use the volume of the annulus inside the jet ejector, the walls can be hollow to provide space for fuel storage in some embodiments.

FIG. 45 illustrates a schematic diagram of another example jet pack 4500 according to one embodiment of the present disclosure. The jet pack 4500 is similar in design and construction to the jet pack 4400 shown and described above with reference to FIG. 44, except that electricity-powered ducted fans 4502 replace the ejectors 4412a, rocket nozzle 4414 combination. A hollow annulus may be configured in the jet ejector 4412b to store batteries.

FIG. 46 illustrates a schematic diagram of another example jet pack 4600 according to one embodiment of the present disclosure. The jet pack 4600 is similar in design and construction to the jet pack 4400 shown and described above with reference to FIG. 44, except that fuel-powered micro jet engines 4602 replace the ejectors 4412a, rocket nozzle 4414 combination. Commercially available micro jet engines, which are readily available for propelling model airplanes and drones, would be ideally suited for this application.

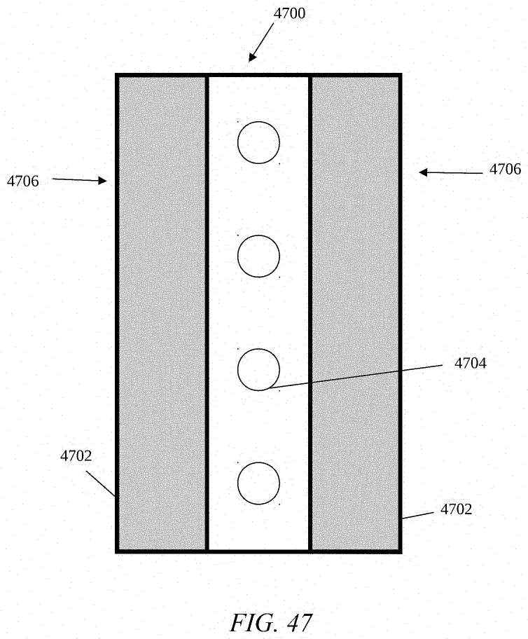

FIG. 47 illustrates a top view of an example jet ejector 4700 according to one embodiment of the present disclosure. The jet ejector 4700 includes opposing ducts 4702 that are disposed on both sides of four engines 4704 that are arranged in a linear fashion relative to one another. For example, each engine 4704 may include an engine 4402, 4502, 4602, such as described above with reference to FIGS. 44, 45, and 46. The engines 4704 are configured to receive a fluid (e.g., air) to generate an inlet fluid flow through an inlet portion 4706 of the duct 4702 and generate an outlet fluid flow through an outlet portion of the duct 4702, which in this particular example, would be downward beneath the engines 4704. The inlet portion 4706 is bent in a circular shape to alter a direction of a corresponding either one of the input stream or the output stream generated by the engines 4704.

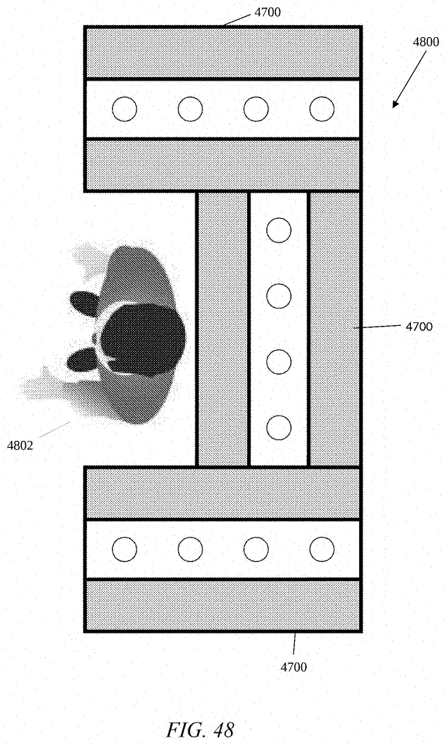

FIG. 48 illustrates a top view of a linear jet ejector assembly 4800 according to one embodiment of the present disclosure. The linear jet ejector assembly 4800 generally includes three jet ejectors 4700 arranged as shown. A passenger 4802 is shown in operative position with regard to the jet ejector assembly 4800 such that, when thrust is applied by the assembly 4800, the passenger 4802 may be lifted from the ground.

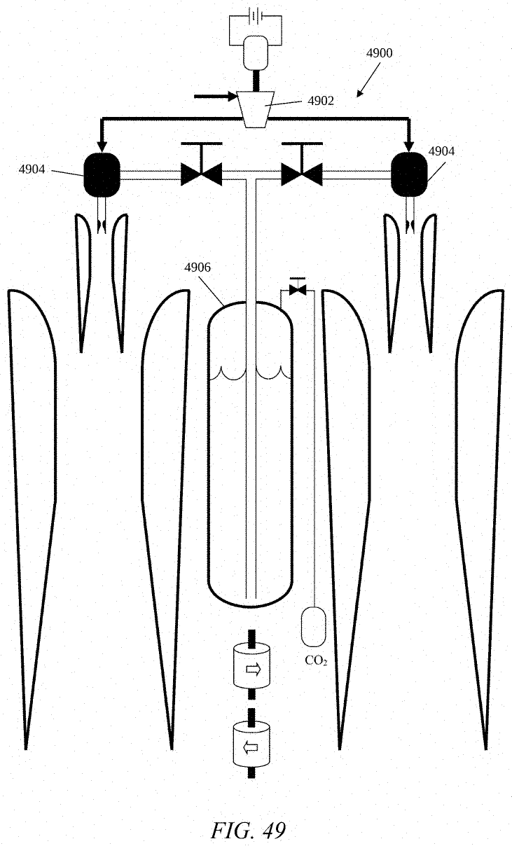

FIG. 49 is a schematic diagram of an example jet pack 4900 according to one embodiment of the present disclosure. The jet pack 4900 includes an electricity-powered blower 4902 that provides pressurized air to a combustor 4904. Fuel is added to the combustor 4904 from a pressurized fuel tank 4906. In other embodiments, a pump could provide fuel from an atmospheric-pressure tank (not shown).

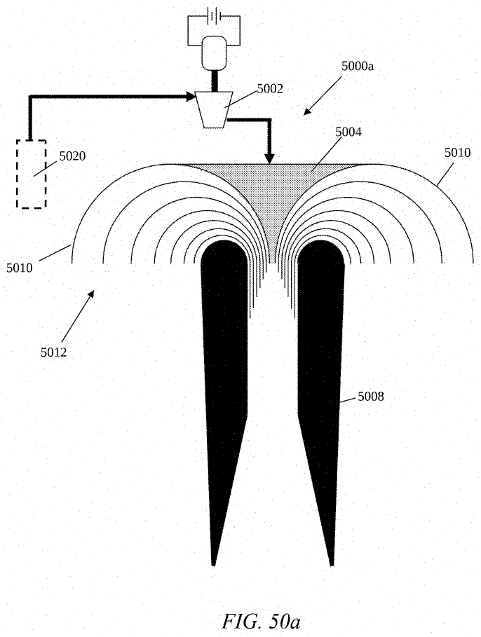

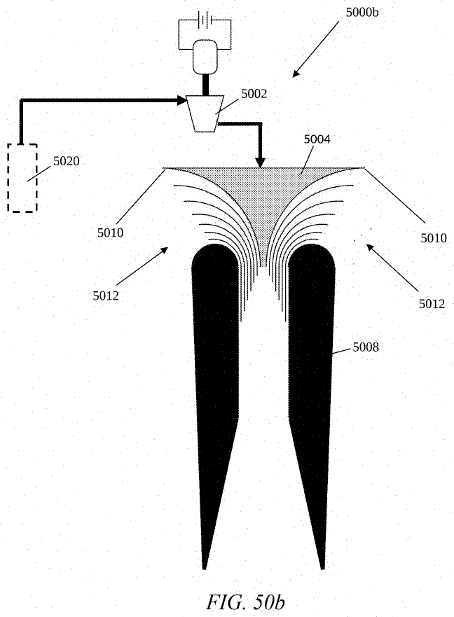

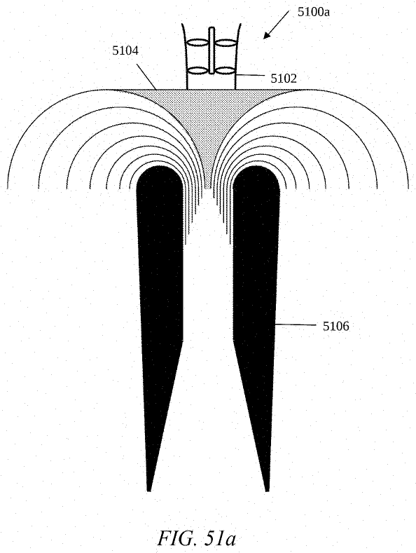

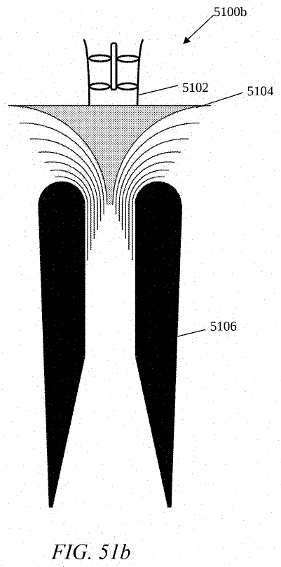

FIGS. 50a and 50b illustrate an example jet ejector 5000a, 5000b according to one embodiment of the present disclosure. The jet ejector 5000a of FIG. 50a includes a duct with an inlet portion that is bent at a 180-degree angle, whereas the jet ejector 5000b of FIG. 50b includes a duct with an inlet portion that is bent at a 90-degree angle. The jet ejector 5000 includes an electricity-powered blower 5002 that pressurizes a reservoir 5004 denoted by the gray-shaded area. The pressurized air flows through a nozzle that induces air flow through a jet ejector 5008 with turning vanes 5010. The change in flow direction from the turning vanes enhances lift. Similarly, flow directional changes in the compressor inlet enhances lift. In some embodiments, a hollow region inside the ejector 5008 may be used to hold batteries.

The geometry of the jet ejector 5008 can be circular or linear. The inlet portion 5012 of the turning vanes can be greater than or less than the outlet area from the jet ejector 5008. The blower 5002 can be any desired type (e.g., axial, centrifugal, or squirrel cage). To reduce noise, the compressor inlet can be configured with a muffler 5020 in some embodiments.

In one embodiment, the reservoir 5004 can be heated by burning a fuel, which increases the velocity through the nozzle and thereby reduces the required power input from the blower.

To improve efficiency, the air exiting the nozzle is blended with turning-vane air in stages, which may minimize velocity differences upon mixing and thereby improving efficiency.

FIGS. 51a and 51b illustrate other example jet packs 5100a, 5100b according to one embodiment of the present disclosure. The jet pack 5100a, 5100b are similar to the jet packs 5000a, 5000b of FIGS. 50a and 50b, except that the exhaust from a jet engine 5102 pressurizes the reservoir 5104. Additionally, a hollow cavity in the jet ejectors 5106 can be used to house the fuel.

To improve efficiency, the air exiting the nozzle is blended with turning-vane air in stages, which minimizes velocity differences upon mixing and thereby improving efficiency.

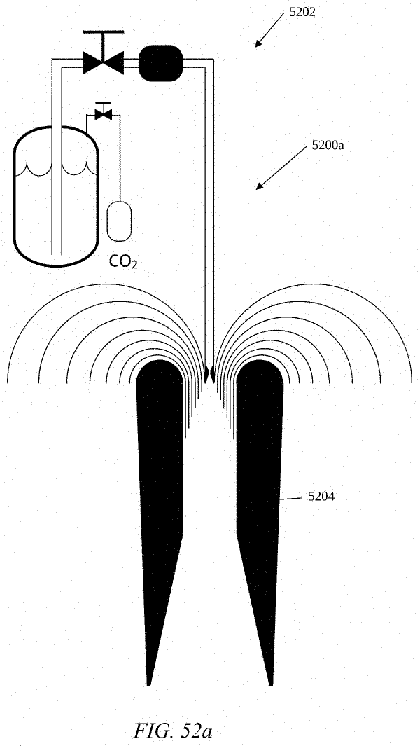

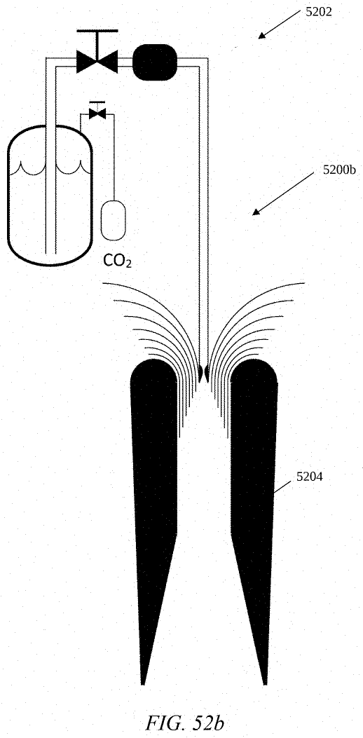

FIGS. 52a and 52b illustrate other example jet packs 5200a, 5200b according to one embodiment of the present disclosure. The jet packs 5200a, 5200b are similar to jet packs 5100a, 5100b, except that a rocket 5202 is implemented to induce flow through the jet ejector 5204.

To improve efficiency, the air exiting the nozzle is blended with turning-vane air in stages, which minimizes velocity differences upon mixing and thereby improves efficiency. That is, the end of each vane is configured at different positions along the duct so that air exiting each vane may be introduced at different positions in the duct. Additionally, a hollow region configured in the ejector 5204 may be used to hold the rocket propellant.

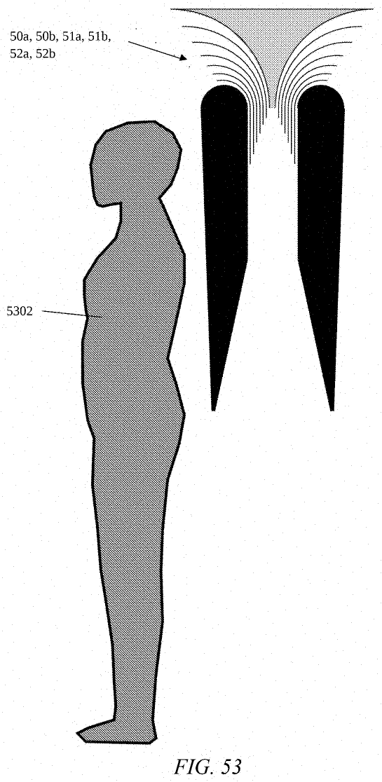

FIG. 53 shows the jet packs illustrated in FIGS. 50a, 50b, 51a, 51b, 52a, and 52b mounted to the back of a passenger 5302.

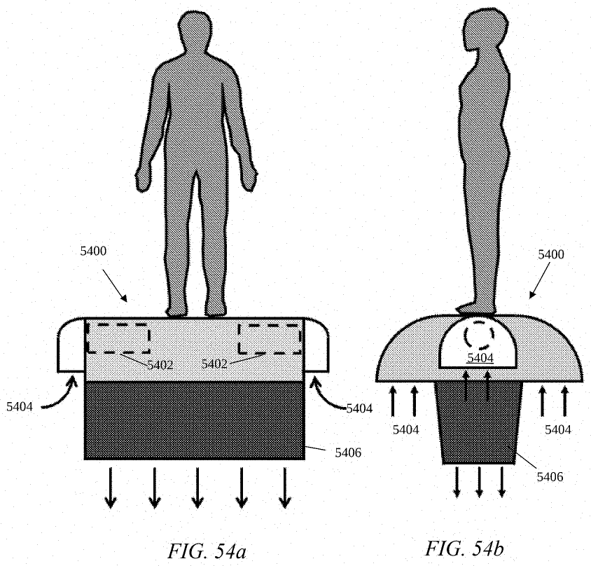

FIGS. 54a and 54b illustrate a front view and a side view, respectively, of an example lift platform 5400 according to one embodiment of the present disclosure. The lift platform 5400 includes one or more gas-moving devices 5402 (e.g., electricity-powered fan, jet engine, propeller, rocket), a duct inlet 5404, and a duct outlet 5406. The air is drawn in from the bottom, which gives additional lift when the air turns direction. The duct inlet 5404 may include a muffler to reduce noise. Nevertheless, it should be appreciated that the duct inlet 5404 may be omitted if not needed or desired.

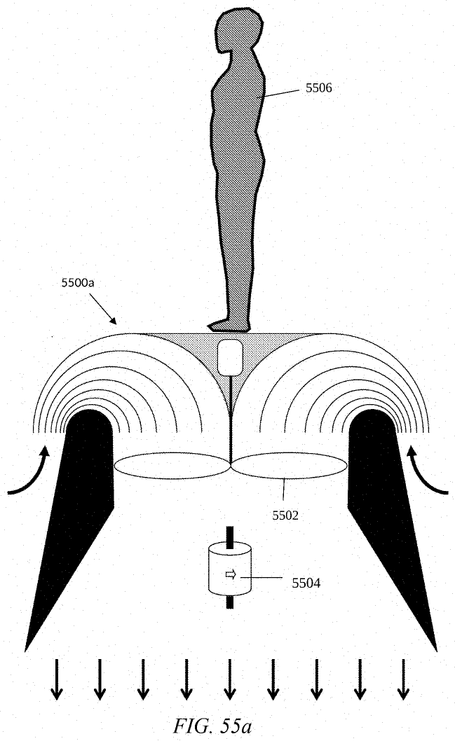

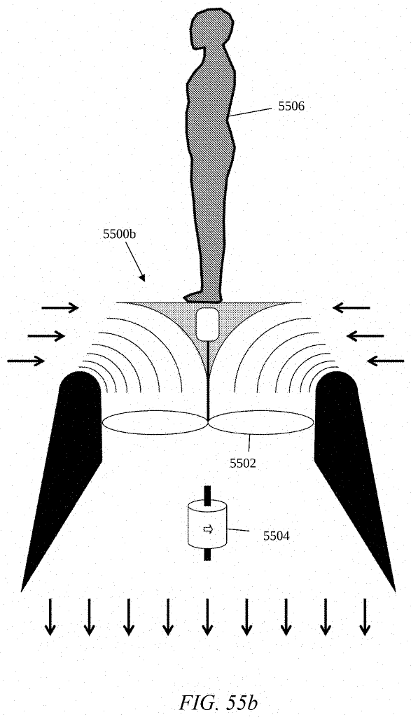

FIGS. 55a and 55b illustrates other example lift platforms 5500a, 5500b according to one embodiment of the present disclosure. The lift platform 5500 includes a single-propeller 5502 for providing lift. A gyroscope 5504 is included, which rotates opposite the propeller to prevent the platform from rotating due to torque imparted by the propeller 5502. If a passenger 5506 wishes to rotate the platform about its vertical axis, he or she can cause the gyroscope 5504 to rotate slightly faster or slower. The lift platform can be implemented in a circular or linear geometry.

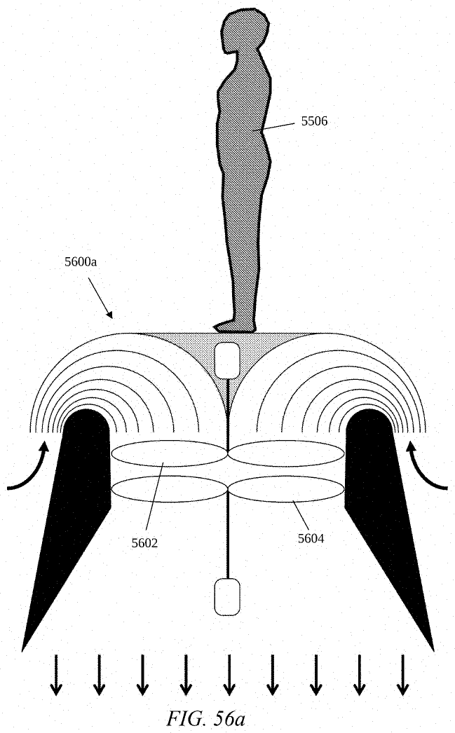

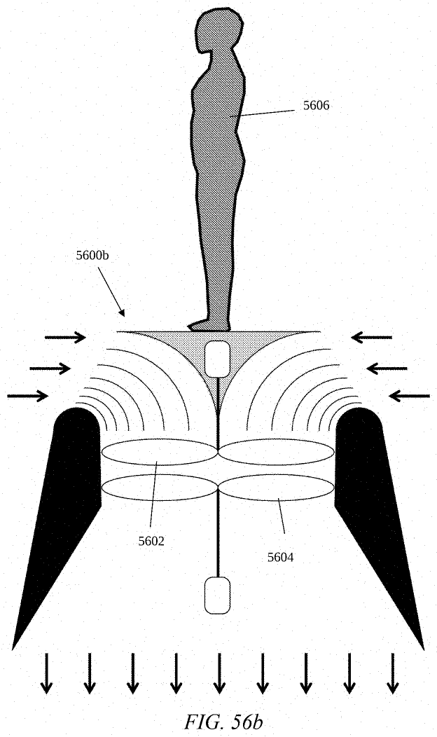

FIGS. 56a and 56b illustrates other lift platforms 5600a, 5600b according to one embodiment of the present disclosure. Each lift platform 5600a, 5600b includes a double-propeller assembly including two propellers 5602, 5604. Each propeller 5602, 5604 rotates in an opposite direction to prevent the platform from rotating. If a passenger 5606 wishes to rotate the platform about the vertical axis, he or she can rotate one propeller slightly faster and the other slightly slower. The platform will rotate in the direction opposite of the faster propeller. The lift platform can be implemented in a circular or linear geometry.

### Ships

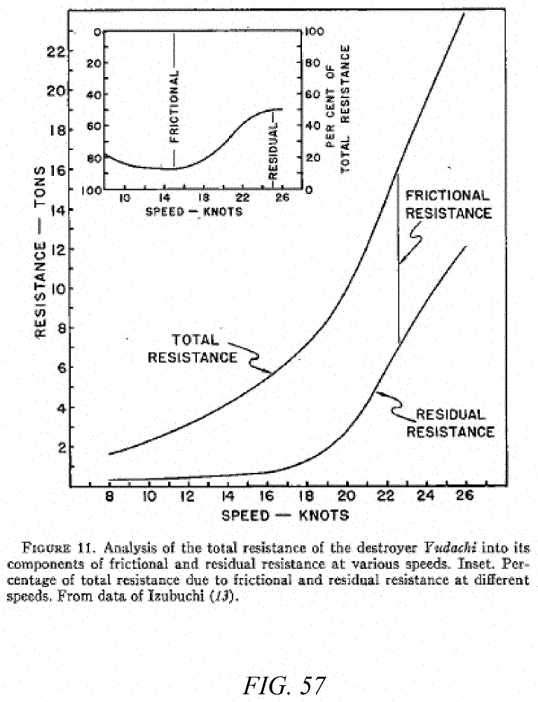

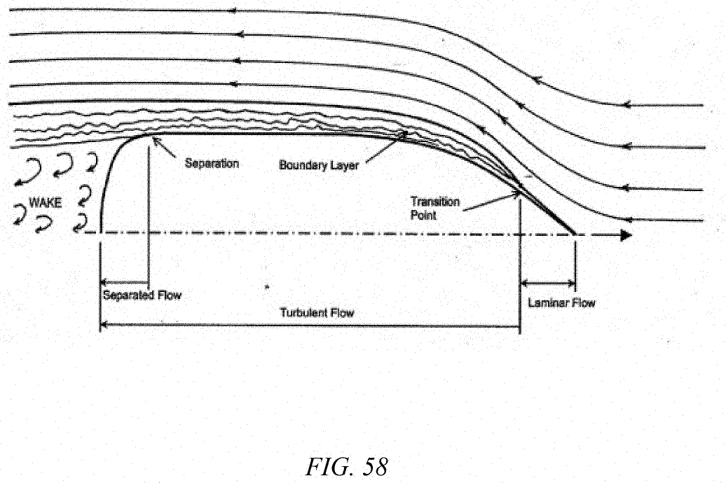

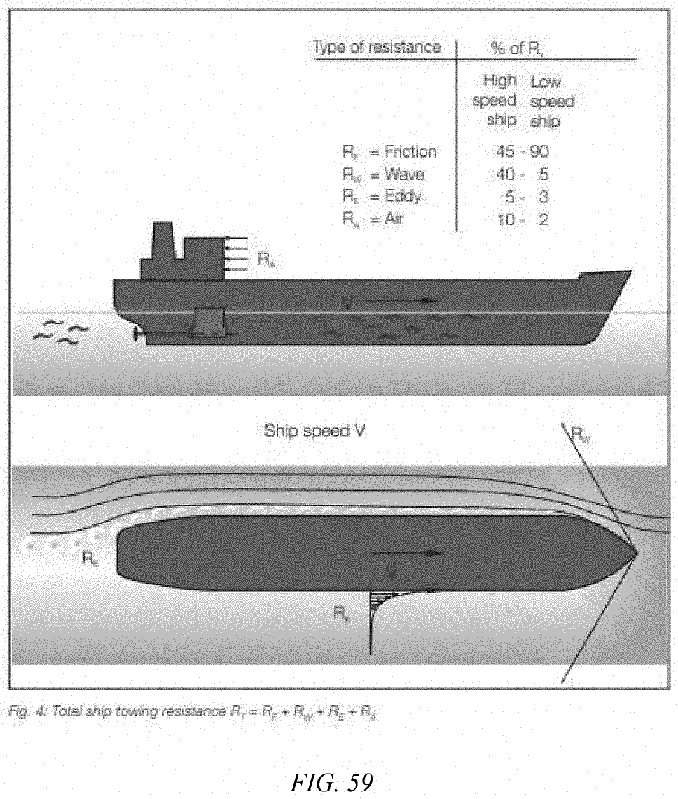

FIG. 57 shows an example measured value of drag on a ship hull as a function of speed. At 24 knots, a speed typical of cargo vessels, frictional drag is about 50% of the total drag and residual drag (primarily wave drag and some eddy drag) is about 50%. FIG. 58 shows the flow streams around a ship hull. The turbulent eddies behind the ship are responsible for about 3 to 5% of the total drag (see Table 4 and FIG. 59).

TABLE 4

| | High Speed (e.g., | Low Speed |
|---|---|---|
| | Container Ship) | (e.g., Oil Tanker) |
| Frictional resistance | 45% | 90% |
| Wave-making resistance | 40% | 5% |
| Eddy-making resistance | 5% | 3% |
| Air Resistance | 10% | 10% |

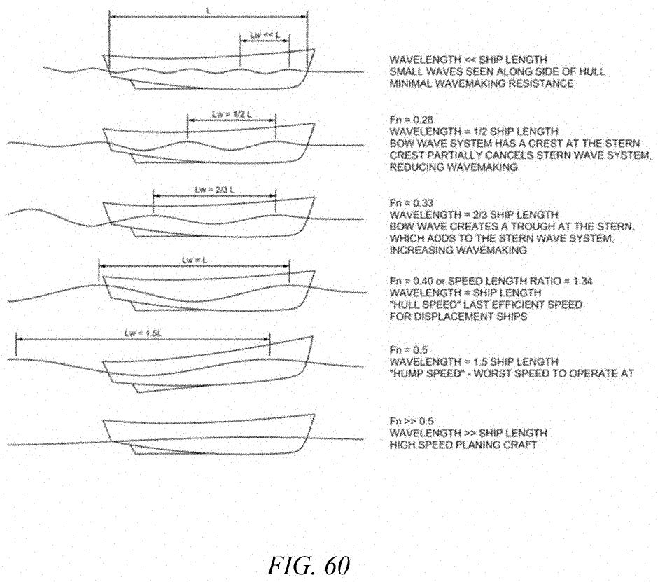

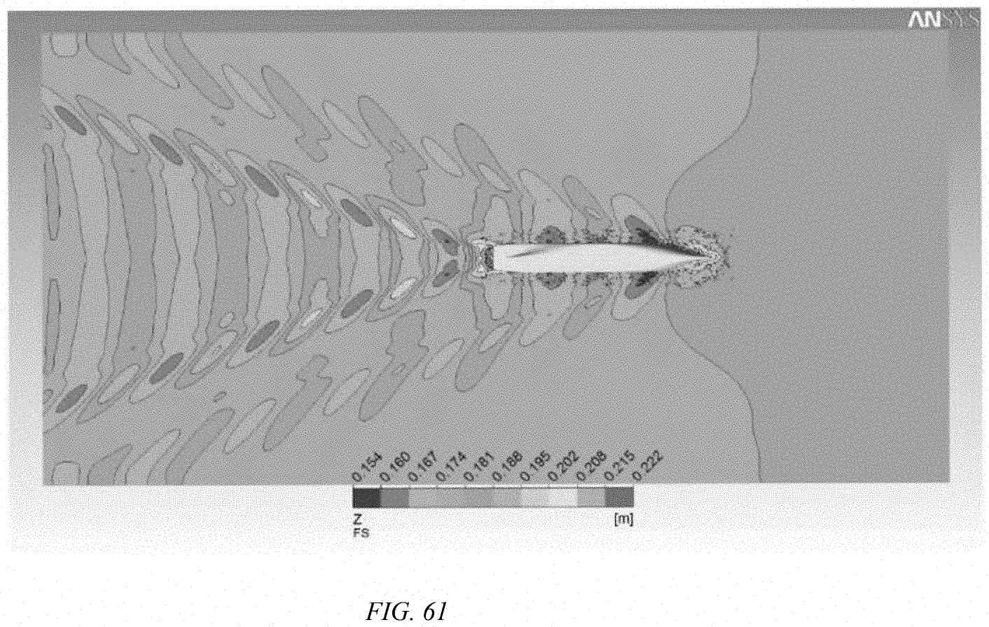

The dominant residual drag is caused by the generation of waves (FIGS. 60 and 61). The impact of waves is minor at low speeds and becomes dominant at high speeds. Depending upon the length of the ship and its speed, the waves have particular resonances that can impact drag significantly.

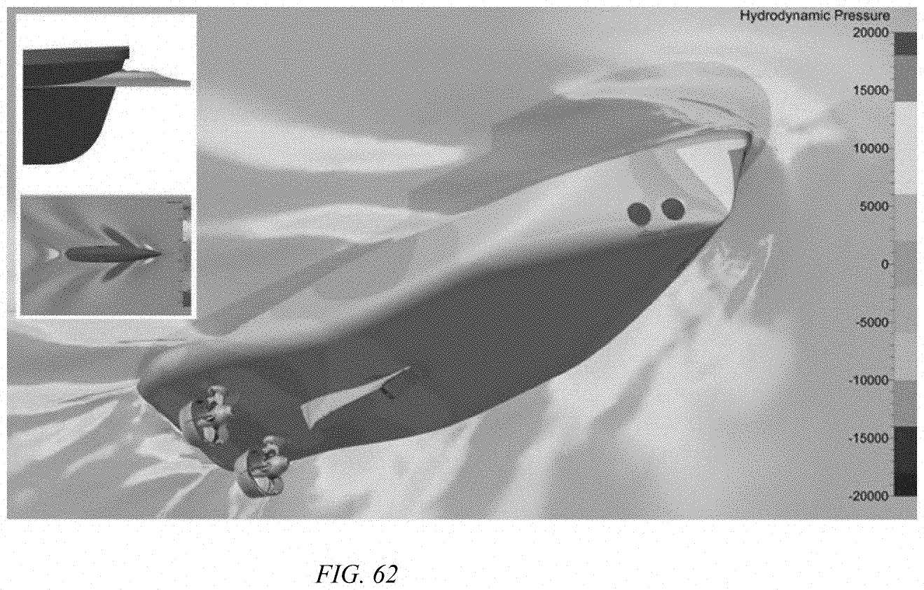

FIG. 62 shows an example hydrodynamic pressure acting on a boat hull. Note that the stern has lower pressures than the bow, which “sucks” the boat backward and contributes to drag.

Appendages (e.g., rudder, struts, brackets) contribute significantly to ship drag (see Tables 5 and 6).

TABLE 5
Total resistance of appendages as a percentage of hull naked resistance

| Vessel type | % of naked resistance |
|---|---|
| Single screw | 2-5 |
| Large fast twin screw | 8-14 |
| Small fast twin screw | Up to 25 |

TABLE 6

| | Speed/length ratio | | |
|---|---|---|---|
| Ship type | 0.70 | 1.0 | 1.6 |
| Large fast quadruple-screw ships | 10-16% | 10-16% | |
| Small fast twin-screw ships | 20-30% | 17-15% | 10-15% |
| Small medium V twin-screw ships | 12-30% | 10-23% | |
| Large medium V twin-screw ships | 8-14% | 8-14% | |
| All single-screw ships | 2-5% | 2-5% | |

### Conventional Propeller

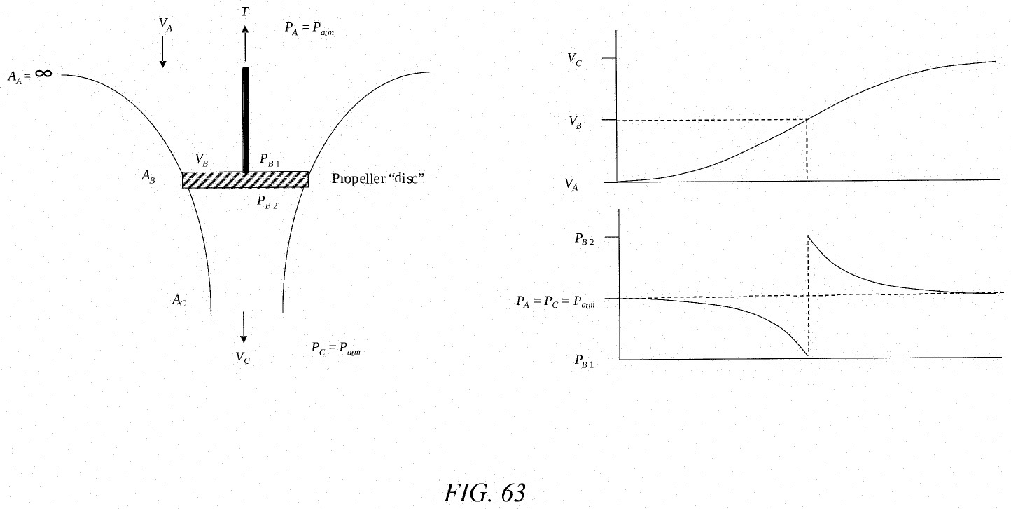

FIG. 63 illustrates a conventional propeller model according to one embodiment of the present disclosure. According the Actuator Disc Theory, the velocity V_{B} at the actuator disc is the arithmetic average of upstream velocity V_{A} and the downstream velocity V_{C}.

$${V}_{B} = \frac{{V}_{A} + {V}_{C}}{2}$$

$${V}_{C} = 2 {V}_{B} - {V}_{A}$$

Mass continuity allows the relationship between the areas to be calculated

$$ρ {A}_{B} {V}_{B} = ρ {A}_{C} {V}_{C}$$

$$\begin{matrix}{A}_{B} = \frac{{V}_{C}}{{V}_{B}} {A}_{C} \\ = \frac{{V}_{C}}{\frac{{V}_{A} + {V}_{C}}{2}} {A}_{C} \\ = 2 \frac{{V}_{C}}{{V}_{A} + {V}_{C}} {A}_{C}\end{matrix}$$

For incompressible fluids undergoing negligible changes in height, the energy content (J/m³) contains a pressure component (N/m² or J/m³) and a kinetic energy component (J/m³), as determined by the Bernoulli equation. The Bernoulli equation is applied to the fluid upstream of the actuator disc:

P_{B1}+1/2ρV_{B}²=P_{A}+1/2ρV_{A}²=Pₐₜₘ+1/2ρV_{A}²;

P_{B1}−P_{A}=P_{B1}−Pₐₜₘ=1/2ρV_{A}²−1/2ρV_{B}²

P_{B1}=Pₐₜₘ+1/2ρV_{A}²−−1/2ρV_{B}²

The Bernoulli equation can also be applied to the fluid downstream of the actuator disc:

P_{B2}+1/2ρV_{B}²=P_{C}+1/2 ρV_{C}²=Pₐₜₘ+1/2ρV_{C}²

P_{B2}−P_{C}=P_{B2}−Pₐₜₘ=1/2ρV_{C}²−1/2ρV_{B}²

P_{B2}=Pₐₜₘ+1/2ρV_{C}²−1/2ρV_{B}²

The pressure difference across the actuator disc follows:

P_{B2}−P_{B1}=(Pₐₜₘ+1/2ρV_{C}²−1/2ρV_{B}²)−(Pₐₜₘ+1/2ρV_{A}²−1/2ρV_{B}²)=1/2ρV_{C}²−1/2ρV_{A}²=1/2ρ(V_{C}²−V_{A}²)

Using the actuator disc as the system, the thrust is

$$\begin{matrix}T = {A}_{B} ( {P}_{B 2} - {P}_{B 1} ) = {A}_{B} ( \frac{1}{2} ρ ( {V}_{C}^{2} - {V}_{A}^{2} ) ) \\ = ( 2 \frac{{V}_{C}}{{V}_{A} + {V}_{C}} {A}_{C} ) ( \frac{1}{2} ρ ( {V}_{C}^{2} - {V}_{A}^{2} ) ) \\ = ρ {A}_{C} ( \frac{{V}_{C}}{{V}_{A} + {V}_{C}} ) ( {V}_{C}^{2} - {V}_{A}^{2} )\end{matrix}$$

The rate that kinetic energy is imparted to the flowing fluid follows:

Ėₖ=1/2\dot{m}(V_{C}²−V_{A}²)=1/2(ρA_{C}V_{C})(V_{C}²−V_{A}²)

It is desirable to have the maximum amount of thrust per unit of kinetic power, which is determined by the following metric:

$$\begin{matrix}\frac{T}{{\dot{E}}_{k}} = \frac{ρ {A}_{C} ( \frac{{V}_{C}}{{V}_{A} + {V}_{C}} ) ( {V}_{C}^{2} - {V}_{A}^{2} )}{\frac{1}{2} ( ρ {A}_{C} {V}_{C} ) ( {V}_{C}^{2} - {V}_{A}^{2} )} \\ = \frac{2 ( \frac{{V}_{C}}{{V}_{A} + {V}_{C}} )}{{V}_{C}} \\ = [ 2 \frac{( \frac{{V}_{A}}{{V}_{C}} )}{( \frac{{V}_{A}}{{V}_{C}} )} ( \frac{\frac{{V}_{C}}{{V}_{A}}}{1 + \frac{{V}_{C}}{{V}_{A}}} ) ] ( \frac{1}{{V}_{C}} ) \\ = [ 2 ( \frac{1}{( \frac{{V}_{A}}{{V}_{C}} ) + 1} ) ] ( \frac{1}{{V}_{C}} ) \\ = [ \frac{2}{1 + ( \frac{{V}_{A}}{{V}_{C}} )} ] ( \frac{1}{{V}_{C}} )\end{matrix}$$

The efficiency is

$$η = \frac{T {V}_{A}}{\dot{E}} = \frac{\{ [ \frac{2}{1 + ( \frac{{V}_{A}}{{V}_{C}} )} ] \frac{1}{{V}_{C}} \dot{E} \} {V}_{A}}{\dot{E}} = [ \frac{2}{1 + ( \frac{{V}_{A}}{{V}_{C}} )} ] \frac{{V}_{A}}{{V}_{C}} = \frac{2 \frac{{V}_{A}}{{V}_{C}}}{1 + ( \frac{{V}_{A}}{{V}_{C}} )}$$

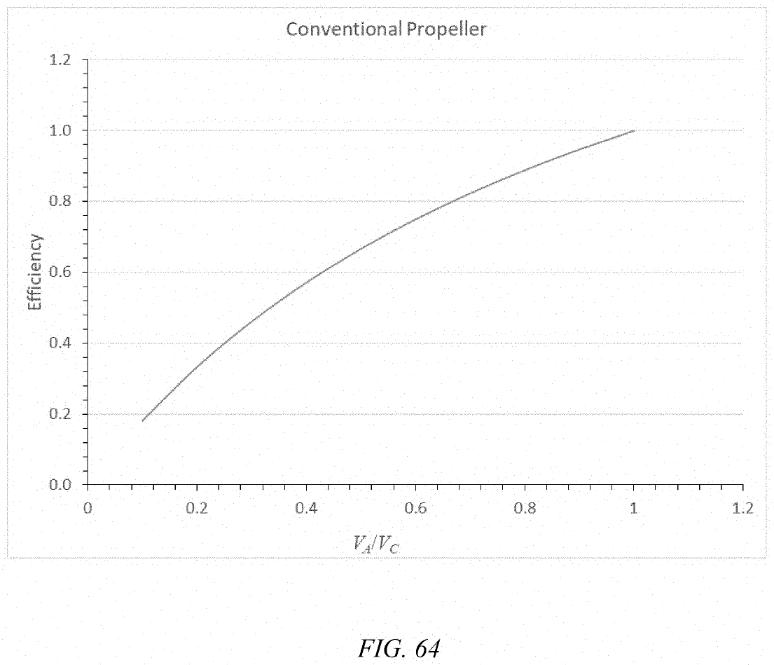

This propulsive efficiency approaches 1.0 as V_{A}/V_{C} approaches 1.0 (FIG. 64). With a conventional propeller, the only mechanism for achieving a propulsive efficiency of 1.0 is for V_{A} to equal V_{C}, which requires an infinitely large propeller.

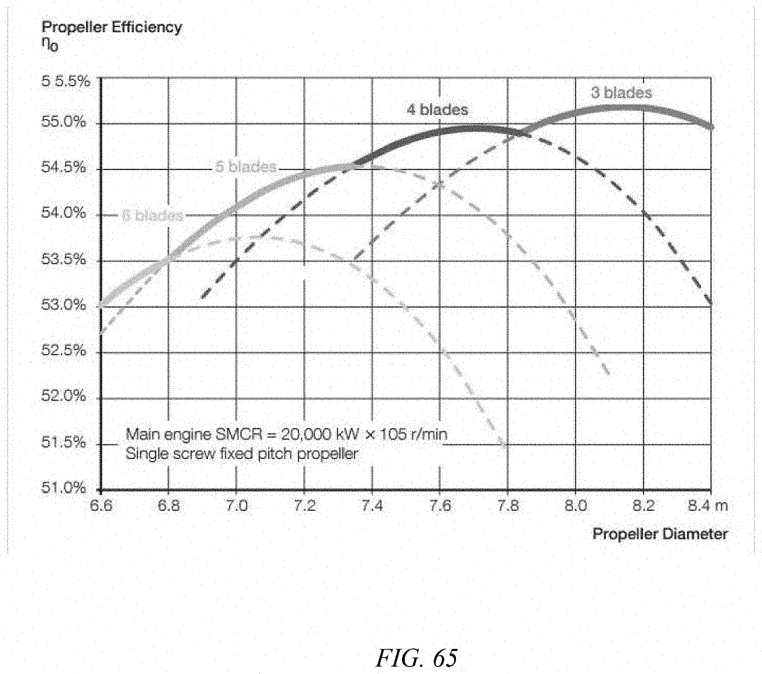

FIG. 65 shows that the efficiency of a conventional propeller increases with size. Even so, the efficiency is relatively low (about 53 to 55%, in this case).

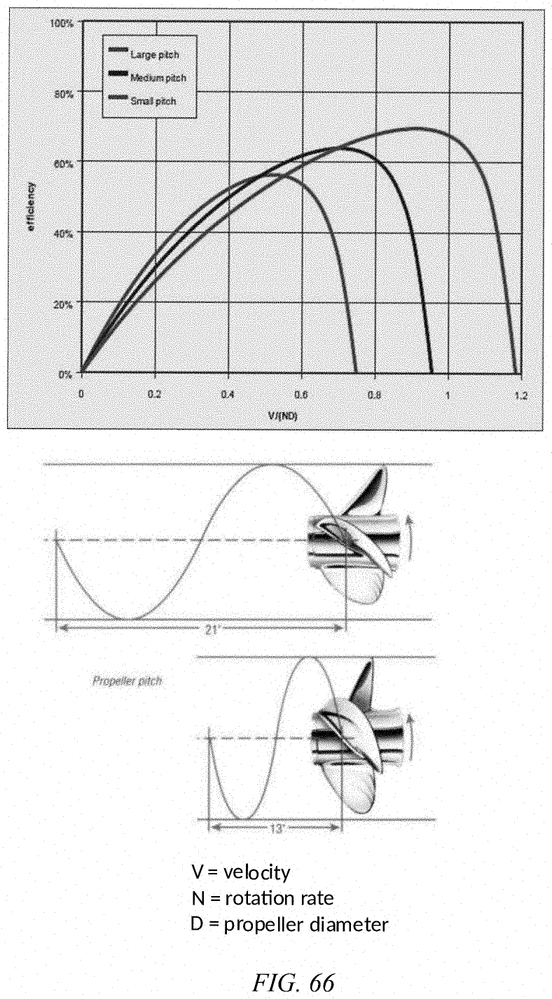

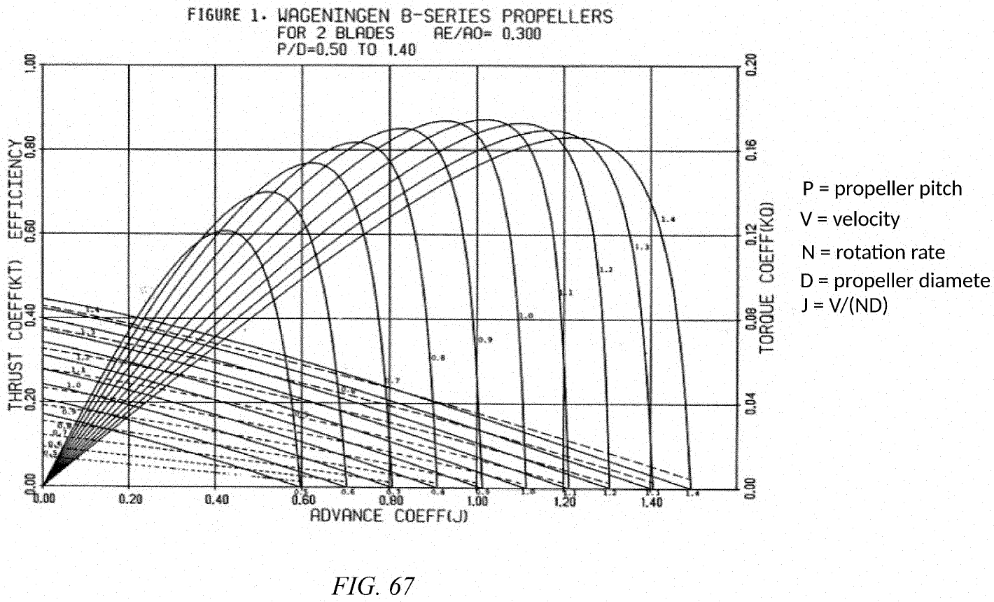

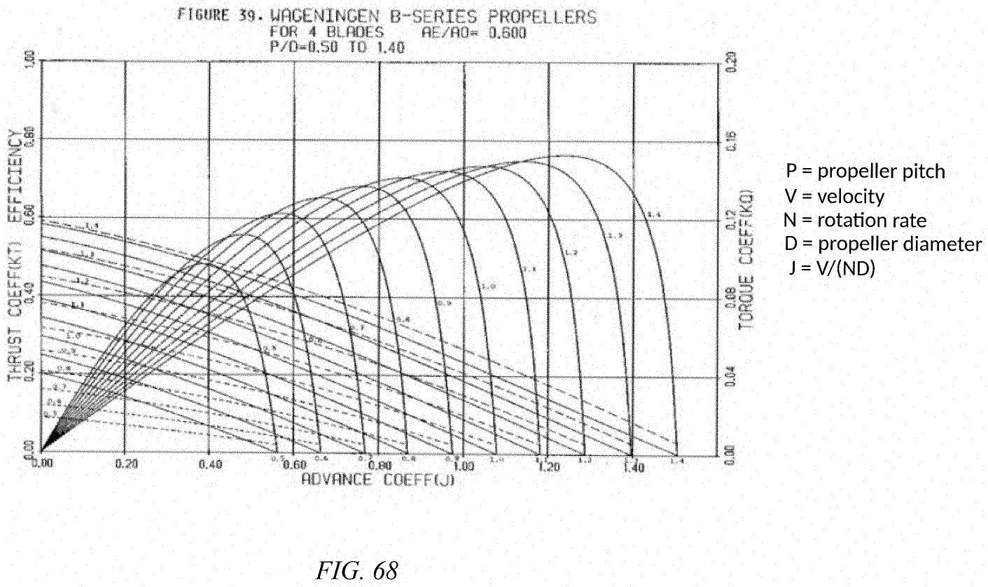

FIG. 66 shows propeller efficiency as a function of velocity and propeller pitch. Pitch is the distance a propeller would travel in a soft material (e.g., wood) using a single rotation. In all cases, for a given pitch, the efficiency is greatest over a narrow range of velocity. With a larger pitch, the efficiency improves. Furthermore, to travel at high velocities, the pitch may be increased.

With a single pitch, the propeller is often efficient only over a relatively narrow range of velocities. FIG. 67 shows the efficiency of a variable-pitch two-blade propeller that extends the range of efficient velocities. At its peak, the efficiency can be as high as 0.87; however, at low velocities, the efficiencies are low (about 0.60).

FIG. 68 shows the efficiency of a variable-pitch four-blade propeller ranges from 0.49 to 0.77.

### Maritime Propeller Example

The measured performance of a ship is described below:

| | |
|---|---|
| p = 1025 kg/m³ | Saltwater density |
| V_{A} = 22 knots = 11.32 m/s | Ship speed |
| D = 7.0 m | Propeller diameter |
| r = 0.975 | Blade area ratio |
| T = 2,748,402N | Thrust |
| Ė = 38,742 kW | Power |
| ηₐ = 0.5484 | Actual propeller efficiency |

$$T = \frac{1}{2} ρ {A}_{B} ( {V}_{C}^{2} - {V}_{A}^{2} ) = \frac{1}{2} ρ {A}_{B} {V}_{C}^{2} - \frac{1}{2} ρ {A}_{B} {V}_{A}^{2}$$

$$\frac{1}{2} ρ {A}_{B} {V}_{C}^{2} = T + \frac{1}{2} ρ {A}_{B} {V}_{A}^{2}$$

$${V}_{C}^{2} = \frac{T + \frac{1}{2} ρ {A}_{B} {V}_{A}^{2}}{\frac{1}{2} ρ {A}_{B}}$$

$$\begin{matrix}{V}_{C} = \sqrt{\frac{T + \frac{1}{2} ρ {A}_{B} {V}_{A}^{2}}{\frac{1}{2} ρ {A}_{B}}} = \sqrt{\frac{T + \frac{1}{2} ρ ( \frac{π}{4} {D}^{2} ) {V}_{A}^{2}}{\frac{1}{2} ρ ( \frac{π}{4} {D}^{2} )}} \\ = \sqrt{\frac{T + \frac{π}{8} ρ {D}^{2} {V}_{A}^{2}}{\frac{π}{8} ρ {D}^{2}}} \\ = \sqrt{\frac{( 2 , 748 , 402 N ) + \frac{π}{8} ( 1025 \frac{kg}{{m}^{3}} ) {( 7.0 m )}^{2} {( 11.32 \frac{m}{s} )}^{2}}{\frac{π}{8} ( 1025 \frac{kg}{{m}^{3}} ) {( 7.0 m )}^{2}}} \\ = 16.36 \frac{m}{s}\end{matrix}$$

$$η = \frac{2 \frac{{V}_{A}}{{V}_{C}}}{1 + ( \frac{{V}_{A}}{{V}_{C}} )} = \frac{2 \frac{11.32 m \text{/} s}{16.36 m \text{/} s}}{1 + ( \frac{11.32 m \text{/} s}{16.36 m \text{/} s} )} = 0.8 \; 18$$

The actual propeller efficiency is 67% of the calculated theoretical propulsive efficiency.

Impact of increasing propeller diameter 1.4×, which is equivalent to increasing area by 2×

$$\begin{matrix}{V}_{C} = \sqrt{\frac{( 2 , 748 , 402 N ) + \frac{π}{8} ( 1025 \frac{kg}{{m}^{3}} ) {( 1.4 \times 7.0 m )}^{2} {( 11.32 \frac{m}{s} )}^{2}}{\frac{π}{8} ( 1025 \frac{kg}{{m}^{3}} ) {( 1.4 \times 7.0 m )}^{2}}} \\ = 14.12 \frac{m}{s}\end{matrix}$$

$$η = \frac{2 \frac{{V}_{A}}{{V}_{C}}}{1 + ( \frac{{V}_{A}}{{V}_{C}} )} = \frac{2 \frac{11.32 m \text{/} s}{14.12 m \text{/} s}}{1 + ( \frac{11.32 m \text{/} s}{14.12 m \text{/} s} )} = 0.8 \; 90$$

Impact of increasing propeller diameter 2×, which is equivalent to increasing area by 4×

$$\begin{matrix}{V}_{C} = \sqrt{\frac{( 2 , 748 , 402 N ) + \frac{π}{8} ( 1025 \frac{kg}{{m}^{3}} ) {( 2 \times 7.0 m )}^{2} {( 11.32 \frac{m}{s} )}^{2}}{\frac{π}{8} ( 1025 \frac{kg}{{m}^{3}} ) {( 2 \times 7.0 m )}^{2}}} \\ = 12.77 \frac{m}{s}\end{matrix}$$

$$η = \frac{2 \frac{{V}_{A}}{{V}_{C}}}{1 + ( \frac{{V}_{A}}{{V}_{C}} )} = \frac{2 \frac{11.32 m \text{/} s}{12.77 m \text{/} s}}{1 + ( \frac{11.32 m \text{/} s}{12.77 m \text{/} s} )} = 0.940$$

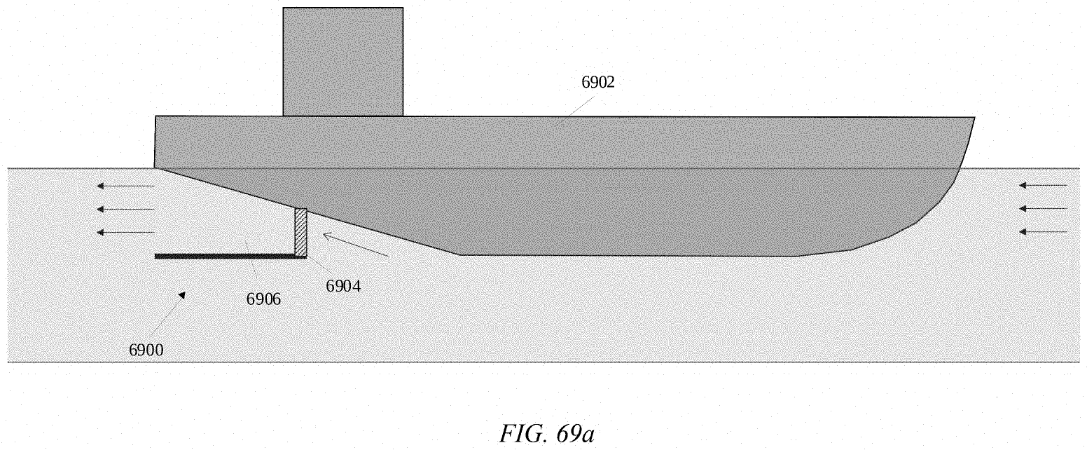

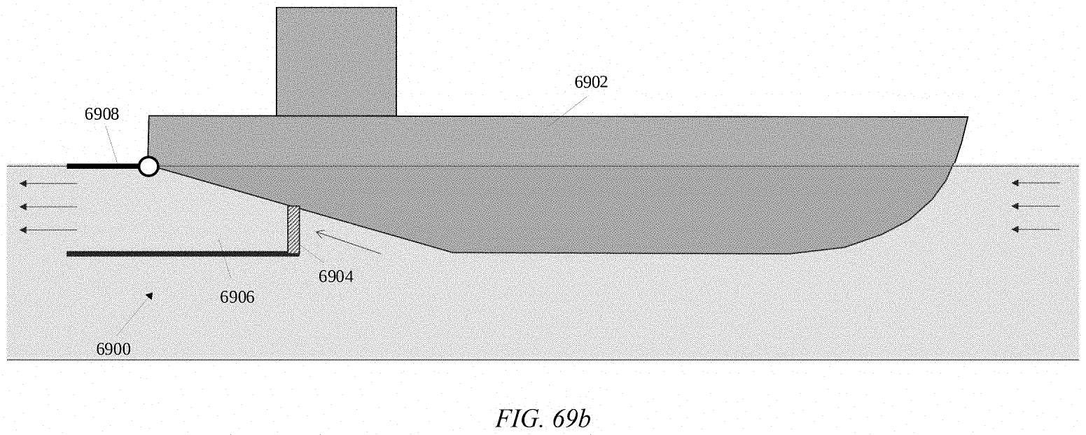

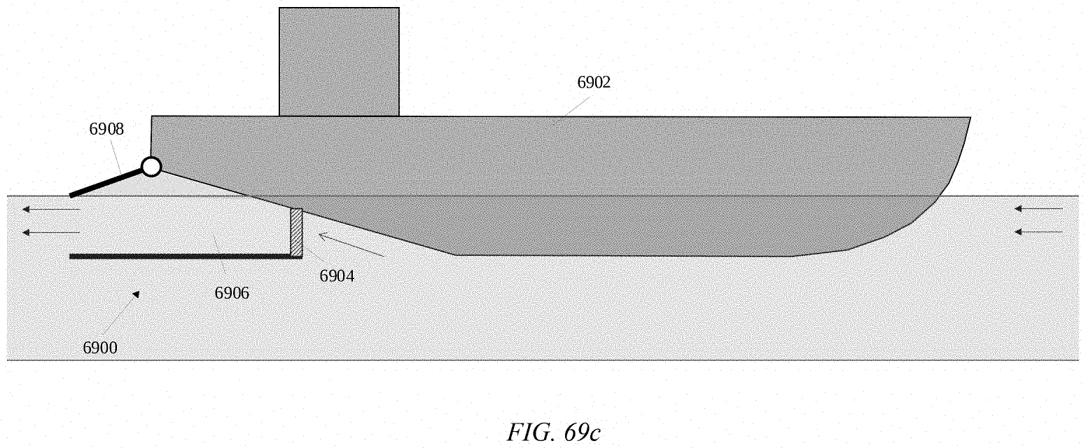

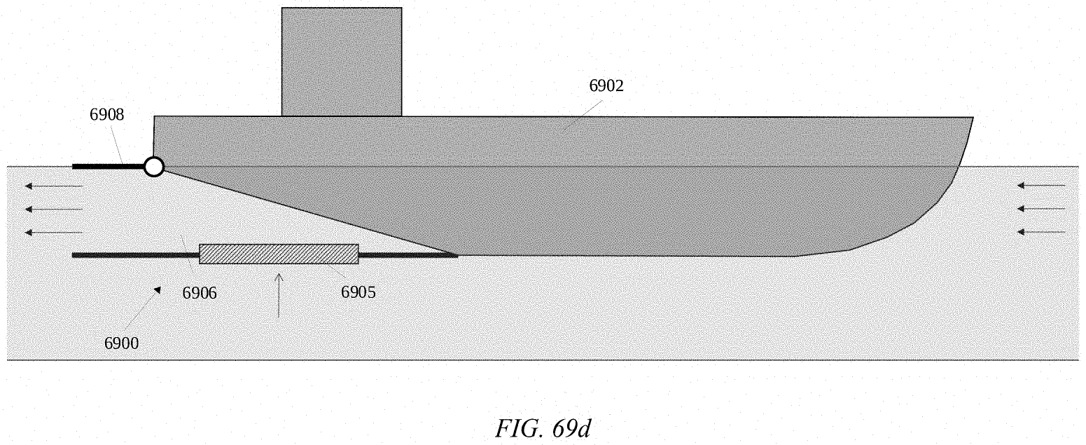

FIG. 69a illustrates an example maritime propulsion system 6900 that is mounted on a ship 6902 according to one embodiment of the present disclosure. The maritime propulsion system 6900 includes a duct 6906 that provides a technique for increasing a propulsive area created by a driving force, such as a propeller 6904. The duct 6906 may be configured on the ship 6902 in any suitable manner. A bank of axial or screw propellers 6904 located on the front of the duct 6906 draws water from the underside of the ship and ejects it from the rear, thus providing thrust. The cross sectional size of the submerged duct 6906 can be approximately similar to, less than, or greater than the cross sectional size of the submerged portion of the hull. FIGS. 69b and 69c show an embodiment that has a pivoting extended flap 6908. Depending on the weight of cargo in a ship, the draft of the ship can vary dramatically. The angle of the pivoting extended flap can vary to ensure the fluid discharge is always below the water line. FIG. 69d shows an embodiment in which the propulsor 6905 draws fluid from the underside of the duct.

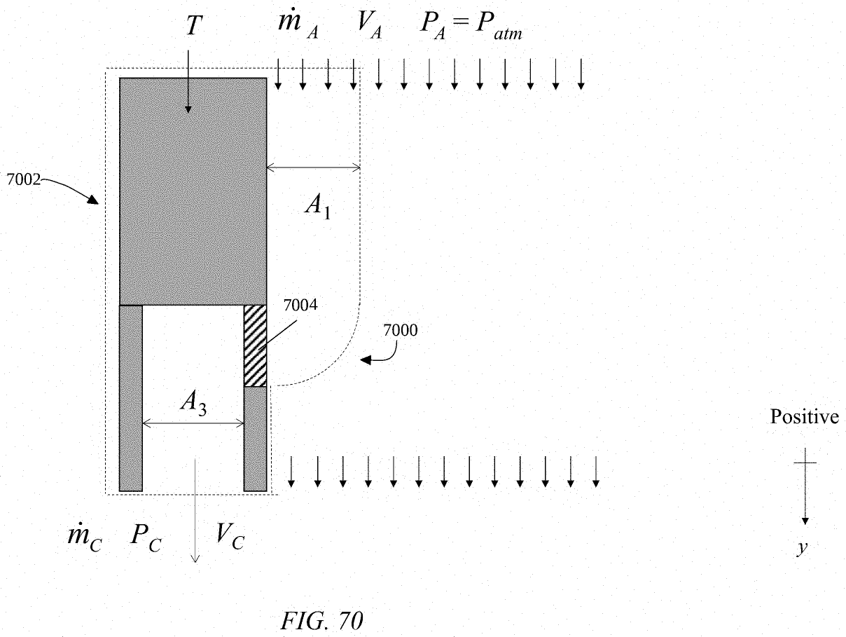

FIG. 70 illustrates another example maritime propulsion system 7000 according to one embodiment of the present disclosure. The maritime propulsion system 7000 includes a structure 7002 configured with a hole for placement of a disc actuator (propeller) 7004 inside. The structure 7002 may be envisioned as a stationary dock, or the symmetrical portion of a ship or aircraft. The disc actuator 7004 draws fluid (water) from the adjacent free stream beside the structure 7002. Although this analysis is performed in the context of a maritime propulsion system, it may be applied to aircraft propulsion as well.

Define f

$$f ≡ \frac{{\dot{m}}_{C}}{{\dot{m}}_{A}}$$

Account for mass

\dot{m}_{A}=\dot{m}_{C}

Account for y momentum

Accum=0=In−Out=\dot{m}_{A}V_{A}+A₁P_{A}−(\dot{m}_{C}V_{C}+A₃P_{C}+T)

P_{A}=P_{C}=Pₐₜₘ=0

T=\dot{m}_{A}V_{A}−\dot{m}_{C}V_{C}

Substituting

T=\dot{m}_{A}V_{A}−m_{A}V_{C}=\dot{m}_{A}(V_{A}−V_{C})=ρA₁V_{A}(V_{A}−V_{C})

The power is

$$\dot{E} = \frac{1}{2} {\dot{m}}_{C} {V}_{C}^{2} + \frac{{\dot{m}}_{C}}{ρ} {P}_{C} - \frac{1}{2} {\dot{m}}_{A} {V}_{A}^{2} - \frac{{\dot{m}}_{A}}{ρ} {P}_{A}$$

$${P}_{A} = {P}_{C} = {P}_{atm} = 0 = \frac{1}{2} {\dot{m}}_{C} {V}_{C}^{2} - \frac{1}{2} {\dot{m}}_{A} {V}_{A}^{2} = \frac{1}{2} {\dot{m}}_{A} {V}_{C}^{2} - \frac{1}{2} {\dot{m}}_{A} {V}_{A}^{2} = \frac{1}{2} {\dot{m}}_{A} ( {V}_{C}^{2} - {V}_{A}^{2} ) = \frac{1}{2} ρ {A}_{1} {V}_{A} ( {V}_{C}^{2} - {V}_{A}^{2} )$$

The thrust-to-power ratio is

$$\frac{T}{\dot{E}} = \frac{ρ {A}_{1} {V}_{A} ( {V}_{A} - {V}_{C} )}{\frac{1}{2} ρ {A}_{1} {V}_{A} ( {V}_{C}^{2} - {V}_{A}^{2} )} = \frac{2 ( {V}_{A} - {V}_{C} )}{( {V}_{C}^{2} - {V}_{A}^{2} )} = \frac{2 \frac{1}{{V}_{C}^{2}} ( {V}_{A} - {V}_{C} )}{\frac{1}{{V}_{C}^{2}} ( {V}_{C}^{2} - {V}_{A}^{2} )} = [ \frac{2 ( \frac{{V}_{A}}{{V}_{C}} - 1 )}{( 1 - \frac{{V}_{A}^{2}}{{V}_{C}^{2}} )} ] \frac{1}{{V}_{C}} = [ \frac{2 ( \frac{{V}_{A}}{{V}_{C}} - 1 )}{( 1 - {( \frac{{V}_{A}}{{V}_{C}} )}^{2} )} ] \frac{1}{{V}_{C}}$$

Flip sign so thrust is in forward direction

$$\frac{T}{\dot{E}} = [ \frac{2 ( 1 - \frac{{V}_{A}}{{V}_{c}} )}{( 1 - {( \frac{{V}_{A}}{{V}_{c}} )}^{2} )} ] \frac{1}{{V}_{C}} = [ \frac{2 ( 1 - \frac{{V}_{A}}{{V}_{C}} )}{( 1 + ( \frac{{V}_{A}}{{V}_{C}} ) ) ( 1 - ( \frac{{V}_{A}}{{V}_{C}} ) )} ] \frac{1}{{V}_{C}} = [ \frac{2}{1 + ( \frac{{V}_{A}}{{V}_{C}} )} ] \frac{1}{{V}_{C}}$$

This is the same as a conventional propeller; hence, the propulsive efficiency will be the same also.

$$η = \frac{T {V}_{A}}{\dot{E}} = \frac{\{ [ \frac{2}{1 + ( \frac{{V}_{A}}{{V}_{C}} )} ] \frac{1}{{V}_{C}} \dot{E} \} {V}_{A}}{\dot{E}} = [ \frac{2}{1 + ( \frac{{V}_{A}}{{V}_{C}} )} ] \frac{{V}_{A}}{{V}_{C}} = \frac{2 \frac{{V}_{A}}{{V}_{C}}}{1 + ( \frac{{V}_{A}}{{V}_{C}} )}$$

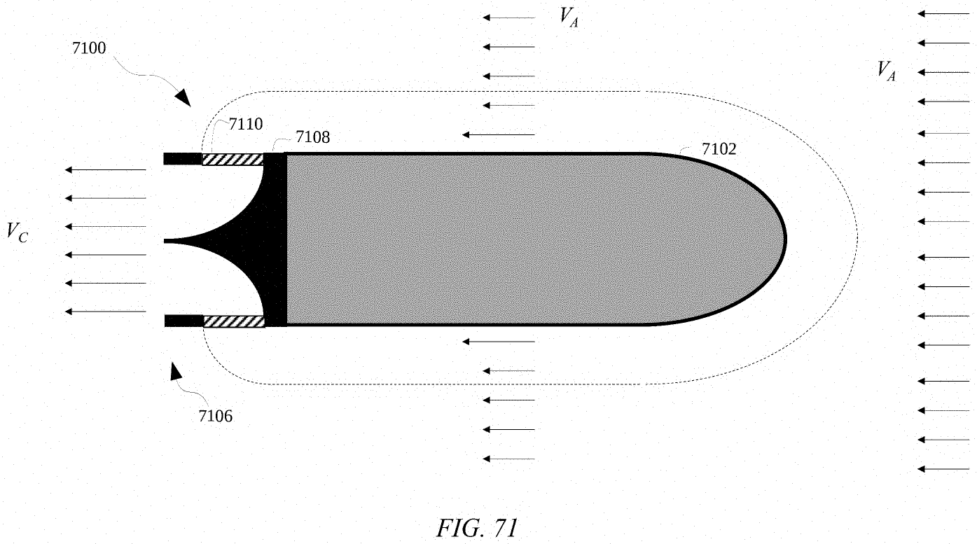

FIG. 71 illustrates a schematic representation of a maritime propulsion system 7100 according to one embodiment of the present disclosure. The propulsion system 7100 described in FIG. 70 is configured at the stern of a ship 7102. A duct 7108 is placed at the stern 7106 of the ship 7102 that has essentially the same cross section as the submerged section of the hull. Fluid is drawn from the sides and possibly bottom by one or more disc actuators (propellers) 7110, which fills the duct and pushes fluid towards the rear. The duct 7108 can have inlet turning vanes (not shown) that help change the fluid direction efficiently.

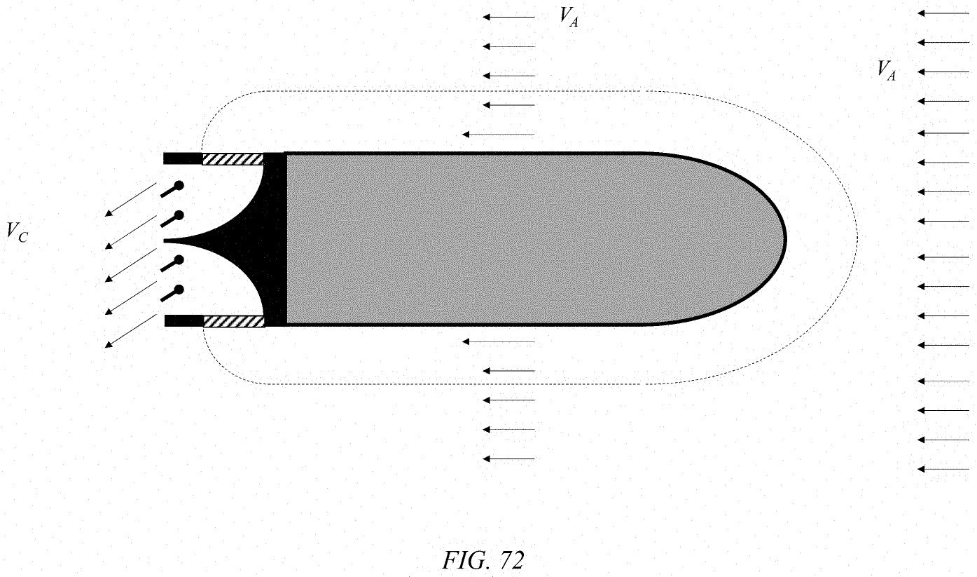

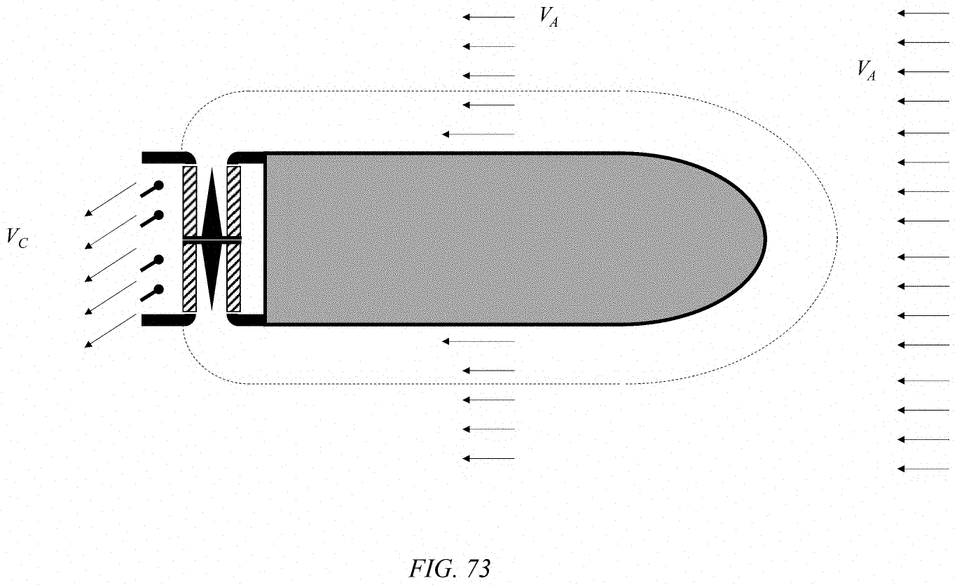

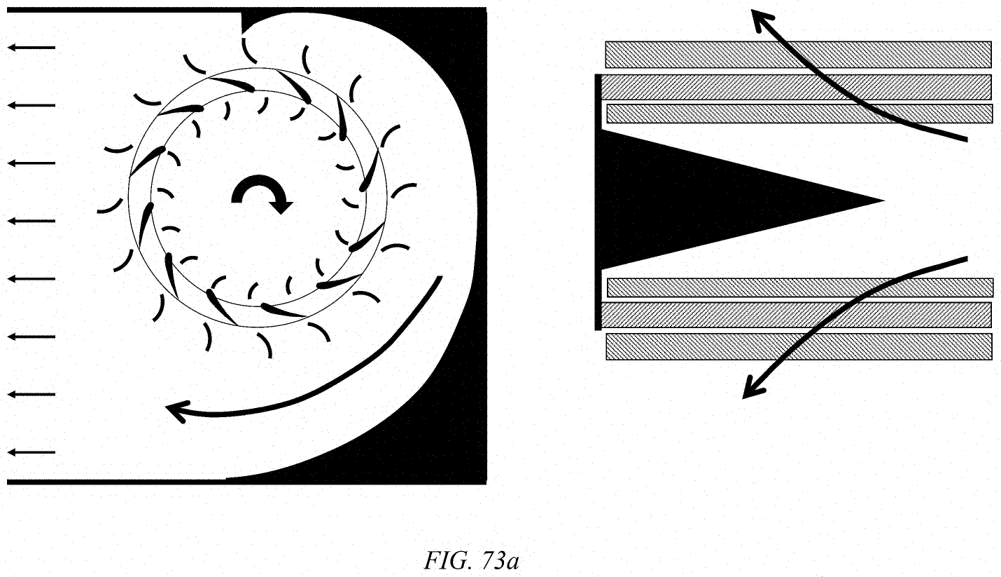

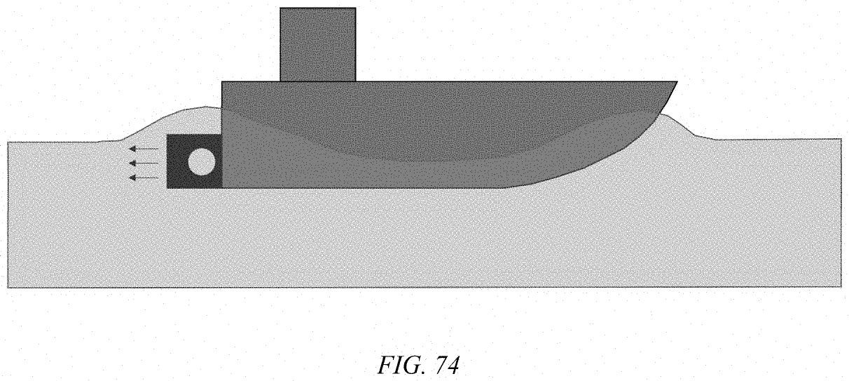

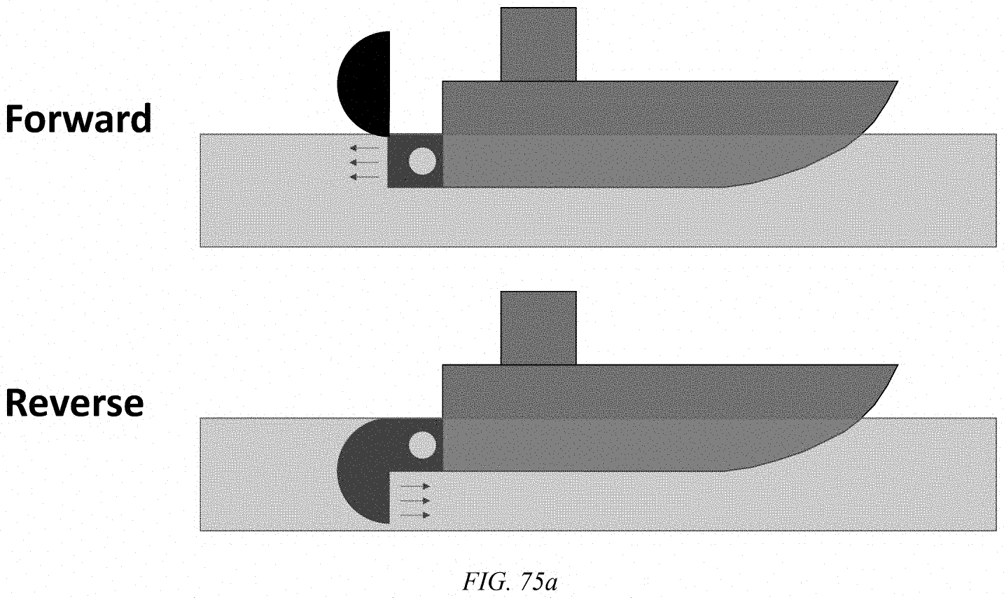

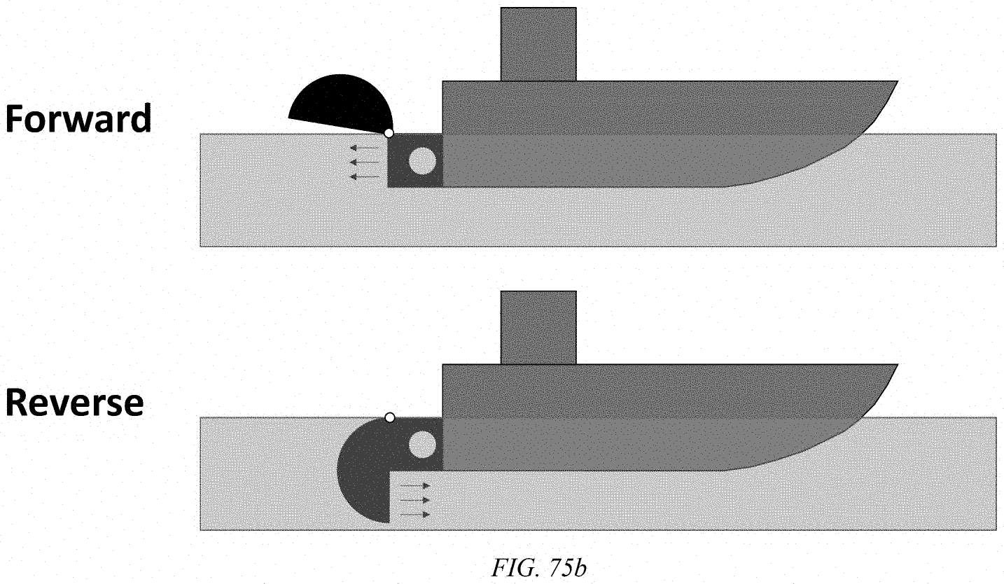

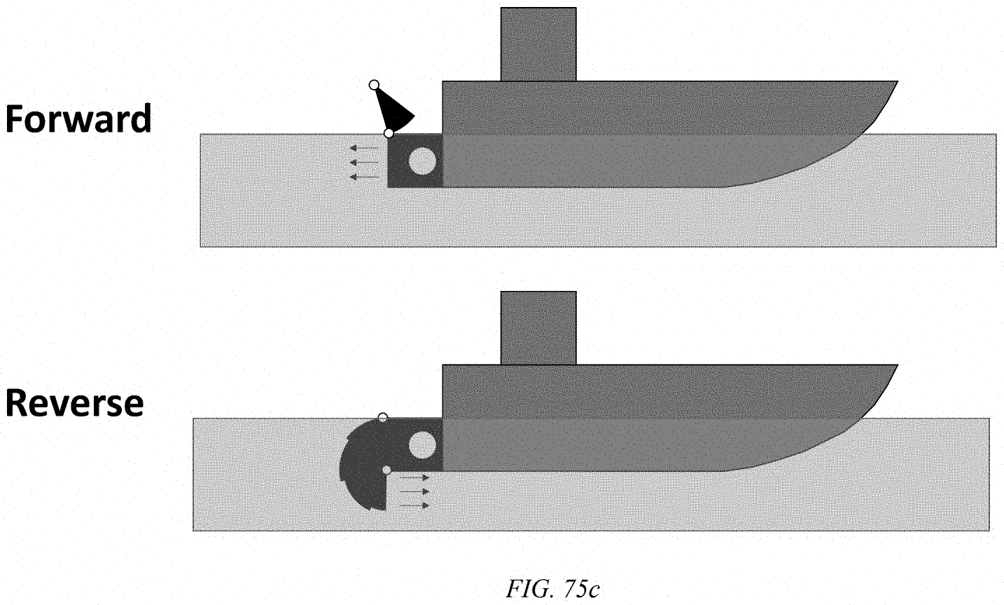

The advantages of this technology include, but are not necessarily limited to the following
The size of the propeller device is decoupled from the size of the propulsion cross section, thus providing added design flexibility. For example, multiple small-diameter propellers could line the wall of the duct and thereby replace one large propeller.
As shown in FIG. 72, multiple small rudders can be incorporated into the duct, which allows for vectored thrust and enhanced maneuverability.
The type of propeller may include not only traditional axial propellers, but also centrifugal and squirrel cage propellers among others (see FIG. 73). The entrance is rounded to provide a smooth flow path. As detailed in FIG. 73a, the center of the squirrel cage can contain a central cone that ensures the velocity is approximately constant along the axis. The squirrel cage propeller can incorporate stationary stators that convert rotational kinetic energy into translational kinetic energy, thus improving efficiency. Furthermore, the stators can be actuated giving the ability to change the angle relative to the rotating hydrofoils of the squirrel cage propeller, thus allowing high efficiency at a variety of rotational speeds. Inlet guide vanes regulate the angle of attack of the fluid relative to the rotating hydrofoils of the squirrel cage propeller. Similarly, the inlet guide vanes can be rotated to change the angle of attack, thus allowing high efficiency at a variety of rotational speeds. Both the stators and guide vanes can be segmented along the axial length of the squirrel cage. To achieve optimal control, each segment can be individually rotated for optimal angles both along the axis and the circumference. Using artificial intelligence, the optimal position of each segment can be adjusted to reduce energy consumption for each condition (e.g., speed, water density, water viscosity).
Traditional propellers have a cross-sectional area only a fraction typically 10 to 50% of the submerged cross-sectional area of the hull. In contrast, the duct fills the entire cross section, which has the following benefits:
   The wake eddies behind the boat are eliminated, which reduces drag by about 3 to 5%.
   Fewer appendages are required on the hull, which reduces drag (Tables 2 and 3).
   To achieve a given thrust, the required velocity V_{C} is much less; therefore, V_{C}/V_{A} is close to 1.0, which improves efficiency.
Because the ship must part the fluid for the hull to move forward, the velocity of the fluid near the ship hull is greater than the free-stream velocity; thus, the propeller does not need to impart as much additional kinetic energy to achieve a desired V_{C}, which improves efficiency.
At particular speeds, the peak of the wave at the stern will be above the inlet to the duct (FIG. 74). This additional hydrostatic head helps push water into the opening and productively utilizes energy already invested in making the wave. By drawing fluid away from the wave peak, the wave is dampened, which reduces the amount of energy in waves and reduces drag from waves.
Steering can be accomplished by directing more flow to one side of the duct, which eliminates or reduces the need for a rudder and with it associated cost, drag, mass, and maintenance.
Reverse thrust can be achieved using a reversing duct. FIG. 75a shows a reversing duct that slides vertically downward to reverse flow. FIG. 75b shows a reversing duct that pivots to reverse flow. FIG. 75c shows a reversing duct with two pivot points. One rotates the entire duct into position and the other rotates nested duct segments into a fully deployed position.

To estimate the potential improvement of the maritime propulsion system 7100 compared to conventional propellers, the numbers from the previous example can be used:

$$\begin{matrix}Factor Improve = Increase cross section area \times \\ \text{Improve impeller efficiency×Reduce drag} \\ = \frac{0.940}{0.818} \times \frac{0.85}{0.67} \times 1.05 \\ = 1.15 \times 1.27 \times 1.05 \\ = 1.53\end{matrix}$$

### Option 2

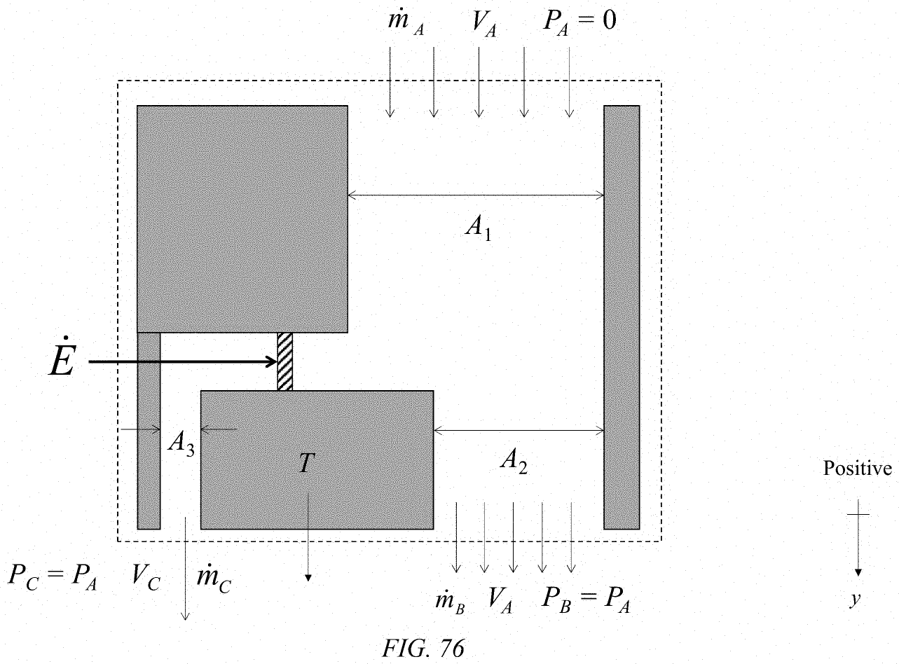

FIG. 76 illustrates another example ducted propulsion system according to one embodiment of the present disclosure. Although this analysis is performed in the context of a maritime propulsion system, it may be applied to aircraft propulsion as well.

Define f

$$f ≡ \frac{{\dot{m}}_{C}}{{\dot{m}}_{A}}$$

Account for mass

\dot{m}_{A}=\dot{m}_{B}+\dot{m}_{C}

\dot{m}_{A}=\dot{m}_{B}+f\dot{m}_{A}

\dot{m}_{B}=\dot{m}_{A}−f\dot{m}_{A}=(1−f)\dot{m}_{A}

Account for y momentum

Accum=0=In−Out=\dot{m}_{A}V_{A}+A₁P_{A}−(\dot{m}_{B}V_{B}+A₂P_{B}+\dot{m}_{C}V_{C}+A₃P_{C}+T)

P_{A}=P_{B}=P_{C}=0

T=\dot{m}_{A}V_{A}−\dot{m}_{B}V_{A}−\dot{m}_{C}V_{C}

Substituting

$$\begin{matrix}T = {\dot{m}}_{A} {V}_{A} - ( 1 - f ) {\dot{m}}_{A} {V}_{A} - f {\dot{m}}_{A} {V}_{C} = {\dot{m}}_{A} {V}_{A} ( 1 - ( 1 - f ) - f \frac{{V}_{C}}{{V}_{A}} ) \\ = {\dot{m}}_{A} {V}_{A} ( f - f \frac{{V}_{C}}{{V}_{A}} ) \\ = {\dot{m}}_{A} {V}_{A} f ( 1 - \frac{{V}_{C}}{{V}_{A}} ) \\ = {\dot{m}}_{A} f ( {V}_{A} - {V}_{C} )\end{matrix}$$

The power is

$$\dot{E} = \frac{1}{2} {\dot{m}}_{C} {V}_{C}^{2} + \frac{{\dot{m}}_{C}}{ρ} {P}_{C} + \frac{1}{2} {\dot{m}}_{B} {V}_{B}^{2} + \frac{{\dot{m}}_{B}}{ρ} {P}_{B} - \frac{1}{2} {\dot{m}}_{A} {V}_{A}^{2} - \frac{{\dot{m}}_{A}}{ρ} {P}_{A}$$

$${P}_{A} = {P}_{B} = {P}_{C} = 0$$

$${V}_{B} = {V}_{A} = \frac{1}{2} {\dot{m}}_{C} {V}_{C}^{2} + \frac{1}{2} {\dot{m}}_{B} {V}_{A}^{2} - \frac{1}{2} {\dot{m}}_{A} {V}_{A}^{2} = \frac{1}{2} f {\dot{m}}_{A} {V}_{C}^{2} + \frac{1}{2} ( 1 - f ) {\dot{m}}_{A} {V}_{A}^{2} - \frac{1}{2} {\dot{m}}_{A} {V}_{A}^{2} = \frac{1}{2} {\dot{m}}_{A} [ {fV}_{C}^{2} + ( 1 - f ) {V}_{A}^{2} - {V}_{A}^{2} ] = \frac{1}{2} {\dot{m}}_{A} [ {fV}_{C}^{2} + {V}_{A}^{2} - {fV}_{A}^{2} - {V}_{A}^{2} ] = \frac{1}{2} {\dot{m}}_{A} [ {fV}_{C}^{2} - {fV}_{A}^{2} ] = \frac{1}{2} {\dot{m}}_{A} f [ {V}_{C}^{2} - {V}_{A}^{2} ]$$

The thrust-to-power ratio is

$$\frac{T}{\dot{E}} = \frac{{\dot{m}}_{A} f ( {V}_{A} - {V}_{C} )}{\frac{1}{2} {\dot{m}}_{A} f ( {V}_{C}^{2} - {V}_{A}^{2} )} = \frac{2 ( {V}_{A} - {V}_{C} )}{( {V}_{C}^{2} - {V}_{A}^{2} )} = \frac{2 \frac{1}{{V}_{C}^{2}} ( {V}_{A} - {V}_{C} )}{\frac{1}{{V}_{C}^{2}} ( {V}_{C}^{2} - {V}_{A}^{2} )} = [ \frac{2 ( \frac{{V}_{A}}{{V}_{C}} - 1 )}{( 1 - \frac{{V}_{A}^{2}}{{V}_{C}^{2}} )} ] \frac{1}{{V}_{C}} = [ \frac{2 ( \frac{{V}_{A}}{{V}_{C}} - 1 )}{( 1 - {( \frac{{V}_{A}}{{V}_{C}} )}^{2} )} ] \frac{1}{{V}_{C}}$$

Flip sign so thrust is in forward direction

$$\frac{T}{\dot{E}} = [ \frac{2 ( 1 - \frac{{V}_{A}}{{V}_{C}} )}{( 1 - {( \frac{{V}_{A}}{{V}_{C}} )}^{2} )} ] \frac{1}{{V}_{C}} = [ \frac{2 ( 1 - \frac{{V}_{A}}{{V}_{C}} )}{( 1 + ( \frac{{V}_{A}}{{V}_{C}} ) ) ( 1 - ( \frac{{V}_{A}}{{V}_{C}} ) )} ] \frac{1}{{V}_{C}} = [ \frac{2}{1 + ( \frac{{V}_{A}}{{V}_{C}} )} ] \frac{1}{{V}_{C}}$$

This is the same as a conventional propeller.

The efficiency is

$$η = \frac{T {V}_{A}}{\dot{E}} = \frac{\{ [ \frac{2}{1 + ( \frac{{V}_{A}}{{V}_{c}} )} ] \frac{1}{{V}_{C}} \dot{E} \} {V}_{A}}{\dot{E}} = [ \frac{2}{1 + ( \frac{{V}_{A}}{{V}_{C}} )} ] \frac{{V}_{A}}{{V}_{C}} = \frac{2 \frac{{V}_{A}}{{V}_{C}}}{1 + ( \frac{{V}_{A}}{{V}_{C}} )}$$

The propulsive efficiency approaches 1.0 as V_{A}/V_{C} approaches 1.0.

### Option 3

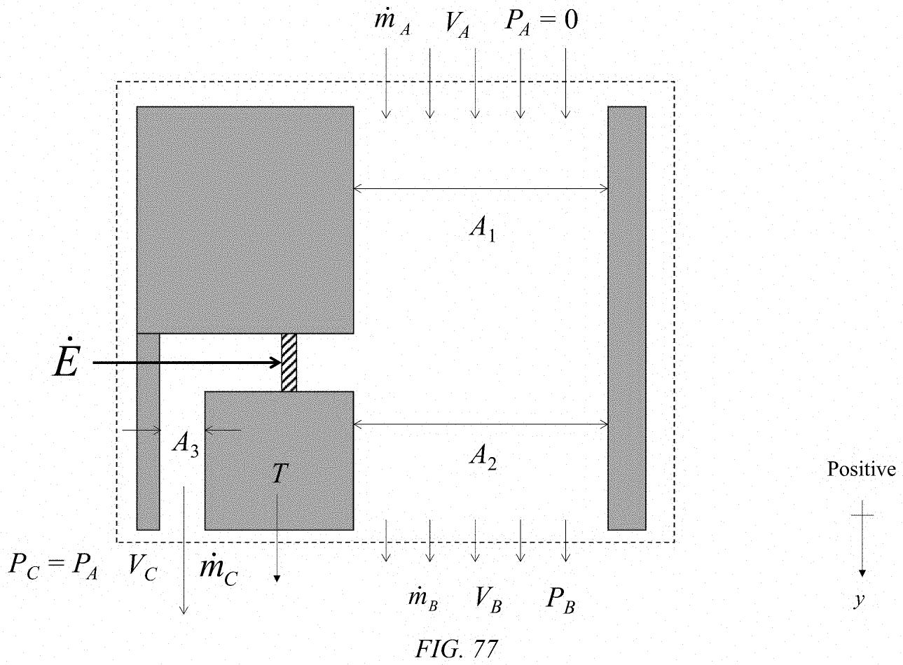

FIG. 77 illustrates another example ducted propulsion system 7900 according to one embodiment of the present disclosure. Although this analysis is performed in the context of a maritime propulsion system, it may be applied to aircraft propulsion as well.

Define f

$$f ≡ \frac{{\dot{m}}_{C}}{{\dot{m}}_{A}}$$

Account for mass

\dot{m}_{A}=\dot{m}_{B}+\dot{m}_{C}

\dot{m}_{A}=\dot{m}_{B}+f\dot{m}_{A}

\dot{m}_{B}=\dot{m}_{A}−f\dot{m}_{A}=(1−f)\dot{m}_{A}

Using Bernoulli equation, account for energy in the stream flowing from the channel inlet to the channel outlet

P_{A}+1/2ρV_{A}²=P_{B}+1/2ρV_{B}²

P_{A}=0

P_{B}=1/2ρ(V_{A}²−V_{B}²)

Account for y momentum

$$Accum = 0 = In - Out = ( {\dot{m}}_{A} {V}_{A} + {A}_{1} {P}_{A} ) - ( {\dot{m}}_{B} {V}_{B} + {A}_{2} {P}_{B} + {\dot{m}}_{C} {V}_{C} + {A}_{3} {P}_{C} + T )$$

$${P}_{A} = {P}_{C} = 0$$

$$\begin{matrix}T = {\dot{m}}_{A} {V}_{A} - ( {\dot{m}}_{B} {V}_{B} + {A}_{2} {P}_{B} + {\dot{m}}_{C} {V}_{C} ) \\ = {\dot{m}}_{A} {V}_{A} - ( {\dot{m}}_{B} {V}_{B} + {\dot{m}}_{C} {V}_{C} + {A}_{2} {P}_{B} )\end{matrix}$$

The area in and out of the channel is the same

A=A₁=A₂

Therefore

T=\dot{m}_{A}V_{A}−(\dot{m}_{B}V_{B}+\dot{m}_{C}V_{C}+AP_{B})

Substituting

$$\begin{matrix}T = {\dot{m}}_{A} {V}_{A} - ( ( 1 - f ) {\dot{m}}_{A} {V}_{B} + f {\dot{m}}_{A} {V}_{C} + A \frac{1}{2} ρ ( {V}_{A}^{2} - {V}_{B}^{2} ) ) \\ = {\dot{m}}_{A} {V}_{A} - ( 1 - f ) {\dot{m}}_{A} {V}_{B} - f {\dot{m}}_{A} {V}_{C} - A \frac{1}{2} ρ ( {V}_{A}^{2} - {V}_{B}^{2} ) \\ = ( ρ A {V}_{A} ) {V}_{A} - ( 1 - f ) ( ρ A {V}_{A} ) {V}_{B} - f ( ρ A {V}_{A} ) {V}_{C} - A \frac{1}{2} ρ ( {V}_{A}^{2} - {V}_{B}^{2} ) \\ = ρ {AV}_{A}^{2} - ( 1 - f ) ρ A {V}_{A} {V}_{B} - f ρ A {V}_{A} {V}_{C} - \frac{1}{2} ρ A ( {V}_{A}^{2} - {V}_{B}^{2} )\end{matrix}$$

Determine expression for V_{B}

$${\dot{m}}_{A} = ρ {AV}_{A}$$

$${\dot{m}}_{B} = ρ {AV}_{B}$$

$${V}_{B} = \frac{{\dot{m}}_{B}}{ρ A} = \frac{( 1 - f ) {\dot{m}}_{A}}{ρ A} = \frac{( 1 - f ) ρ {AV}_{A}}{ρ A} = ( 1 - f ) {V}_{A}$$

Substituting

$$\begin{matrix}T = & ρ {AV}_{A}^{2} - ( 1 - f ) ρ {AV}_{A} ( 1 - f ) {V}_{A} - \\ & f ρ {AV}_{A} {V}_{C} - \frac{1}{2} ρ A ( {V}_{A}^{2} - {( 1 - f )}^{2} {V}_{A}^{2} ) \\ = & ρ {AV}_{A}^{2} - {( 1 - f )}^{2} ρ {AV}_{A}^{2} - f ρ {AV}_{A} {V}_{C} - \\ & \frac{1}{2} ρ {AV}_{A}^{2} ( 1 - {( 1 - f )}^{2} ) \\ = & ρ {AV}_{A}^{2} ( 1 - {( 1 - f )}^{2} ) - f ρ {AV}_{A} {V}_{C} - \\ & \frac{1}{2} ρ {AV}_{A}^{2} ( 1 - {( 1 - f )}^{2} ) \\ = & \frac{1}{2} ρ {AV}_{A}^{2} ( 1 - {( 1 - f )}^{2} ) - f ρ {AV}_{A} {V}_{C}\end{matrix}$$

The power is

$$\begin{matrix}\dot{E} = & \frac{1}{2} {\dot{m}}_{C} {V}_{C}^{2} + \frac{{\dot{m}}_{C}}{ρ} {P}_{C} + \frac{1}{2} {\dot{m}}_{B} {V}_{B}^{2} + \\ & \frac{{\dot{m}}_{B}}{ρ} {P}_{B} - \frac{1}{2} {\dot{m}}_{A} {V}_{A}^{2} - \frac{{\dot{m}}_{A}}{ρ} {P}_{A} \\ {P}_{A} = {P}_{C} = 0 \\ = & \frac{1}{2} {\dot{m}}_{C} {V}_{C}^{2} + \frac{1}{2} {\dot{m}}_{B} {V}_{B}^{2} + \frac{{\dot{m}}_{B}}{ρ} {P}_{B} - \frac{1}{2} {\dot{m}}_{A} {V}_{A}^{2} \\ = & \frac{1}{2} f {\dot{m}}_{A} {V}_{C}^{2} + \frac{1}{2} ( 1 - f ) {\dot{m}}_{A} {V}_{B}^{2} + \\ & \frac{( 1 - f ) {\dot{m}}_{A}}{ρ} \frac{1}{2} ρ ( {V}_{A}^{2} - {V}_{B}^{2} ) - \frac{1}{2} {\dot{m}}_{A} {V}_{A}^{2} \\ = & \frac{1}{2} f {\dot{m}}_{A} {V}_{C}^{2} + \frac{1}{2} ( 1 - f ) {\dot{m}}_{A} {V}_{B}^{2} + \\ & \frac{1}{2} ( 1 - f ) {\dot{m}}_{A} ( {V}_{A}^{2} - {V}_{B}^{2} ) - \frac{1}{2} {\dot{m}}_{A} {V}_{A}^{2} \\ = & \frac{1}{2} {\dot{m}}_{A} ( {fV}_{C}^{2} + ( 1 - f ) {V}_{B}^{2} + ( 1 - f ) ( {V}_{A}^{2} - {V}_{B}^{2} ) - {V}_{A}^{2} ) \\ = & \frac{1}{2} {\dot{m}}_{A} ( {fV}_{C}^{2} + ( 1 - f ) {( 1 - f )}^{2} {V}_{A}^{2} + \\ & ( 1 - f ) ( {V}_{A}^{2} - {( 1 - f )}^{2} {V}_{A}^{2} ) - {V}_{A}^{2} ) \\ = & \frac{1}{2} ρ {AV}_{A} ( {fV}_{C}^{2} + {( 1 - f )}^{3} {V}_{A}^{2} + ( 1 - f ) {V}_{A}^{2} - \\ & {( 1 - f )}^{3} {V}_{A}^{2} - {V}_{A}^{2} ) \\ = & \frac{1}{2} ρ {AV}_{A} ( {fV}_{C}^{2} + ( 1 - f ) {V}_{A}^{2} - {V}_{A}^{2} ) \\ = & \frac{1}{2} ρ {AV}_{A}^{3} ( f \frac{{V}_{C}^{2}}{{V}_{A}^{2}} + ( 1 - f ) - 1 ) \\ = & \frac{1}{2} ρ {AV}_{A}^{3} ( f \frac{{V}_{C}^{2}}{{V}_{A}^{2}} - f ) \\ = & \frac{1}{2} ρ {AV}_{A}^{3} f ( \frac{{V}_{C}^{2}}{{V}_{A}^{2}} - 1 )\end{matrix}$$

The thrust-to-power ratio is

$$\begin{matrix}\frac{T}{\dot{E}} = & \frac{\frac{1}{2} ρ {AV}_{A}^{2} ( 1 - {( 1 - f )}^{2} ) - f ρ {AV}_{A} {V}_{C}}{\frac{1}{2} ρ {AV}_{A}^{3} f ( \frac{{V}_{C}^{2}}{{V}_{A}^{2}} - 1 )} = \\ & \frac{\frac{1}{2} {V}_{A}^{2} ( 1 - {( 1 - f )}^{2} ) - {fV}_{A} {V}_{C}}{\frac{1}{2} {V}_{A}^{3} f ( \frac{{V}_{C}^{2}}{{V}_{A}^{2}} - 1 )} \\ = & \frac{\frac{1}{2} {V}_{A} ( 1 - {( 1 - f )}^{2} ) - {fV}_{C}}{\frac{1}{2} {V}_{A}^{2} f ( \frac{{V}_{C}^{2}}{{V}_{A}^{2}} - 1 )} = \\ & \frac{\frac{1}{2} {V}_{A} ( 1 - {( 1 - f )}^{2} ) - {fV}_{C}}{\frac{1}{2} f ( {V}_{C}^{2} - {V}_{A}^{2} )} \\ = & \frac{\frac{1}{{V}_{C}^{2}} ( \frac{1}{2} {V}_{A} ( 1 - {( 1 - f )}^{2} ) - {fV}_{C} )}{\frac{1}{{V}_{C}^{2}} \frac{1}{2} f ( {V}_{C}^{2} - {V}_{A}^{2} )} = \\ & [ \frac{\frac{1}{2} \frac{{V}_{A}}{{V}_{C}} ( 1 - {( 1 - f )}^{2} ) - f}{\frac{1}{2} f ( 1 - \frac{{V}_{A}^{2}}{{V}_{C}^{2}} )} ] \frac{1}{{V}_{C}} \\ = & [ \frac{\frac{1}{2} \frac{{V}_{A}}{{V}_{C}} ( 1 - {( 1 - f )}^{2} ) - f}{\frac{1}{2} f ( 1 - {( \frac{{V}_{A}}{{V}_{C}} )}^{2} )} ] \frac{1}{{V}_{C}}\end{matrix}$$

Flip sign so thrust is in forward direction

$$\frac{T}{\dot{E}} = - [ \frac{\frac{1}{2} \frac{{V}_{A}}{{V}_{C}} ( 1 - {( 1 - f )}^{2} ) - f}{\frac{1}{2} f ( 1 - {( \frac{{V}_{A}}{{V}_{C}} )}^{2} )} ] \frac{1}{{V}_{C}} = [ \frac{f - \frac{1}{2} \frac{{V}_{A}}{{V}_{C}} ( 1 - {( 1 - f )}^{2} )}{\frac{1}{2} f ( 1 - {( \frac{{V}_{A}}{{V}_{C}} )}^{2} )} ] \frac{1}{{V}_{C}}$$

The efficiency is

$$η = \frac{{TV}_{A}}{\dot{E}} = \frac{\{ [ \frac{f - \frac{1}{2} \frac{{V}_{A}}{{V}_{C}} ( 1 - {( 1 - f )}^{2} )}{\frac{1}{2} f ( 1 - {( \frac{{V}_{A}}{{V}_{C}} )}^{2} )} ] \frac{1}{{V}_{C}} \dot{E} \} {V}_{A}}{\dot{E}} = [ \frac{f - \frac{1}{2} \frac{{V}_{A}}{{V}_{C}} ( 1 - {( 1 - f )}^{2} )}{\frac{1}{2} f ( 1 - {( \frac{{V}_{A}}{{V}_{C}} )}^{2} )} ] \frac{{V}_{A}}{{V}_{C}}$$

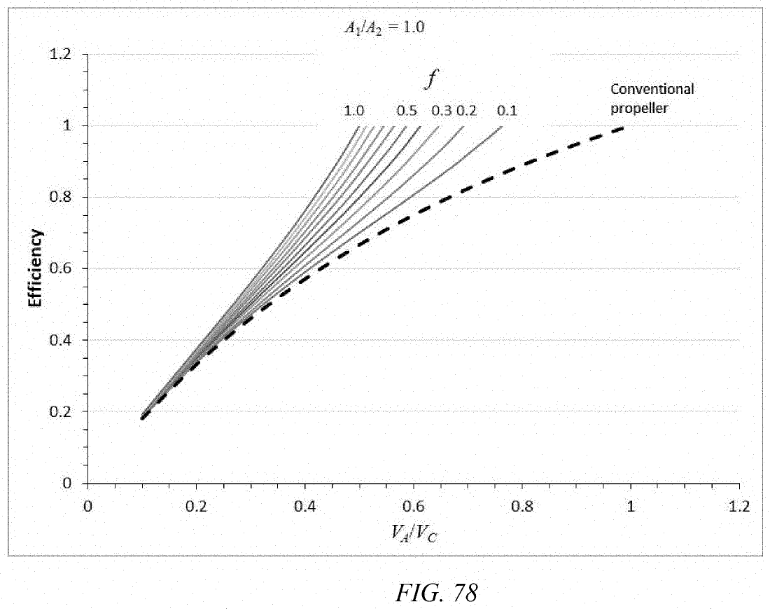

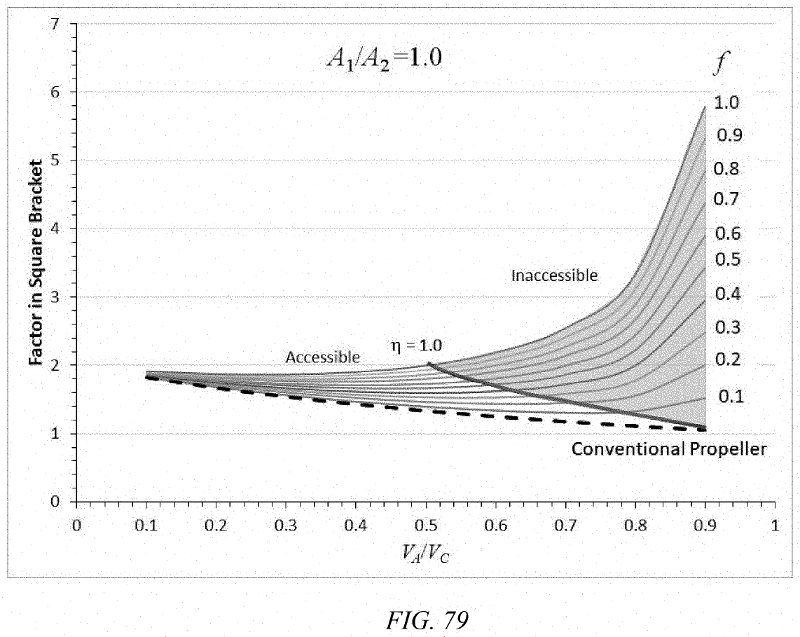

FIGS. 78 and 79 show the propulsive efficiency and factor in the square bracket, respectively.

It should be emphasized that these equations may only be valid to the degree that the boundary conditions can be achieved.

### Option 4

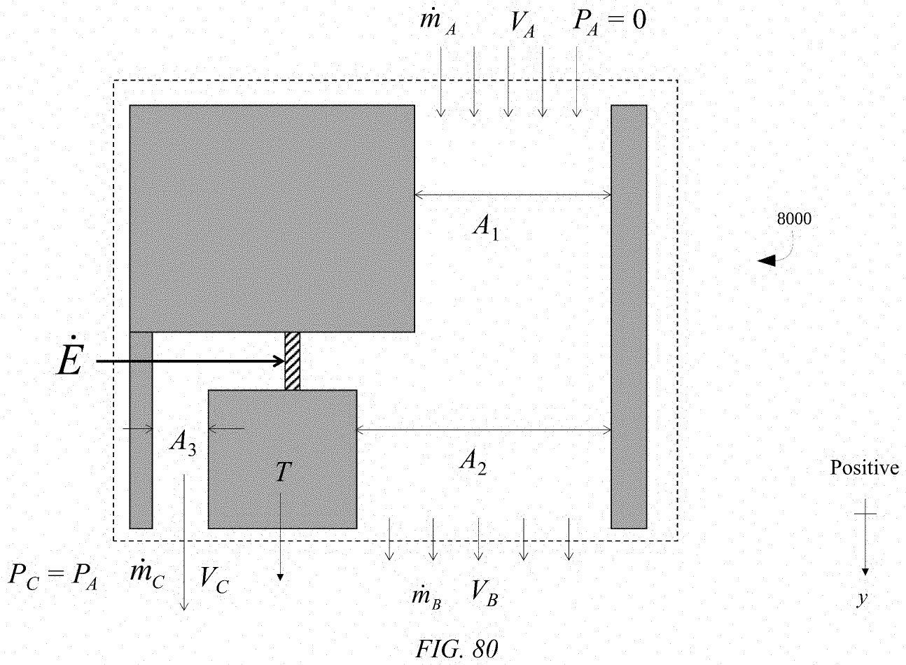

FIG. 80 illustrates another example ducted propulsion system 8000 according to one embodiment of the present disclosure. Although this analysis is performed in the context of a maritime propulsion system, it may be applied to aircraft propulsion as well. The ducted propulsion system 8000 is similar to the ducted propulsion system of FIG. 77, except areas A₁ and A₂ are not identical.

Define f

$$f ≡ \frac{{\dot{m}}_{C}}{{\dot{m}}_{A}}$$

Account for mass

\dot{m}_{A}=\dot{m}_{B}+\dot{m}_{C}

\dot{m}_{A}=\dot{m}_{B}+f\dot{m}_{A}

\dot{m}_{B}=\dot{m}_{A}−f\dot{m}_{A}=(1−f)\dot{m}_{A}

Account for energy in the stream exiting the channel

P_{A}+1/2ρV_{A}²=P_{B}+1/2ρV_{B}²

P_{A}=0

P_{B}=1/2ρ(V_{A}²−V_{B}²)

Account for y momentum

Accum=0=In−Out=(\dot{m}_{A}V_{A}+A₁P_{A})−(\dot{m}_{B}V_{B}+\dot{m}_{C}V_{C}+A₂P_{B}+A₃P_{C}+T)

P_{A}=P_{C}=0

T=\dot{m}_{A}V_{A}−(\dot{m}_{B}V_{B}+\dot{m}_{C}V_{C}+A₂P_{B})

Substituting

$$\begin{matrix}T = {\dot{m}}_{A} {V}_{A} - ( ( 1 - f ) {\dot{m}}_{A} {V}_{B} + f {\dot{m}}_{A} {V}_{C} + {A}_{2} {P}_{B} ) \\ = {\dot{m}}_{A} {V}_{A} - ( 1 - f ) {\dot{m}}_{A} {V}_{B} - f {\dot{m}}_{A} {V}_{C} - {A}_{2} {P}_{B} \\ = {\dot{m}}_{A} ( {V}_{A} - ( 1 - f ) {V}_{B} - {fV}_{C} ) - {A}_{2} {P}_{B} \\ = {\dot{m}}_{A} ( {V}_{A} - ( 1 - f ) {V}_{B} - {fV}_{C} ) - {A}_{2} \frac{1}{2} ρ ( {V}_{A}^{2} - {V}_{B}^{2} )\end{matrix}$$

Determine expression for V_{B}

$${\dot{m}}_{A} = ρ {A}_{1} {V}_{A}$$

$${\dot{m}}_{B} = ρ {A}_{2} {V}_{B}$$

$${V}_{B} = \frac{{\dot{m}}_{B}}{ρ {A}_{2}} = \frac{( 1 - f ) {\dot{m}}_{A}}{ρ {A}_{2}} = \frac{( 1 - f ) ρ {A}_{1} {V}_{A}}{ρ {A}_{2}} = ( 1 - f ) \frac{{A}_{1}}{{A}_{2}} {V}_{A}$$

$$a ≡ \frac{{A}_{1}}{{A}_{2}}$$

$${V}_{B} = ( 1 - f ) {aV}_{A}$$

Substituting

$$\begin{matrix}T = & ρ {A}_{1} {V}_{A} ( {V}_{A} - ( 1 - f ) ( 1 - f ) {aV}_{A} - {fV}_{C} ) - \\ & {A}_{2} \frac{1}{2} ρ ( {V}_{A}^{2} - {( ( 1 - f ) {aV}_{A} )}^{2} ) \\ = & ρ {A}_{1} {V}_{A} ( {V}_{A} - {( 1 - f )}^{2} {aV}_{A} - {fV}_{C} ) - \\ & {A}_{2} \frac{1}{2} ρ ( {V}_{A}^{2} - {( ( 1 - f ) {aV}_{A} )}^{2} ) \\ = & ρ {A}_{1} {V}_{A}^{2} - {( 1 - f )}^{2} a ρ {A}_{1} {V}_{A}^{2} - f ρ {A}_{1} {V}_{A} {V}_{C} - \\ & {A}_{2} \frac{1}{2} ρ ( {V}_{A}^{2} - {( ( 1 - f ) {aV}_{A} )}^{2} ) \\ = & ρ {A}_{1} ( 1 - {( 1 - f )}^{2} a ) {V}_{A}^{2} - ρ {A}_{1} {fV}_{A} {V}_{C} - \\ & \frac{1}{2} ρ {A}_{2} ( 1 - {( 1 - f )}^{2} {a}^{2} ) {V}_{A}^{2}\end{matrix}$$

The power is

$$\begin{matrix}\dot{E} = & \frac{1}{2} {\dot{m}}_{C} {V}_{C}^{2} + \frac{{\dot{m}}_{C}}{ρ} {P}_{C} + \frac{1}{2} {\dot{m}}_{B} {V}_{B}^{2} + \\ & \frac{{\dot{m}}_{B}}{ρ} {P}_{B} - \frac{1}{2} {\dot{m}}_{A} {V}_{A}^{2} - \frac{{\dot{m}}_{A}}{ρ} {P}_{A} \\ {P}_{A} = {P}_{C} = 0 \\ = & \frac{1}{2} {\dot{m}}_{C} {V}_{C}^{2} + \frac{1}{2} {\dot{m}}_{B} {V}_{B}^{2} + \frac{{\dot{m}}_{B}}{ρ} {P}_{B} - \frac{1}{2} {\dot{m}}_{A} {V}_{A}^{2} \\ = & \frac{1}{2} f {\dot{m}}_{A} {V}_{C}^{2} + \frac{1}{2} ( 1 - f ) {\dot{m}}_{A} {V}_{B}^{2} + \\ & \frac{( 1 - f ) {\dot{m}}_{A}}{ρ} \frac{1}{2} ρ ( {V}_{A}^{2} - {V}_{B}^{2} ) - \frac{1}{2} {\dot{m}}_{A} {V}_{A}^{2} \\ = & \frac{1}{2} f {\dot{m}}_{A} {V}_{C}^{2} + \frac{1}{2} ( 1 - f ) {\dot{m}}_{A} {V}_{B}^{2} + \\ & \frac{1}{2} ( 1 - f ) {\dot{m}}_{A} ( {V}_{A}^{2} - {V}_{B}^{2} ) - \frac{1}{2} {\dot{m}}_{A} {V}_{A}^{2} \\ = & \frac{1}{2} {\dot{m}}_{A} ( {fV}_{C}^{2} + ( 1 - f ) {V}_{B}^{2} + ( 1 - f ) ( {V}_{A}^{2} - {V}_{B}^{2} ) - {V}_{A}^{2} ) \\ = & \frac{1}{2} {\dot{m}}_{A} ( {fV}_{C}^{2} + ( 1 - f ) {( 1 - f )}^{2} {V}_{A}^{2} + \\ & ( 1 - f ) ( {V}_{A}^{2} - {( 1 - f )}^{2} {V}_{A}^{2} ) - {V}_{A}^{2} ) \\ = & \frac{1}{2} ρ {AV}_{A} ( {fV}_{C}^{2} + {( 1 - f )}^{3} {V}_{A}^{2} + ( 1 - f ) {V}_{A}^{2} - \\ & {( 1 - f )}^{3} {V}_{A}^{2} - {V}_{A}^{2} ) \\ = & \frac{1}{2} ρ {AV}_{A} ( {fV}_{C}^{2} + ( 1 - f ) {V}_{A}^{2} - {V}_{A}^{2} ) \\ = & \frac{1}{2} ρ {AV}_{A}^{3} ( f \frac{{V}_{C}^{2}}{{V}_{A}^{2}} + ( 1 - f ) - 1 ) \\ = & \frac{1}{2} ρ {AV}_{A}^{3} ( f \frac{{V}_{C}^{2}}{{V}_{A}^{2}} - f ) \\ = & \frac{1}{2} ρ {AV}_{A}^{3} f ( \frac{{V}_{C}^{2}}{{V}_{A}^{2}} - 1 )\end{matrix}$$

The thrust-to-power ratio is

$$\begin{matrix}\frac{T}{\dot{E}} = & \frac{\frac{1}{2} ρ {AV}_{A}^{2} ( 1 - {( 1 - f )}^{2} ) - f ρ {AV}_{A} {V}_{C}}{\frac{1}{2} ρ {AV}_{A}^{3} f ( \frac{{V}_{C}^{2}}{{V}_{A}^{2}} - 1 )} = \\ & \frac{\frac{1}{2} {V}_{A}^{2} ( 1 - {( 1 - f )}^{2} ) - {fV}_{A} {V}_{C}}{\frac{1}{2} {V}_{A}^{3} f ( \frac{{V}_{C}^{2}}{{V}_{A}^{2}} - 1 )} \\ = & \frac{\frac{1}{2} {V}_{A} ( 1 - {( 1 - f )}^{2} ) - {fV}_{C}}{\frac{1}{2} {V}_{A}^{2} f ( \frac{{V}_{C}^{2}}{{V}_{A}^{2}} - 1 )} = \\ & \frac{\frac{1}{2} {V}_{A} ( 1 - {( 1 - f )}^{2} ) - {fV}_{C}}{\frac{1}{2} f ( {V}_{C}^{2} - {V}_{A}^{2} )} \\ = & \frac{\frac{1}{{V}_{C}^{2}} ( \frac{1}{2} {V}_{A} ( 1 - {( 1 - f )}^{2} ) - {fV}_{C} )}{\frac{1}{{V}_{C}^{2}} \frac{1}{2} f ( {V}_{C}^{2} - {V}_{A}^{2} )} = \\ & [ \frac{\frac{1}{2} \frac{{V}_{A}}{{V}_{C}} ( 1 - {( 1 - f )}^{2} ) - f}{\frac{1}{2} f ( 1 - \frac{{V}_{A}^{2}}{{V}_{C}^{2}} )} ] \frac{1}{{V}_{C}} \\ = & [ \frac{\frac{1}{2} \frac{{V}_{A}}{{V}_{C}} ( 1 - {( 1 - f )}^{2} ) - f}{\frac{1}{2} f ( 1 - {( \frac{{V}_{A}}{{V}_{C}} )}^{2} )} ] \frac{1}{{V}_{C}}\end{matrix}$$

Flip sign so thrust is in forward direction

$$\begin{matrix}\frac{T}{\dot{E}} = - [ \frac{( ( 1 - {( 1 - f )}^{2} a ) - \frac{1}{2 a} ( 1 - {( 1 - f )}^{2} {a}^{2} ) ) \frac{{V}_{A}}{{V}_{C}} - f}{\frac{1}{2} f ( 1 - {( \frac{{V}_{A}}{{V}_{C}} )}^{2} )} ] \frac{1}{{V}_{C}} \\ = [ \frac{f - ( ( 1 - {( 1 - f )}^{2} a ) - \frac{1}{2 a} ( 1 - {( 1 - f )}^{2} {a}^{2} ) ) \frac{{V}_{A}}{{V}_{C}}}{\frac{1}{2} f ( 1 - {( \frac{{V}_{A}}{{V}_{C}} )}^{2} )} ] \frac{1}{{V}_{C}}\end{matrix}$$

The efficiency is

$$\begin{matrix}η = \frac{{TV}_{A}}{\dot{E}} = \frac{\{ [ \frac{f - ( ( 1 - {( 1 - f )}^{2} a ) - \frac{1}{2 a} ( 1 - {( 1 - f )}^{2} {a}^{2} ) ) \frac{{V}_{A}}{{V}_{C}}}{\frac{1}{2} f ( 1 - {( \frac{{V}_{A}}{{V}_{C}} )}^{2} )} ] \frac{1}{{V}_{C}} \dot{E} \} {V}_{A}}{\dot{E}} \\ = [ \frac{f - ( ( 1 - {( 1 - f )}^{2} a ) - \frac{1}{2 a} ( 1 - {( 1 - f )}^{2} {a}^{2} ) ) \frac{{V}_{A}}{{V}_{C}}}{\frac{1}{2} f ( 1 - {( \frac{{V}_{A}}{{V}_{C}} )}^{2} )} ] \frac{{V}_{A}}{{V}_{C}}\end{matrix}$$

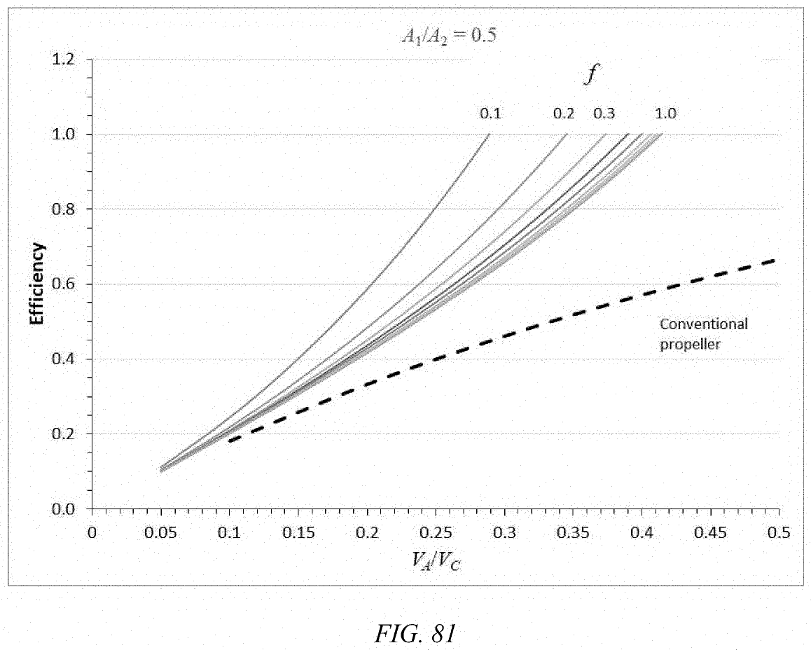

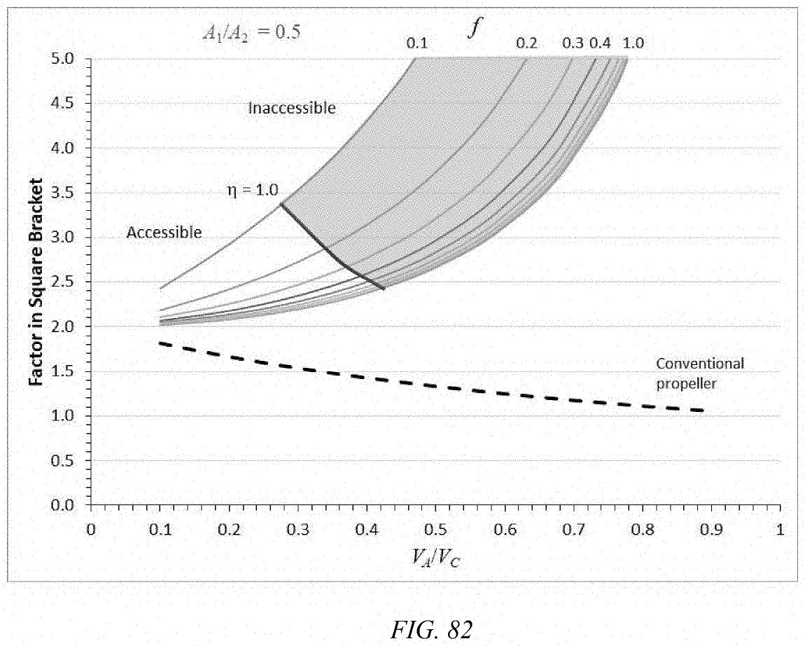

FIGS. 81 and 82 show the propulsive efficiency and factor in the square bracket, respectively of the propulsion system 7800 described above.

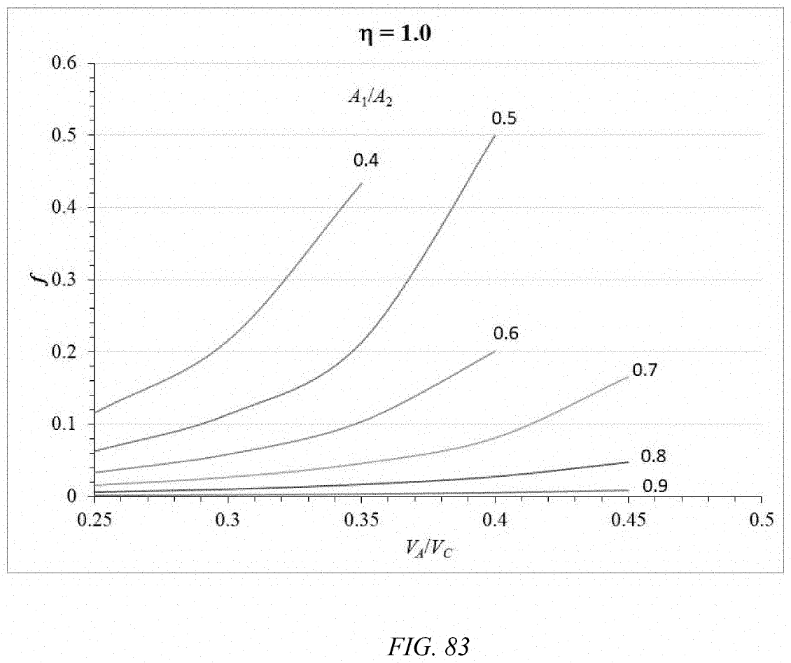

FIG. 83 shows combinations of area ratio (A₁/A₂), velocity ratio (V_{A}/V_{B}), and withdrawal fraction (f) that result in 100% efficiency (η=1.0) for the ducted propulsion systems described above. Many combinations of these parameters could potentially allow a theoretical efficiency of 100%, which greatly extends the range of efficient speeds.

It should be emphasized that these equations may only be valid to the degree that the boundary conditions can be achieved.

### Maritime Propulsion System Examples

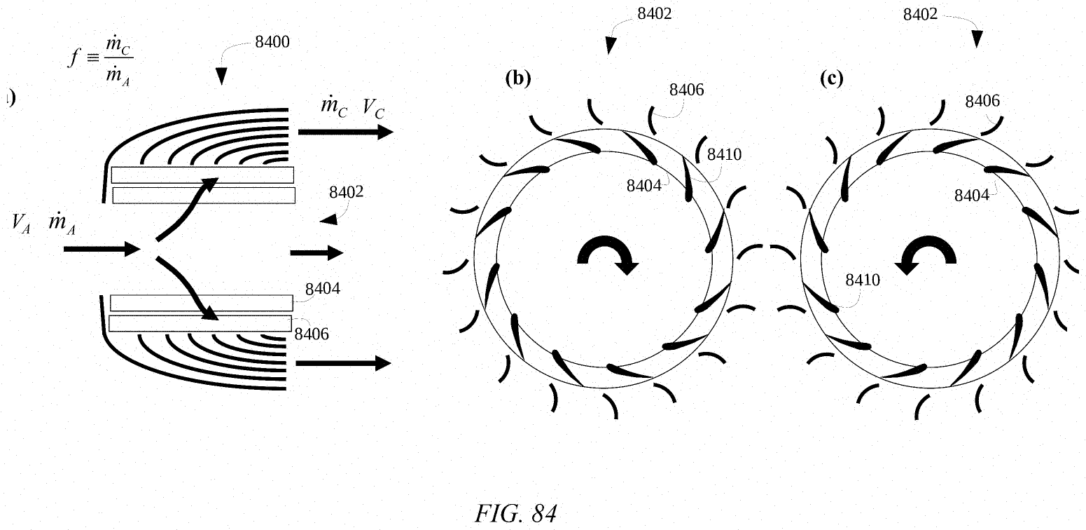

FIG. 84 illustrates an example hardware implementation 8400 of the ducted propulsion system of FIG. 77. The hardware implementation 8400 includes a squirrel cage fluid mover 8402 having a squirrel cage 8404 concentrically aligned with stators 8406 that remove spin from the fluid. Turning vanes 8410 direct the radial flow toward the rear. To extend the range of efficient operation, the angle of attack of the hydrodynamic foils can be varied using a mechanical pivot mechanism in some embodiments.

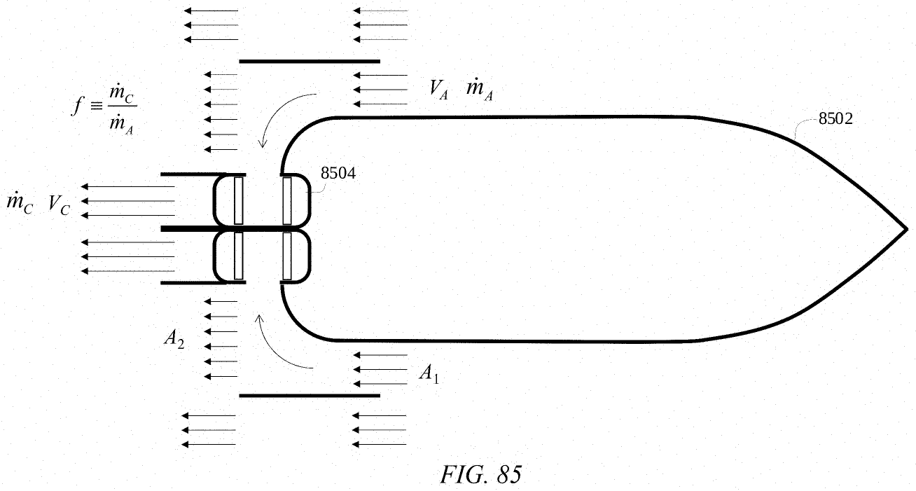

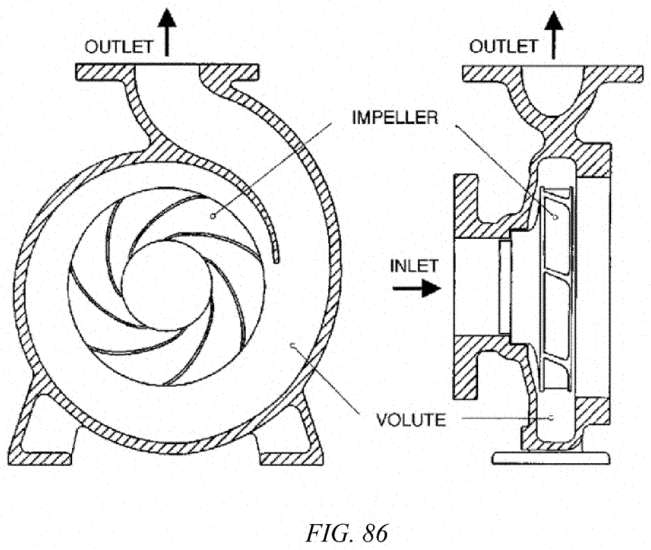

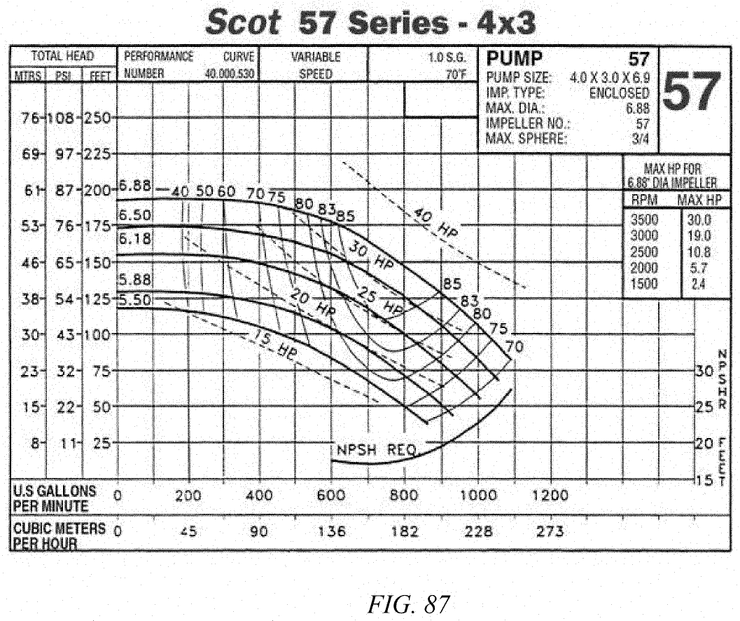

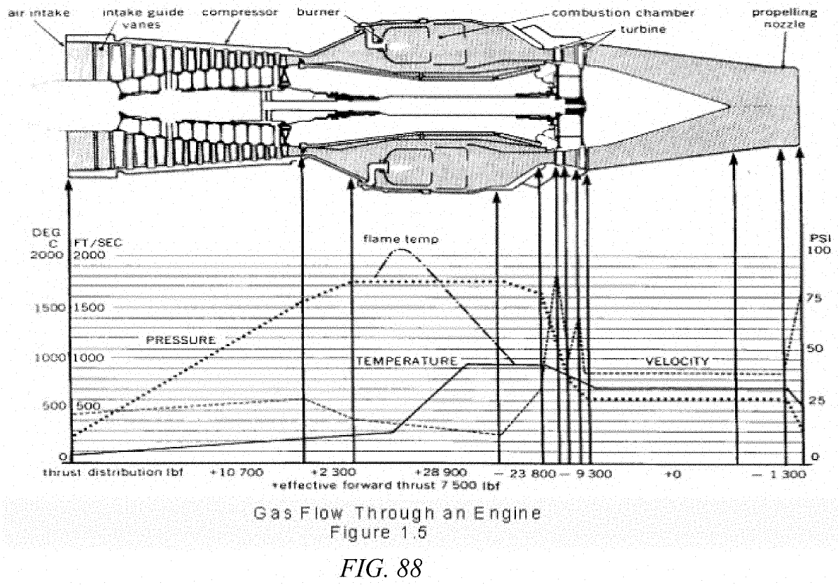

FIG. 85 illustrates an example hardware implementation of the maritime propulsion system 8000 according to one embodiment of the present disclosure. The system 8000 is configured at the rear of a ship 8002. A portion of the fluid flows through a propeller 8004 and is directed rearward. The propeller 8004 can be a squirrel cage (FIG. 84) or a centrifugal pump (FIG. 86). At its optimal operating condition, a centrifugal pump is about 85% efficient (FIG. 87). Variable-angle inlet guide vanes can extend the efficiency over a wider operating range. Furthermore, during operation, the area ratio (A₁/A₂) can be adjusted to maintain optimal performance at a variety of ship velocities.

### Aircraft

It should be emphasized that although these ducted propulsion systems have have been described in the context of ship propulsion, the concepts can be applied equally well to aircraft. For example, the propulsion system illustrated in FIG. 84 could be mounted on a conventional aircraft and has the advantage that it is not affected by bird strikes.

FIG. 88 shows the temperature, pressure, and velocity at various points in a turbojet engine. The inlet velocity V_{A} is 450 ft/s (307 mi/h) and the outlet velocity V_{C} is 1600 ft/s (1090 mi/h). The propulsive efficiency is

$$η = \frac{2 \frac{{V}_{A}}{{V}_{C}}}{1 + ( \frac{{V}_{A}}{{V}_{C}} )} = \frac{2 \frac{450 ft \text{/} s}{1600 ft \text{/} s}}{1 + ( \frac{450 ft \text{/} s}{1600 ft \text{/} s} )} = 0.439$$

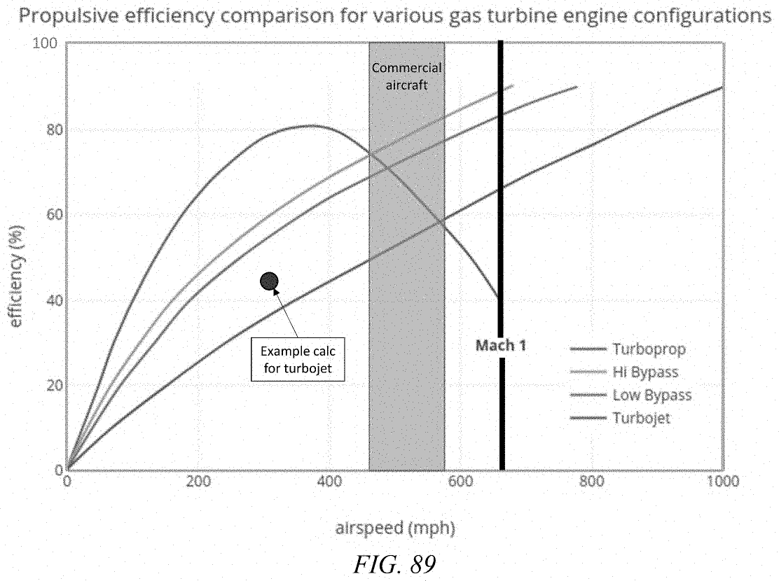

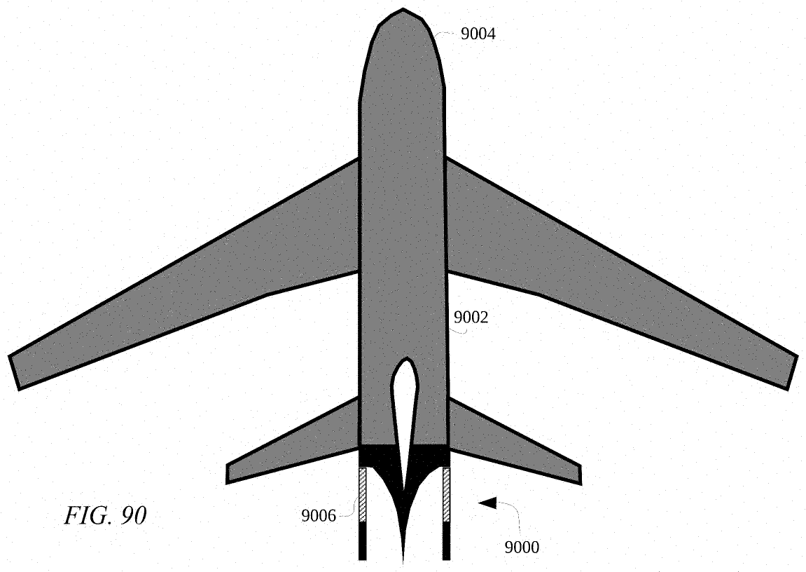

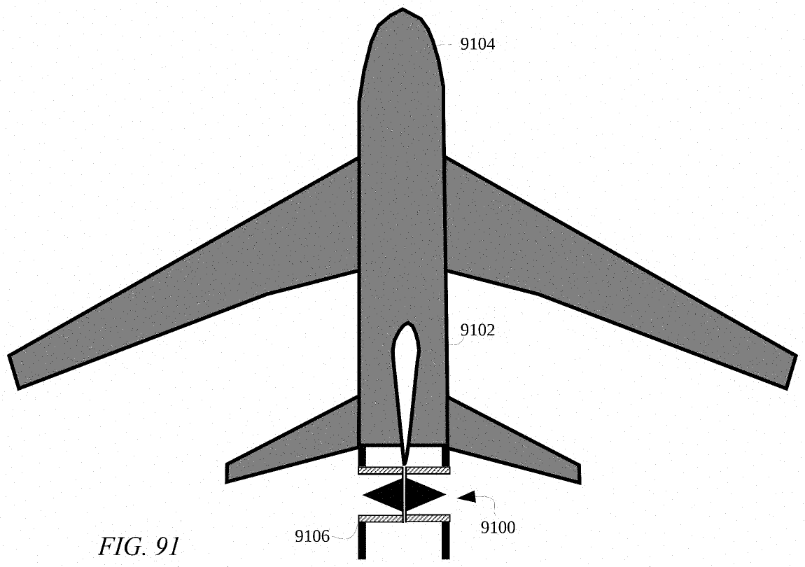

FIG. 89 shows the propulsive efficiency for aircraft engines as a function of airspeed. (Note: The data point in the figure is the above calculated efficiency for a turbojet.) In the range of typical commercial aircraft (460 to 575 miles per hour), the propulsive efficiency of high bypass turbofan engines is 74-83%; therefore, efficiency gains are possible by increasing the area through which air flows. FIGS. 90 and 91 show embodiments where the propulsion system 9000, 9100 is placed behind the fuselage 9002, 9102 of an aircraft 9004, 9104. In particular, FIG. 90 shows axial fans 9006 on the faces of the duct, whereas FIG. 91 shows squirrel cage fans 9106 (see FIG. 73a).

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A propulsion system comprising:
a duct comprising an elongated cavity with an inlet portion and an outlet portion; and
a fluid flow generator disposed in the duct, the fluid flow generator configured to receive a fluid to generate an inlet stream through the inlet portion and generate an outlet stream through the outlet portion,
wherein the outlet stream is configured to generate thrust for a vehicle on which the fluid flow generator and the duct are mounted; and
wherein at least one of the inlet portion or the outlet portion is bent in a circular shape to alter a direction of a corresponding either one of the input stream or the output stream.

2. The propulsion system of claim 1, wherein the vehicle comprises at least one of a flying car or a motorcycle, and wherein the fluid flow generator comprises a propeller, the thrust generated by the outlet stream being configured to lift the at least one of the flying car or the motorcycle from the ground.

3. The propulsion system of claim 1, wherein at least a portion of the duct is selectively movable from a deployed position in which the outlet stream is to provide lift for the vehicle to a retracted position where the duct is stored.

4. The propulsion system of claim 1, wherein the duct comprises multiple nested vanes that direct the outlet stream through a directional turn.

5. The propulsion system of claim 1, wherein an end of at least one of the inlet portion or the outlet portion of the duct includes a bulb to assist entry of the inlet stream or exist of the outlet stream.

6. The propulsion system of claim 1, wherein the fluid flow generator comprises a plurality of propellers, a portion of the plurality of propellers having a direction of rotation opposite to the direction of rotation of another portion of the plurality of propellers.

7. The propulsion system of claim 1, wherein the vehicle comprises at least one of a jet pack and a lift platform, the thrust generated by the outlet stream configured to lift a user from the ground.

8. The propulsion system of claim 7, wherein the duct comprises multiple nested vanes that direct the outlet stream through a directional turn, and wherein an end of each vane is configured at different positions along the duct so that the fluid exiting each vane may be introduced at different stages along the duct.

9. The propulsion system of claim 1, wherein the vehicle comprises a ship and the fluid flow generator comprises a propeller, wherein the inlet portion of the duct is configured on a side of the ship, and wherein the side is perpendicular to a direction of motion of the ship.

10. The propulsion system of claim 9, further comprising a reversing duct coupled to the outlet portion of the duct, the reversing duct configured for at least one of rotational movement or a sliding movement for engaging the reversing duct over the outlet portion or disengaging the reversing duct from the outlet portion.

11. The propulsion system of claim 1, wherein the vehicle comprises a torpedo and the fluid flow generator comprises a propeller, the torpedo comprising a rear portion with a conical shape that forms a portion of the duct.

12. The propulsion system of claim 1, wherein the inlet portion has a cross-sectional area that is less than the cross-sectional area of the outlet portion.

13. An apparatus comprising:
a vehicle;
a duct configured on the vehicle, the duct comprising an elongated cavity with an inlet portion and an outlet portion; and
a fluid flow generator disposed in the duct, the fluid flow generator configured to receive a fluid to generate an inlet stream through the inlet portion and generate an outlet stream through the outlet portion,
wherein the outlet stream is configured to generate thrust for the vehicle; and
wherein at least one of the inlet portion or the outlet portion is bent in a circular shape to alter a direction of a corresponding either one of the input stream or the output stream.

14. The apparatus of claim 13, wherein the vehicle comprises at least one of a flying car and a motorcycle, and wherein the fluid flow generator comprises a propeller, the thrust generated by the outlet stream being configured to lift the at least one flying car or the motorcycle from the ground.

15. The apparatus of claim 13, wherein the duct comprises multiple nested vanes that direct the outlet stream through a directional turn.

16. The apparatus of claim 13, wherein an end of at least one of the inlet portion or the outlet portion of the duct includes a bulb to assist entry of the inlet stream or exit of the outlet stream via a coanda effect.

17. The apparatus system of claim 13, wherein the vehicle comprises at least one of a jet pack and a lift platform, the thrust generated by the outlet stream configured to lift a user from the ground.

18. The apparatus of claim 13, wherein wherein the vehicle comprises a ship and the fluid flow generator comprises a propeller, wherein the inlet portion of the duct is configured on a side of the ship, and wherein the side is perpendicular to a direction of motion of the ship.

19. The apparatus of claim 13, wherein the vehicle comprises a torpedo and the fluid flow generator comprises a propeller, the torpedo comprising a rear portion with a conical shape that forms a portion of the duct.

20. A propulsion system comprising:
a duct configured on the vehicle, the duct comprising an elongated cavity with an inlet portion and an outlet portion; and
a fluid flow generator disposed in the duct, the fluid flow generator configured to receive a fluid to generate an inlet stream through the inlet portion and generate an outlet stream through the outlet portion,
wherein the outlet stream is configured to generate thrust for a vehicle on which the fluid flow generator and the duct are mounted; and
wherein an inlet of the duct has a cross-sectional area that is less than the outlet of the propeller to enhance the thrust exerted on the vehicle.
